(19) United States
(12) Patent Application Publication
(10) Pub. No.: US 2026/0289577 A1
(43) Pub. Date: Sep. 24, 2026

(54) SYSTEM FOR COORDINATING USER AND REPRESENTATIVE INTERACTIONS IN VIRTUAL AND PHYSICAL SPACES

(71) Applicant: SOFTBANK GROUP CORP., Tokyo (JP)

(72) Inventor: Yushi KITAZAWA, Tokyo (JP)

(73) Assignee: SOFTBANK GROUP CORP., Tokyo (JP)

(21) Appl. No.: 19/084,844

(22) Filed: Mar. 20, 2025

(51) Int. Cl. G06Q 30/015; G06F 16/3329; G06F 16/34; G06F 40/20; G06Q 10/02

(52) U.S. Cl. CPC G06Q 30/015; G06F 16/33295; G06F 16/345; G06F 40/20; G06Q 10/02

(57) ABSTRACT

Means of installing an AI in a virtual space that can learn CS data and explain the company's services, means of contacting a person in charge at a physical store or making a reservation for a visit to the store after the initial user response, means of summarizing the interaction in the virtual space so that it can be shared for the physical store, means of receiving questions from the user and using natural language processing technology to analyze the questions, means of inputting prompt sentences related to the questions analyzed by the above-mentioned analyzing means and generating appropriate answers by the above-mentioned generating means The means for receiving a question from the user and analyzing the question using natural language processing technology, inputting prompt sentences related to the question analyzed by the analyzing means into a generative AI model to generate an appropriate response, providing the response generated by the generating means to the user through the AI, and recording and summarizing the dialogue data between the user and the AI. system including means for recording and summarizing dialogue data between said user and said AI.

### BACKGROUND

### Technical Field

The technology of this disclosure relates to a system.

### Related Art

JP 2022-180282 discloses a persona chatbot control method, carried out by at least one processor, comprising the steps of: receiving a user utterance; adding said user utterance to a prompt containing a description of the chatbot character and associated instructions The method is disclosed, including the steps of adding the prompt to a prompt, encoding said prompt, and inputting said encoded prompt into a language model to generate a chatbot utterance in response to said user utterance.

Challenges exist in the lack of coordination of customer service between Metaverse and real stores, and the inability to ensure a consistent customer experience.

### SUMMARY

As a means to solve this issue, an AI that can explain the company's services by learning CS data, etc., will be installed in the metaverse store to provide initial user support. The AI will then contact the person in charge at the real store or make a reservation for a store visit, and summarize the interaction in the metaverse and share it with the store. This will strengthen the coordination of customer service between the Metaverse and real stores and ensure consistency in the customer experience.

### BRIEF DESCRIPTION OF THE DRAWINGS

Exemplary embodiments of the present disclosure will be described in detail based on the following figures, wherein:

FIG. 1 is a conceptual diagram showing an example of implement of a data processing system.

FIG. 2 is a conceptual diagram showing an example of the key functions of the data processing device and smart device of the first exemplary embodiment.

FIG. 3 is a conceptual diagram showing an example of implement of a data processing system for the second exemplary embodiment.

FIG. 4 is a conceptual diagram showing an example of the key functions of the data processing device and smart glasses of the second exemplary embodiment.

FIG. 5 is a conceptual diagram showing an example of implement of a data processing system for the third exemplary embodiment.

FIG. 6 is a conceptual diagram showing an example of the key functions of the data processing device and headset-type terminal for the third exemplary embodiment.

FIG. 7 is a conceptual diagram showing an example of implement of a data processing system for the fourth exemplary embodiment.

FIG. 8 is a conceptual diagram showing an example of the key functions of the data processing device and robot of the fourth exemplary embodiment.

FIG. 9 shows an emotion map where multiple emotions are mapped.

FIG. 10 shows an emotion map where multiple emotions are mapped.

FIG. 11 is a sequence diagram showing the flow of data processing system processing in Example 1 of implement example.

FIG. 12 is a sequence diagram showing the flow of data processing system processing in ex ample of application 1 of example of implement.

FIG. 13 is a sequence diagram showing the flow of data processing system processing in Example 2 of implement example.

FIG. 14 is a sequence diagram showing the flow of data processing system processing in ex ample of application 2 of example of implement.

FIG. 15 is a sequence diagram showing the flow of data processing system processing in Example 3 of implement example.

FIG. 16 is a sequence diagram showing the flow of data processing system processing in ex ample of application 3 of implement.

FIG. 17 is a sequence diagram showing the flow of data processing system processing in Example 1 of embodiment when the emotional engine is combined.

FIG. 18 is a sequence diagram showing the flow of data processing system processing in ex ample of application 1 of example of implement when combined with an emotion engine.

FIG. 19 is a sequence diagram showing the flow of data processing system processing in Example 2 of exemplary embodiment when the emotional engine is combined.

FIG. 20 is a sequence diagram showing the flow of data processing system processing in ex ample of application 2 of example of implement when combined with an emotion engine.

FIG. 21 is a sequence diagram showing the flow of processing of the data processing system in Example 3 of exemplary embodiment when the emotional engine is combined.

FIG. 22 is a sequence diagram showing the flow of data processing system processing in ex ample of application 3 of example of implement when combined with an emotion engine.

### DETAILED DESCRIPTION

The following is an example of implementations of systems for the technology of the present disclosure according to the accompanying drawings.

First, let us explain the wording used in the following description.

In the following exemplary embodiments, a signed processor (hereinafter simply referred to as “processor”) may be one arithmetic device or a combination of multiple arithmetic devices. The processor may be one type of computing device or a combination of multiple types of computing devices. Examples of computing devices include CPUs (Central Processing Units), GPUs (Graphics Processing Units), GPGPUs (General-Purpose computing on Graphics Processing Units), APUs (Accelerated Processing Units), or Accelerated Processing Unit), or TPU (Tensor Processing Unit (registered trademark)).

In the following exemplary embodiment, signed RAM (Random Access Memory) is a memory in which information is temporarily stored and is used by the processor as work memory.

In the following exemplary embodiments, the signed storage is one or more non-volatile storage devices that store various programs and various parameters, etc. Examples of non-volatile storage devices include flash memory (SSD (Solid State Drive)), magnetic disks (e.g., hard disks), or magnetic tape.

In the following exemplary embodiment, a signed communication I/F (Interface) is an interface that includes a communication processor and antenna, etc. The communication I/F is responsible for communication between multiple computers. Examples of communication standards applicable to the communication I/F include wireless communication standards including 5G (5th Generation Mobile Communication System), Wi-Fi (registered trademark), or Bluetooth (registered trademark).

In the following exemplary embodiments, “A and/or B” is synonymous with “at least one of A and B”. In other words, “A and/or B” means that there may be only A, only B, or a combi nation of A and B. The same concept as “A and/or B” also applies when three or more matters are expressed in this document by linking them together with “and/or”.

### First Exemplary Embodiment

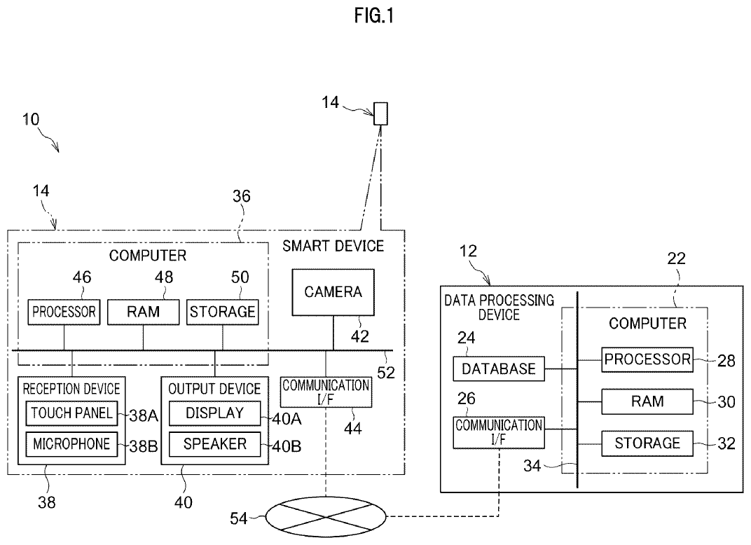

FIG. 1 shows an example of implement of a data processing system 10.

As shown in FIG. 1, data processing system 10 has data processing device 12 and smart de vice 14. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Smart device 14 has a computer 36, reception device 38, output device 40, camera 42, and communication I/F 44. The computer 36 has a processor 46, RAM 48, and storage 50. The processor 46, RAM 48, and storage 50 are connected to a bus 52. The reception device 38, output device 40, and camera 42 are also connected to the bus 52.

The reception device 38 is equipped with a touch panel 38A and a microphone 38B, etc., to accept user input. The touch panel 38A detects the touch of an indicating body (e.g., a pen or a finger, etc.), thereby accepting user input by the touch of the indicating body. The microphone 38B detects the user's voice, thereby accepting user input by voice. The control unit 46A transmits data indicating the user input accepted by the touch panel 38A and microphone 38B to the data processing device 12. In the data processing device 12, the specific processing unit 290 acquires the data indicating the user input.

The output device 40 is equipped with a display 40A and a speaker 40B, etc., and presents data to the user 20 by outputting the data in a form of representation (e.g., audio and/or text) that can be perceived by the user 20. Display 40A displays text, images, and other visible information in accordance with instructions from processor 46. Speaker 40B outputs audio in accordance with instructions from processor 46. Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. The camera is a compact digital camera.

The communication I/F 44 is connected to the network 54. The communication I/F 44 and 26 are responsible for transferring and receiving various types of information between the processor 46 and the processor 28 via the network 54.

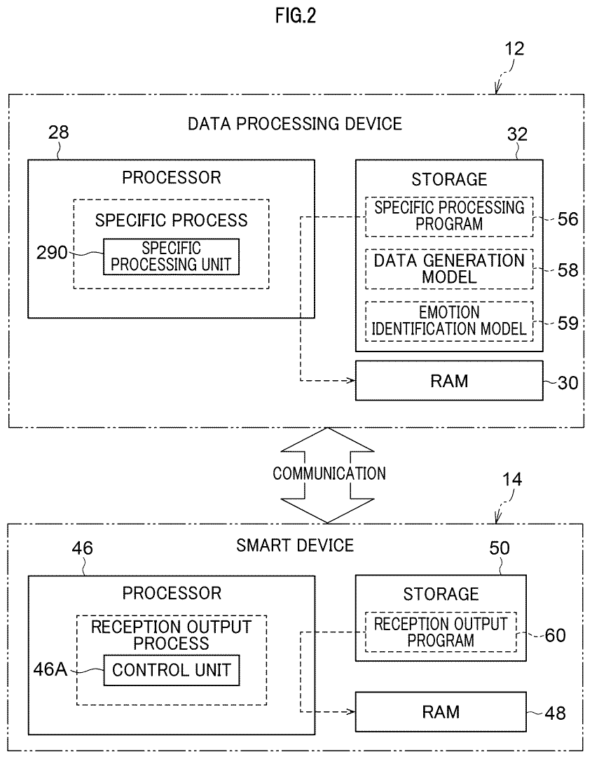

FIG. 2 shows an example of the key functions of data processing device 12 and smart device 14.

As shown in FIG. 2, specific processing is performed by processor 28 in data processing device 12. The specific processing program 56 is stored in the storage 32. The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executing on the RAM 30.

The data generation model 58 and emotion identification model 59 are stored in storage 32. The data generation model 58 and emotion identification model 59 are used by the specific processing unit 290.

In smart device 14, the reception output process is performed by processor 46. The reception output program 60 is stored in storage 50. The reception output program 60 is used by the da ta processing system 10 in conjunction with the specific processing program 56. Processor 46 reads reception output program 60 from storage 50 and executes the read reception output program 60 on RAM 48. The reception output process is realized by the processor 46 operating as the control unit 46A according to the reception output program 60 executing on RAM 48.

Next, the specific processing by the specific processing unit 290 of the data processing device e 12 is described.

### Example of Implement 1.”

As an exemplary embodiment of this invention, an AI that can learn CS data and other data to explain the company's services will be installed in the metaverse store. This AI will, for ex ample, use natural language processing technology to understand questions from users and generate appropriate responses. The AI will also record and summarize user questions and other interactive data.

### Example of Implement 2.”

After the initial user response, contact the person in charge of the real store OR make an app ointment to visit the store. This contact can be made, for example, by e-mail, telephone, or through a dedicated reservation system. For the convenience of the user, the date and time of the visit and the services to be provided can be specified at the time of the reservation. Example of implement 3.”

The interactions in the metaverse are summarized and shared for the stores. This sharing is accomplished, for example, by storing the summary information in a cloud-based database that can be accessed by real store personnel. The summary information would include the user's question, the AI's answer, and other important interaction data. This allows real store personnel to understand the content of the user's interaction in the metaverse and provide better service.

The following is a description of the process flow for each example of implement.

### Example of Implement 1.”

Step 1: The AI learns CS data and other data. This learning is performed, for example, using machine learning methods such as supervised learning, unsupervised learning, and reinforcement learning.

Step 2: An AI is installed in the Metaverse store to take questions from users. Questions are entered in text or voice format, which the AI analyzes using natural language processing technology.

Step 3: The AI generates appropriate answers and provides them to the user. Answers are generated based on training data and include the content that best fits the user's question.

Step 4: The AI records the user's questions and other dialogue data and summarizes this data. Summaries are generated, for example, using keyword extraction or sentence summarization techniques.

### Example of Implement 2.”

Step 1: After the initial user response is completed, the AI contacts the real store representative. The contact is made, for example, by accessing the real store's reservation system through the API and sending the user's information and summarized dialogue data.

Step 2: A real store representative receives the contact and confirms the user's appointment to visit the store. Notification of the confirmed reservation is sent to the user, for example, via e-mail or SMS.

### Example of Implement 3.”

Step 1: The AI summarizes the interactions in the metaverse and stores this in a cloud-based database. The storage is done, for example, by accessing the database through an API and submitting the summary data.

Step 2: A real store representative accesses the database and reviews the summary data. The review is done, for example, through a dedicated dashboard, which allows the representative to keep track of user questions and AI answers, as well as other important interaction data.

### Example 1

The following is an example of exemplary embodiment of implement. In the following description, data processing device 12 is referred to as the “server” and smart device 14 is referred to as the “terminal.

Conventional user response systems in the virtual space have difficulty in quickly providing appropriate answers to users' questions, and are inadequate in recording and summarizing dialogue data. As a result, the user experience was degraded and the system was not smoothly linked to the physical store. Furthermore, the quality of answers to users' questions was not consistent, which sometimes resulted in reduced user satisfaction.

The specific processing by the specific processing unit 290 of the data processing device 12 in Example 1 is realized by the following means.

In this invention, the server has means to install an AI in the virtual space that can explain its services by learning CS data, etc.; means to contact a person in charge at the physical store or to make a reservation for a visit to the store after the initial user response; means to summarize the interaction in the virtual space so that it can be shared for the store; means to receive questions from the user and analyze the questions using natural language processing technology; means to input prompt sentences into the generated AI model and generate appropriate answers; and means to record the dialog data and provide the generated answers to the user. from the user, means to analyze the question using natural language processing technology, means to input prompt sentences into a generative AI model to generate appropriate responses, means to provide the generated responses to the user, and means to record and summarize the dialogue data. This enables the system to provide prompt and appropriate answers to the user's questions and effectively record and summarize the dialogue data.

CS data” is data related to customer service and includes information such as the content of customer inquiries and response history.

An “AI that can explain its services” is an artificial intelligence that automatically explains the services offered by a company in response to questions from users.

A “virtual space” is a three-dimensional virtual environment built on the Internet, where users can interact with other users and systems through avatars.

A “physical store” is a store that actually exists and that users can visit in person.

Natural language processing technology” is a technology that allows computers to understand and analyze human language.

A “generative AI model” is an artificial intelligence model that generates new information and answers based on input data.

A “prompt sentence” is a sentence that is input into a generative AI model and serves as an instruction for the model to generate an appropriate response.

Dialogue data” is a record of questions and answers exchanged between the user and the AI.

Summarizing” refers to extracting the important parts of the dialogue data and summarizing them in a concise manner.

This invention is a system that provides appropriate answers to questions from users in a virtual space and records and summarizes dialogue data. Specific exemplary embodiments of this system are described below.

First, the server generates an AI program using natural language processing technology. This program has the ability to understand questions from users and generate appropriate responses. The hardware used should be a high-performance server (e.g., a server equipped with a NVIDIA GPU). The software used will be a natural language processing library (e.g., TENSORFLOW (registered trademark), PyTorch) or database (e.g., MySQL (registered trademark)).

The server places the generated AI program in the virtual space. When this AI receives a que stion from a user, it analyzes the question using natural language processing technology. Specifically, it performs the following data processing and data computation
1. data preprocessing: tokenize user questions and remove unnecessary characters and words
2. question analysis: Analyze the intent of the question using tokenized data.

Answer generation: Generate appropriate answers based on the intent of the question. In this case, a generative AI model (e.g., GPT-3 (registered trademark)) is used.
4. recording of dialogue data: user questions and AI answers are recorded in a database.

Data summarization: summarize the recorded dialog data for later reference.

As a concrete example, when a user asks the AI “What are the features of this product?” in the virtual space, the following processing is performed.

1. the user enters a question through an interface in the virtual space.

The terminal sends the user's question to the server.

3. the server receives the questions and uses a natural language processing library to tokenize the questions and remove unnecessary characters and words.

4. the server analyzes the intent of the question using the tokenized data and enters the prompt sentence “User: Tell me about the features of this product. ai:” into the data generation mod el.

5. the generated AI model says, “The features of this product are as follows. First, . . . ” The generated AI model generates the answer “First of all . . . ”.

The server sends the generated answers to the terminal.

7. the terminal displays the answer to the user and the user confirms the answer.

8. the server records the user's questions and the AI's answers in a database and summarizes the dialogue data.

An example of a prompt statement would be in the following form

User: What are the features of this product?

AI: This product has the following features. First, . . .

In this way, the server, terminal, and user can work together to provide appropriate answers to user questions and effectively record and summarize dialogue data.

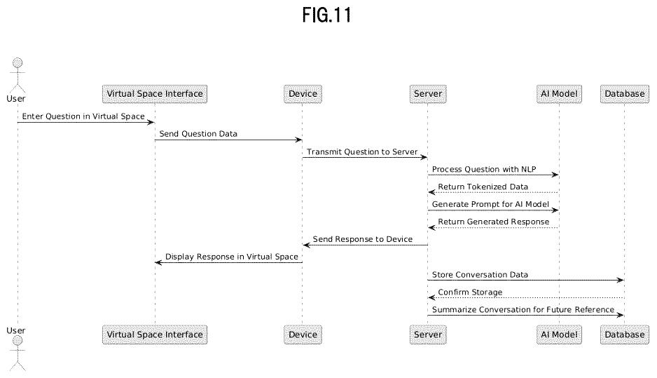

The flow of the identification process in Example 1 is described in FIG. 11.

### Step 1:

The user enters a question in the virtual space.

Specific behavior: The user enters a question through an interface in the virtual space. For ex ample, the user enters, “What are the features of this product?
Input: User's question text
Output: Question text is sent to the terminal

### Step 2:

The terminal sends the user's question to the server.

Specific operation: The terminal sends the questions entered by the user to the server. In this case, the data is transmitted via the Internet.
Input: Question text
Output: Question text is sent to the server

### Step 3:

The server receives the question and begins natural language processing.

Specific operation: The server receives questions sent from terminals. The received questions are analyzed using natural language processing libraries (e.g., TensorFlow, PyTorch).
Input: Question text
Output: Tokenized question data

### Step 4:

The server parses the questions and inputs prompt sentences into the generative AI model.

Specific behavior: The server tokenizes questions and removes unnecessary characters and w ords. It then analyzes the intent of the question and prompts a generative AI model (e.g., GP T-3) with a prompt sentence. For example, the input could be in the form “User: Tell me about the features of this product; AI:”.
Input: Tokenized question data
Output: Prompt statement

### Step 5:

Generative AI models generate appropriate responses.

Specific behavior: the Generate AI model generates appropriate responses based on the prom pt text entered. For example, “This product has the following features. First, . . . ” The model generates the response “First, . . . ”.
Input: Prompt statement
Output: Generated response text

### Step 6:

The server sends the generated responses to the terminal.

Specific behavior: The server sends the answers obtained from the generated AI model to the terminal. At this time, the server converts the response data into an appropriate format before sending it.
Input: Generated response text
Output: Answer text is sent to the terminal

### Step 7:

The terminal displays the answer to the user.

Specific behavior: The terminal displays the answers received from the server to the user. The user checks the answers through the interface in the virtual space.
Input: Answer text
Output: Answers displayed to user

### Step 8:

The server records and summarizes the dialogue data.

Specifics: The server records user questions and AI responses in a database. The recorded dialogue data is then summarized for later reference.
Input: User's question text and AI's answer text
Output: Recorded dialogue data and its summary

### (Example of Application 1)

Next, example of application 1 of example of implement 1 will be described. In the following description, data processing device 12 will be referred to as the “server” and smart device 14 will be referred to as the “terminal.

In conventional metaverse stores, users had difficulty getting appropriate answers to their questions about products and services. In addition, there was a lack of a means to effectively re cord, summarize, and share user questions and dialogue data with real store personnel, thus creating a need to improve the user experience. In addition, users were unable to provide real-time answers to their questions, which could potentially reduce user satisfaction

The specific processing by the specific processing unit 290 of the data processing device 12 in example of application 1 is realized by the following means.

In this invention, the server includes: a means of installing an AI in the metaverse store that can learn CS data and other data to explain its services; a means of contacting the person in charge of the real store or making a reservation for a store visit after the initial user response; a means of summarizing the interaction in the metaverse and making it available to the store for sharing; a means of generating real-time answers to user questions and providing them to the user; and a means of recording the interaction data, summarizing it, and providing it to the store administrator, The system includes means to generate real-time answers to user questions and provide them to the user, and means to record the dialogue data, summarize it, and provide it to the store administrator. This enables users to obtain appropriate answers in real time when they ask questions about products and services in the metaverse store, and the dialogue data can be effectively recorded, summarized, and shared with real store personnel, there by improving the user experience.

CS data” is data related to customer service and includes information such as the content of customer inquiries and response history.

AI″ stands for artificial intelligence, a system that uses machine learning and natural language processing techniques to mimic the intelligent work of humans.

A “metaverse” is a virtual reality space, a digital environment in which users can interact with h other users and content through avatars.

Real-time” refers to the temporal immediacy with which the system can respond immediately to user input.

Dialogue data” is a record of conversations between a user and the AI, including questions and answers.

A “summary” is information that extracts and briefly summarizes the main points of the dialogue data.

A “store manager” is the person or organization responsible for the operation of a real or Met averse store.

A “user” is a consumer or user who visits a Metaverse store and asks questions about a product or service.

A “real store” is a store that exists in a physical location, where customers can visit and purchase goods and services in person.

The “Visit Reservation” is a procedure whereby a user reserves a date and time in advance for a visit to a real store.

The following system configuration is an exemplary embodiment of this invention.

The server will install an AI in the Metaverse store that can learn CS data and other data to explain the company's services. When a user asks a question about a product or service in a Metaverse store, the AI uses natural language processing technology to understand the user's question and generates an appropriate response in real time. This answer is then provided to the user.

The server also records the dialogue data, including the user's questions and AI responses, and provides a summary of this data to the store manager. This helps the store manager understand the needs and interests of the user. It also includes a means to contact a real store representative or implement a reservation for a visit to the store after the initial user response.

The system will be implemented using the following hardware and software
Hardware: (1)
Smartphone or head-mounted display
Software: C
Python
OpenAI (registered trademark) API

When a user enters a question into the application, the server uses OpenAI's API to generate the appropriate answer to the user's question. The generated answers are displayed to the user. The dialogue data is recorded, summarized, and provided to the store manager.

As a concrete example, when a user asks “Tell me about this product” in a virtual store, the AI will respond, “This product uses the latest technology and is very high performance. The dialogue data is recorded and summarized as “User: Tell me about this product; AI: This product uses the latest technology and is very high performance.

Example of a prompt statement: “I am a member of the User: Tell me about this product.

AI: This product uses the latest technology and is very high performance.

In this way, when a user asks a question about a product or service in a Metaverse store, the user can get an appropriate response in real time, and the dialogue data can be effectively recorded, summarized, and shared with real store personnel, thereby improving the user experience.

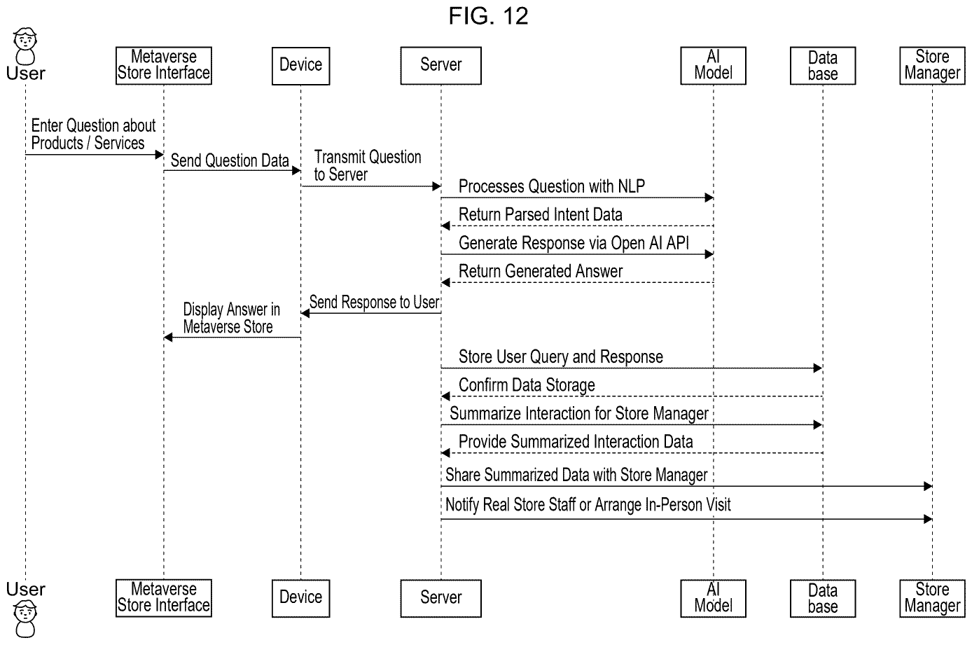

The flow of the identification process in Example of Application 1 is described in FIG. 12.

### Step 1:

Users use a terminal (smartphone or head-mounted display) to access the Metaverse store and enter questions about products and services.
Input: User's question text
Output: User's question text is sent to the server

### Step 2:

The server receives the user's question text and analyzes the intent of the question using natural language processing techniques.
Output: Data parsed for question intent

### Step 3:

The server generates appropriate answers using the OpenAI API based on the intent of the parsed question.
Input: Data parsed for question intent
Output: Answer text generated from OpenAI API

### Step 4:

The server sends the generated response text to the user's terminal for display to the user.
Input: Answer text generated from OpenAI API
Output: Response text displayed on the user's terminal

### Step 5:

The server records the user's question text and the generated answer text as dialogue data.
Input: user's question text, generated answer text
Output: Recorded dialogue data

### Step 6:

The server summarizes the recorded dialogue data and provides it to the store manager.
Input: recorded dialog data
Output: summarized dialog data

### Step 7:

The server provides a means to contact a real store representative or implement an appointment to visit the store after the initial user response.
Input: user question text, generated answer text, recorded dialog data
Output: Contact a real store representative or make an appointment to visit the store

In this way, when a user asks a question about a product or service in a Metaverse store, the user can get an appropriate response in real time, and the dialogue data can be effectively recorded, summarized, and shared with real store personnel, thereby improving the user experie nce.

### Example 2

Next, example 2 of exemplary embodiment of implement will be described. In the following description, data processing device 12 is referred to as the “server” and smart device 14 is referred to as the “terminal.

The conventional system required users to contact a real store representative after receiving initial response or to make an appointment to visit the store. In addition, there was a lack of an efficient and accurate means of conveying information to users when they specify the date and time of their visit and the services to be provided. Furthermore, when sharing interactions within the virtual space with real stores, information was not adequately summarized or organized, which sometimes delayed the store's response.

The specific processing unit 290 of the data processing device 12 in Example 2 is realized by the following means.

In this invention, the server provides a means to install an AI in the virtual space that can exp lain its services by learning CS data, etc., a means to contact the person in charge at the physical store or to make a reservation for a visit after the initial user response, a means to summarize the communication in the virtual space so that it can be shared with the store, a means to provide an interface for the user to input the date and time of the visit and the services provided, a means to store the input data in a database, a means to send notifications according to a specified contact method based on the stored data, and a means to send notifications based on the results of the user feedback. The system includes means to provide an interface for the user to enter the date and time of the visit and service details, means to store the entered data in a database, means to send a notification according to the specified contact method based on the stored data, and means to provide feedback to the user on the results of the notification transmission. This enables the user to efficiently and accurately specify the date and time of the visit and the services to be provided, and to quickly contact the person in charge of the real store. In addition, by summarizing and sharing the exchange within the virtual space, the store can respond quickly and accurately.

CS data” is data related to customer service and includes information such as the content of customer inquiries and response history.

AI″ stands for artificial intelligence, a technology that uses machine learning and natural language processing to automatically process information and provide appropriate answers and services to users.

A “virtual space” is a digital environment generated by computer simulation, which users can access through the Internet to perform various activities.

A “physical store” is a real store that actually exists and where users can visit and receive ser vices in person.

An “interface” is the means by which a user interacts with the system, including user interface elements such as input forms and buttons.

A “database” is a system for efficiently storing, managing, and retrieving data, and is operated using a query language such as SQL.

A “notice” is information sent from the system to a user or contact person, in the form of an e-mail, phone call, or message.

Feedback” is the response or result that the system provides to the user, informing him or her of the results of an operation he or she has performed.

A “summary” is a concise summary of the content of an exchange within a virtual space, extracting and organizing important information.

### Exemplary Embodiment of the Invention

This invention is a system that allows users to contact a real store representative or make an appointment to visit a store after receiving initial response. The system includes an AI, user interface, database, and notification functions installed in a virtual space.

### Hardware and Software Used

The server is developed using the Python programming language and implemented as a web application using the Flask framework. MySQL is used for the database, and the SMTP server and Twilio API are used for notification functions.

### Specific System Operation

The user accesses the system's web page using a web browser; the web page displays a form for entering the date and time of the visit and the services desired. The user enters, for example, that he/she wishes to have “Cut and Color” on “Oct. 15, 2023 at 14:00” and clicks on the submit button.

The server receives the data entered into the form by the user and processes the request using the Flask framework. The input data is stored in a MySQL database. Specifically, an SQL query is generated and inserted into the database.

The server then sends the notification according to the contact method specified by the user based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.

Finally, the server checks whether the notification was successfully sent and feeds back the result to the user. For example, if the notification is successful, the message “Reservation completed” is displayed; if not, the message “Reservation failed. Please try again” message is dis played.

### Examples of Specific Examples and Prompt Sentences

As a concrete example, consider the case where a user makes a reservation at a beauty salon. The user enters on the web form that he/she wishes to request a “cut and color” service on Oct. 15, 2023 at 14:00. The server receives this information and sends an e-mail notification to the person in charge.

### Example of a Prompt Statement:

If a user enters on a web form to make a reservation at a beauty salon that he/she would like to request a “cut and color” service on Oct. 15, 2023 at 14:00, the server should receive this information and send an e-mail notification to the person in charge.

In this way, a system is realized that allows the user to specify the date and time of the visit and the services to be provided for the convenience of the user.

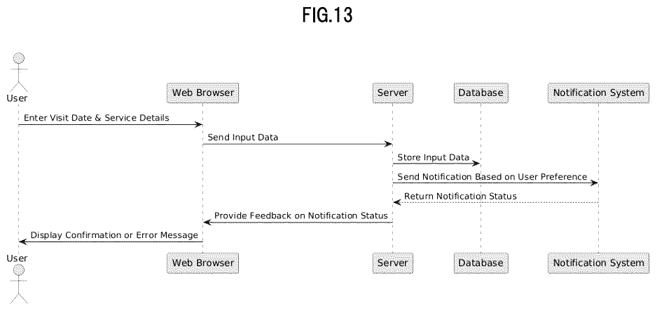

The flow of the identification process in Example 2 is described in FIG. 13.

### Step 1:

The user enters the date and time of the visit and services in a web form.

The user accesses the system's web page using a web browser and enters information in a form to enter the date and time of the visit and the services desired. For example, the user enters that he/she wishes to have “Cut and Color” on “Oct. 15, 2023 at 14:00” and clicks on the submit button.
Input: Date and time of visit, service details
Output: Data input by user

### Step 2:

The server receives the input data and stores it in a database.

The server receives the data entered into the form by the user; it processes the request using the Flask framework and stores the input data in a MySQL database. Specifically, it generates an SQL query and inserts it into the database.
Input: Data entered by user
Output: Data stored in database

### Step 3:

The server sends notifications based on the stored data and according to the specified contact method.

The server sends notifications according to the contact method specified by the user, based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.
Input: data stored in database, contact method
Output: Result of sending notification

### Step 4:

The server feeds back the results of the notification transmission to the user.

The server checks whether the notification was successfully sent and feeds back the result tother user. For example, if the notification is successful, the message “Reservation completed” is displayed; if not, the message “Reservation failed. Please try again” message is displayed.
Input: Result of sending notification
Output: Feedback message to user

### (Example of Application 2)

Next, example of application 2 of example of implement 2 will be described. In the following description, data processing device 12 is referred to as the “server” and smart device 14 is referred to as the “terminal.

Conventional user response systems within the metaverse lacked coordination with real stores after the initial response, which was problematic and reduced user convenience. In addition, there was a lack of a means to select an appropriate contact person based on the content of the user's inquiry and contact them promptly, which could lead to a decrease in user satisfaction. Furthermore, the lack of a reservation system that allowed users to specify the date and time of their visit and the services to be provided made it difficult to respond flexibly to user needs.

The specific processing by the specific processing unit 290 of the data processing device 12 in example of application 2 is realized by each of the following means.

In this invention, the server has a means of installing an AI in the metaverse store that can ex plain the company's services by learning CS data, etc., a means of contacting the person in chargeat the real store or making a reservation for a visit after the initial user response, and a means of summarizing the communication in the metaverse and making it available to be shared with the store, Means for the AI to automatically select an appropriate person in charge based on the user's inquiry, and to contact the person in charge via e-mail, telephone, or a dedicated reservation system, including a reservation system that allows the user to specify the date and time of the visit and the services to be provided. This makes it possible to quickly select and contact the appropriate person in charge based on the user's inquiry, thereby improving user convenience and satisfaction.

CS data” is data related to customer service and includes information such as the content of customer inquiries and response history.

AI″ stands for artificial intelligence, a technology that uses machine learning and natural language processing to automatically process information and provide appropriate answers and services to users.

A “metaverse” is a digital environment built on a virtual space, a platform that allows users to interact with other users and systems through their avatars.

A “real store” is a store that exists in a physical location, where users can actually visit and receive products and services.

The “person in charge” is a staff member or employee of the store designated to respond to user inquiries and reservations.

A “reservation system” is a system that allows users to make reservations by specifying the date, time, and services of their visit, either by e-mail, telephone, or through a dedicated online platform.

A “summary” is information that briefly summarizes the content of the exchange in the meta verse, including the user's questions and the AI's answers.

E-mail” is a digital message sent and received via the Internet and is a means of exchanging information between users and personnel.

A “phone call” is a means of exchanging information in real time through voice communication, and is intended for direct communication between a user and a contact person.

Automatic Selection” is the process by which AI automatically selects the best person for the job based on the user's inquiry.

The system for implementing this invention consists of the following

First, the server will install an AI in the metaverse store that can explain its services by learning CS data and other data. When a user makes an initial inquiry in the metaverse, the AI automatically generates an answer based on the content of the inquiry and provides it to the user. This allows users to quickly obtain the information they need.

Next, if the user's inquiry meets certain conditions, the server contacts the person in charge at the real store or makes a reservation for a visit. Specifically, the AI automatically selects an appropriate person based on the user's inquiry and contacts the person via e-mail, telephone, or a dedicated reservation system. This contact includes the user's inquiry, desired visit date and time, and service details.

In addition, the interactions in the metaverse will be summarized and made available for stores to share. The summary will include the user's question and the AI's response, which will al low personnel to quickly understand the user's situation.

To implement this system, the server will use the following hardware and software. Hardwar e: The server must be connected to the Internet and the user's smart phone. Software includes a Python-based program, an SMTP server (e.g., smtp.example.com), and a reservation system.

As a specific example, if a user wishes to “discuss the purchase of a new smartphone” and wishes to make an appointment to visit the store at 14:00 on Oct. 15, 2023, the following prompt statement is generated.

### User Name: Taro Yamada

Inquiry: Consultation on purchase of a new smartphone
Preferred date and time: 2023 Oct. 15 14:00
Contact: (phone number)
Email: taro.yamada@example.com
Phone: 090-1234-5678

Based on this prompt statement, the server contacts the person in charge and confirms the us er's appointment to visit the store. This allows the user to receive services at the real store smoothly.

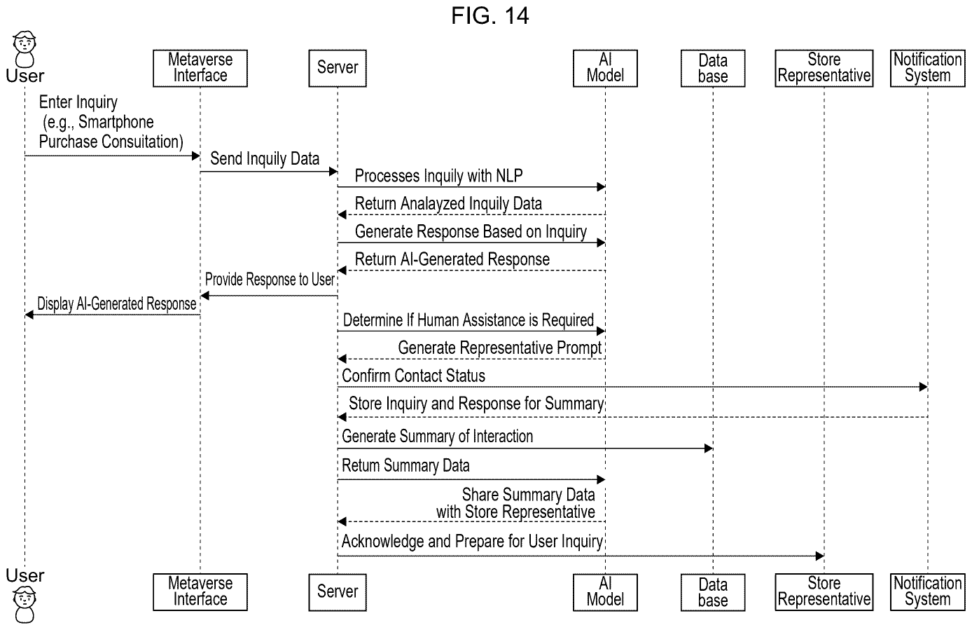

The flow of the identification process in example of application 2 is described in FIG. 14.

### Step 1:

The user makes an initial query in the metaverse.
Input: User's inquiry (e.g., “Consultation on the purchase of a new smartphone”)

Processing: The AI receives the user's inquiry and analyzes its content.
Output: parsed query contents

### Step 2:

AI automatically generates answers based on the user's query and provides them to the user.
Input: parsed query content

Processing: AI generates appropriate responses using a generative AI model.
Output: Generated answers (e.g., “Regarding the purchase of a new smartphone, the following models are recommended . . . ”)

### Step 3:

If the user's inquiry meets certain criteria, the server will contact the person in charge at the real store or make a reservation for the user to visit the store.
Input: parsed query, user's desired date and time of visit, and service details.

Processing: AI automatically selects the appropriate person in charge based on the content of the inquiry and generates prompt text.
Output: Generated prompt text (e.g., “User name: Taro Yamada, Inquiry: Consultation on purchase of new smartphone, Desired date: 2023 Oct. 15 14:00, Contact: E-mail: taro.yamada@e xample.com, Phone: 090-1234-5678”)

### Step 4:

The server will contact the person in charge via e-mail, telephone, or a dedicated reservation system.
Input: Generated prompt text

Processing: Server sends an email to the person in charge using an SMTP server, or automatically places a call using the phone API, or sends a prompt statement to the reservation system.
Output: Contact person in charge (e.g., reservation information is sent to the person's mailbox)

### Step 5:

Summarize the exchange in the metaverse and share it for the stores.
Input: user questions, AI answers

Processing: The server summarizes the exchange in the metaverse and generates summary in formation.
Output: Generated summary information (e.g., “User's question: How can I help you buy a new smartphone?)

### Step 6:

Share summary information for stores.
Input: Generated summary information

Processing: The server sends the summary information to the person in charge.

Output: Person in charge receives summary information and quickly assesses the user's situation.

### Example 3

Next, example 3 of exemplary embodiment of implement will be described. In the following description, data processing device 12 is referred to as the “server” and smart device 14 is referred to as the “terminal.

There is a need to efficiently collect, summarize, and share dialogue data between users and AI in the metaverse with real store personnel to provide better service based on user needs and questions. However, current systems often collect, summarize, and share dialogue data manually, which is inefficient and lacks real-time performance.

The specific processing unit 290 of the data processing device 12 in Example 3 is realized by the following means.

In this invention, the server includes means for collecting dialogue data in the metaverse, storing the collected dialogue data in a cloud-based database, summarizing the dialogue data using a data generation AI model, storing the summarized data in a cloud-based database, and all owing a real store representative The summary data is stored in a cloud-based database and made available for viewing by personnel in real stores. This enables dialogue data to be efficiently collected, summarized, and shared in real time within the metaverse.

The “metaverse” is a three-dimensional virtual space built using virtual reality technology, where users can interact with other users and AI through their avatars.

Dialogue data” is data that contains questions, answers, and other important dialogue between the user and the AI in the metaverse.

A “cloud-based database” is a database service accessible via the Internet that stores, manages, and accesses data in a cloud environment.

A “generative AI model” is a model for generating, summarizing, and transforming text data using artificial intelligence techniques, e.g., natural language processing techniques.

Summary data” is a concise summary of important information extracted from the dialogue data by the data generation model.

Real store personnel” are those staff members who provide customer service and provide ser vices in physical stores.

Viewing” is the act of displaying and checking stored data and information.

This invention is a system that efficiently collects, summarizes, and shares dialogue data bet ween users and AI in the metaverse with real store personnel. An exemplary embodiment of this system is described below.

The server collects real-time dialogue data between the user and AI that takes place in the me taverse. This dialogue data includes the user's questions, the AI's answers, and other important dialogue content. The server stores the collected dialogue data in a cloud-based database (e.g., Amazon RDS or Google (registered trademark) Cloud SQL).

The server then uses a data generation model (e.g., a model using natural language processing techniques) to summarize the collected dialogue data. This summary includes the key points of the user's question and the AI's response. The summarized information is again stored in a cloud-based database.

Real store representatives use their terminals to access the cloud-based database and view summary information. This allows the representative to understand the content of the interaction with the user in the metaverse and provide better service.

As a concrete example, consider a user asking in the metaverse, “Do you have the new product in stock?” and the AI responds, “Yes, we have it in stock. This interaction data is collected by the server, which uses a generative AI model to generate a summary that says, “The user asked if the new product is in stock, and the AI responded that it is in stock. This summary in formation is stored in a cloud-based database and can be accessed by real store personnel.

### Example of a Prompt Statement:

Summarize the user's question and the AI's answer.

User Question: Do you have any new products in stock?

AI's response: Yes, we have them in stock.

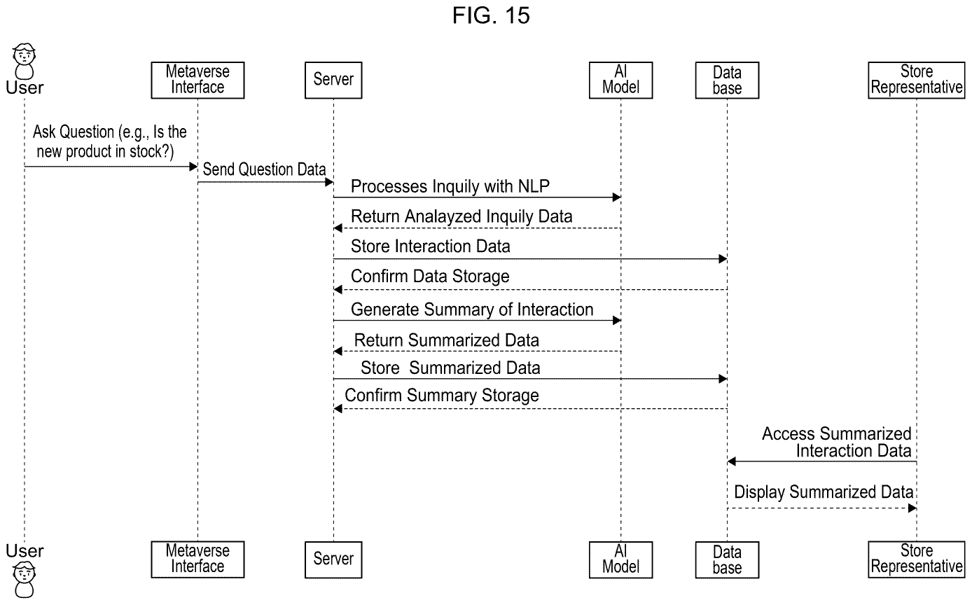

By inputting this prompt text into a generative AI model, summarized information can be obt ained. This system makes it possible to efficiently collect, summarize, and share dialogue data in the metaverse in real time. The flow of the identification process in Example 3 is described in FIG. 15.

### Step 1:

The server collects real-time dialogue data between the user and the AI that takes place in the metaverse. Specifically, if a user asks in the metaverse, “Do you have the new product in sto ck?” and the AI responds “Yes, we have it in stock,” this dialogue data is captured. The input is the user's question and the AI's response, and the output is the collected dialogue data.

### Step 2:

The server stores the collected dialogue data in a cloud-based database. Specifically, the dialogue data is inserted into the appropriate tables in the database. The input is the collected dialogue data and the output is the dialogue data stored in the database.

### Step 3:

The server inputs the stored dialogue data into the generative AI model to generate a summary. Specifically, the following prompt sentences are input to the generative AI model:

Summarize the user's question and the AI's answer.

User Question: Do you have any new products in stock?

AI's response: Yes, we have them in stock.

The input is the prompt text and dialogue data, and the output is the generated summary data.

### Step 4:

The server stores the generated summary data again in the cloud-based database. Specifically, the summary data is inserted into the appropriate tables in the database. The input is the generated summary data and the output is the summary data stored in the database.

### Step 5:

Using the terminal, a real store representative accesses the cloud-based database and views the summary data. Specifically, the person in charge executes a query to the database to retrieve and display the summary data. The input is a request to access the database and the output is the summary data displayed.

This series of processes enables the efficient collection, summarization, and real-time sharing of dialogue data within the metaverse.

### (Example of Application 3)

Next, example 3 of application of example of implement 3 will be described. In the following description, data processing device 12 is referred to as the “server” and smart device 14 is referred to as the “terminal.

In order for real store personnel to understand the content of dialogue with users in the metaverse and provide better service, a means to efficiently summarize and share dialogue content is needed. However, current systems make it difficult to summarize dialogue data in the meta verse in real time, store it in a cloud-based database, and allow real store personnel to access it using smartphones. This makes it difficult to quickly identify user needs and interests and provide personalized service.

The specific processing by the specific processing unit 290 of the data processing device 12 in example of application 3 is realized by the following means.

In this invention, the server includes: a means of installing an AI in the metaverse that can learn CS data and other data to explain the company's services; a means of contacting a real store representative or making a reservation for a store visit after the initial user response; a means of summarizing the interaction in the metaverse so that it can be shared with the store; a means of storing the summarized information in a cloud-based database and making it accessible to the real store representative using a smartphone; and a means of including the user's que stion, the AI's response, and other important interaction data in the summary. The summary information includes the user's questions and AI responses, as well as other important interact ion data. This allows the content of the dialogue in the metaverse to be efficiently summarized and quickly accessed by real store personnel, enabling them to understand the needs and interests of users and provide personalized service.

C S data” is data related to customer service and includes information such as customer inquiries, feedback, service history, etc. “CS data” is data related to customer service and includes information such as customer inquiries, feedback, service history, etc.

AI″ stands for artificial intelligence, a system that mimics human intelligence using techniques such as machine learning and natural language processing.

A “metaverse” is a virtual reality space, a digital environment where users can interact with other users and engage in various activities through their avatars.

A “real store” is a store that exists in a physical location, where customers can visit and purchase goods and services in person.

A “cloud-based database” is a database that can be accessed through the Internet, with data storage and management provided by a cloud service provider.

A “smart device” is a type of cell phone, a multifunctional device with Internet access and access to applications.

Summary information” is a concise summary of detailed data and dialogue, including important points and main points.

A “user question” is a query or question posed by a user to the AI in the metaverse.

An “AI response” is a response or explanation generated by the AI to a user's question.

Important dialogue data” refers to information and data that is considered particularly important in the dialogue between the user and AI, and includes content that is useful in the provision of services.

The following system configuration and processing procedures are used to implement this in vention.

First, the server will install an AI in the metaverse store that can learn CS data and other data to explain the company's services. When a user asks a question to the AI in the metaverse, the AI automatically generates an answer to the question and provides it to the user. This allows users to obtain information about the company's services in the metaverse.

Next, after the initial user response, the server contacts the person in charge of the real store and, if necessary, makes an appointment for the user to visit the store. The user is then ready to receive services at the real store.

In addition, the server will summarize the interactions in the metaverse and store the summary information in a cloud-based database. The summary information includes the user's question, the AI's answer, and other important interaction data. The person in charge of the physical store can use a smartphone to access the cloud-based database and review the summary info rmation. This allows personnel to quickly understand the needs and interests of users and pro vide personalized service.

As a concrete example, consider a user asking in the metaverse, “What are the features of the new smartphone?” and the AI responds, “The new smartphone has a high-resolution camera and a long battery life. The content of this dialogue is summarized and stored in the cloud-based data base. A real store representative could use a smartphone to access this summarized information to understand the user's interest in the new smartphone.

Examples of prompt sentences to be input into the generative AI model include the following

A user asked in the metaverse, “What are the features of your new smartphone?” and the AIresponded, “The new smartphone has a high-resolution camera and a long battery life.” Summarize this dialogue.

In this way, the server, terminal, and user can work together to efficiently summarize the content of the dialogue in the metaverse, which can then be quickly accessed by real store personnel. This will enable the system to understand the needs and interests of users and provide personalized services.

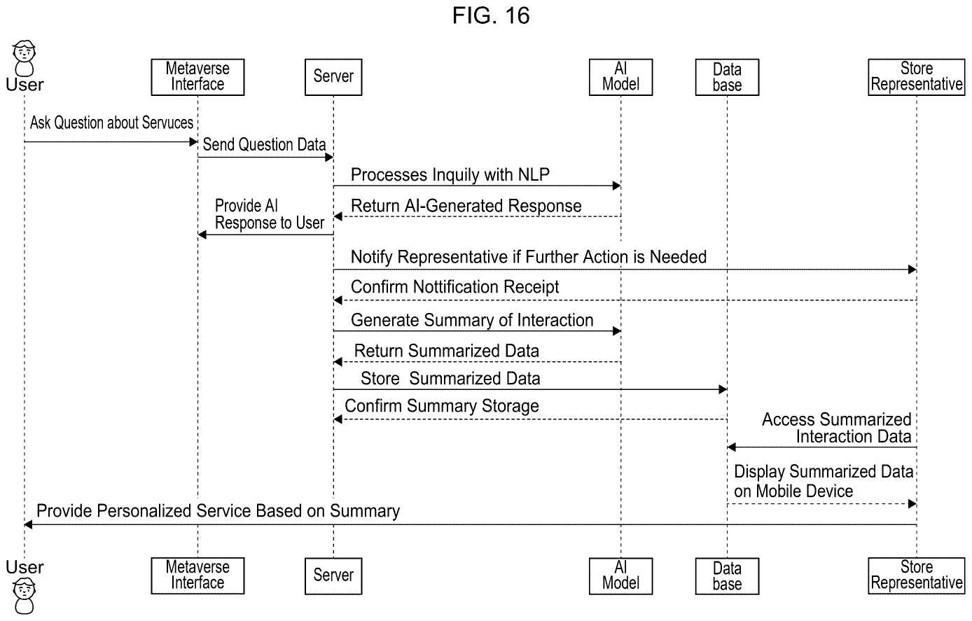

The flow of the identification process in example of application 3 is described in FIG. 16.

### Step 1:

The server will install an AI in the metaverse store that can learn CS data and other data to ex plain the company's services. When a user asks a question to the AI in the metaverse, the AI automatically generates an answer to that question and provides it to the user. The input is the user's question and the output is the AI's answer. Specifically, the AI uses natural language processing technology to analyze the user's question and generate an appropriate response.

### Step 2:

After the initial user response, the server contacts the person in charge at the real store and, if necessary, makes a reservation for the user to visit the store. The input is the user's question and the AI's response, and the output is the information for contacting the person in charge. The specific operation is to send a notification to the person in charge based on the user's quest ion and the AI's response, and then perform the procedures for making a reservation for a visit to the store.

### Step 3:

The server summarizes the interactions in the metaverse and stores the summary information in a cloud-based database. The input is the user's questions and AI responses, and the output is the summary information. Specifically, the server summarizes the dialogue using a generative AI model and stores it in a cloud-based database.

### Step 4:

The person in charge of the real store uses a smartphone to access the cloud-based database and review the summary information. The input is the summary information obtained from the cloud-based database, and the output is the person in charge's understanding. The specific operation is to access the database through the smartphone application and display the summary information.

### Step 5:

The person in charge uses the summary information to understand the needs and interests of the user and provide personalized services. The input is the summary information and the out put is the service provided. The specific action of is to refer to the summary information and suggest products and services suitable for the user.

Furthermore, an emotion engine that estimates the user's emotion may be combined. In other words, the specific processing unit 290 may use the emotion identification model 59 to estimate the user's emotion and perform specific processing using the user's emotion.

### Example of Implement 1.”

In one exemplary embodiment of the invention, the AI includes an emotion engine. The emotion engine estimates the user's emotional state from the user's questions and other interaction data. Specifically, it uses natural language processing and speech analysis technologies to estimate emotions from the user's text and voice input. Image analysis and motion analysis technologies can also be used to analyze the user's facial expressions and body movements.

### Example of Implement 2.”

The user's emotional state, as estimated by the emotion engine, is reflected in the AI's response generation. Specifically, if the user is happy or excited, the AI will generate responses that emphasize those emotions. Conversely, if the user is uncomfortable or confused, the AI will generate a response that softens the emotion. This allows the AI to respond appropriately to the user's emotions.

### Example of Implement 3.”

The emotion engine also influences the summary of interactions in the metaverse. Specifically, the user's emotional state is recorded as part of the summary, which is then shared with the store. For example, if a user expresses strong excitement about a product, this information is shared with the store to help predict product popularity and sales. If a user expresses dissatisfaction with a service, this information is shared with the store to help them improve the serv ice.

The following is a description of the process flow for each example of implement.

### Example of Implement 1.”

Step 1: The AI receives questions and other interactive data from the user.

Step 2: The emotion engine estimates the emotional state of the user from the data received. Specifically, it uses natural language processing and speech analysis technologies to estimate emotions from text and voice input. It also uses image analysis and motion analysis technologies to estimate emotions from the user's facial expressions and body movements.

### Example of Implement 2.”

Step 1: The emotion engine estimates the user's emotional state.

Step 2: The AI generates responses based on the estimated emotional state. Specifically, if the user is happy or excited, it generates a response that emphasizes that emotion. Conversely, if the user is uncomfortable or confused, it generates a response that softens the emotion.

### Example of Implement 3.”

Step 1: The emotion engine estimates the user's emotional state and reflects the results in a summary of the interaction in the metaverse.

Step 2: Summaries are shared with the stores. Specifically, information about the user's strong excitement about the product or the user's dissatisfaction with the service is shared with the store.

Step 3: Stores use the shared information to forecast product popularity and sales, and to imp rove their services.

### Example 1

The following is an example of exemplary embodiment of implement. In the following description, data processing device 12 is referred to as the “server” and smart device 14 is referred to as the “terminal.

Conventional user response systems in virtual spaces have difficulty generating appropriate responses to users' questions and cannot accurately grasp users' emotional states. As a result, the user experience was degraded, resulting in inducement to the actual store or inability to improve the quality of service. Furthermore, there was a lack of a means to effectively share interactions within the virtual space to the actual store, resulting in a lack of consistency in us er responses

The specific processing by the specific processing unit 290 of the data processing device 12 in Example 1 is realized by the following means.

In this invention, the server includes means to install an artificial intelligence in the virtual space that can learn CS data and other data to explain the company's services, means to contact a person in charge at the actual store or to make a reservation to visit the store after the initial user response, and means to summarize the interaction in the virtual space so that it can be shared for the store, Means to analyze user questions using natural language processing technology to generate appropriate responses, means to use speech analysis technology, image ana lysis technology, and motion analysis technology to estimate the user's emotional state, and means to record and summarize the dialogue data. This makes it possible to generate appropriate answers to the user's questions and to accurately ascertain the user's emotional state. In addition, by effectively sharing the interactions in the virtual space with the actual store, it is possible to maintain consistency in user responses and improve the quality of service.

Artificial Intelligence” is a system that includes technology to generate appropriate responses to user questions and to estimate the user's emotional state.

A “virtual space” is a three-dimensional virtual environment constructed on the Internet, where users can interact with other users and systems through avatars.

Natural language processing technology” is a technology that analyzes text input from users to understand their intentions and generate appropriate responses.

Speech analysis technology” is a technology for converting voice input from users into text and analyzing that text.

Image analysis technology” is a technology that uses a camera to capture a user's facial expressions and body movements, and analyzes the data to estimate the emotional state of the user.

Motion analysis technology” is a technology that analyzes the user's body movements and us es the data to estimate the emotional state of the user.

Dialogue data” is a record of the interaction between the user and the artificial intelligence, and includes information such as the content of questions and answers, as well as the emotion al state of the user.

A “summary” is a concise summary of important information extracted from the dialogue dat a.

A “physical store” is a store that exists in a physical location and that users can actually visit.

The “Visit Reservation” is a procedure whereby a user reserves a date and time in advance for a visit to a physical store.

This invention relates to an artificial intelligence system that explains its services to users in a virtual space. The following is an exemplary embodiment of this system.

First, the server generates a program that combines natural language processing technology, speech analysis technology, image analysis technology, and motion analysis technology. This program includes artificial intelligence to understand questions from users and generate appropriate responses. Specifically, the following technologies will be used.

Natural language processing technology: The server analyzes text input from the user to understand the intent of the question. This technology uses, for example, BERT and GPT-3.

Speech analytics technology: The server converts the user's voice input into text and analyzes that text. Google Cloud Speech-to-Text and Amazon Transcribe are used for this technology

Image Analysis Technology: The server uses cameras to capture the user's facial expressions and body movements to estimate their emotional state. OpenCV and Google Cloud Vision are used for this technology.

Motion analysis technology: The server analyzes the user's body movements to estimate emotional states. Microsoft (registered trademark) Azure (registered trademark) Kinect DK is used for this technology.

Next, the user accesses the AI within the virtual space. The user logs into a virtual store within the virtual space to access the AI assistant. The user initiates a dialogue by clicking on the AI assistant's icon or avatar within the virtual space.

When a user enters a question in text or voice, the server receives the input and selects the ap propriate analysis technology. For text input, the server selects natural language processing technology; for voice input, it selects speech analysis technology.

The server uses natural language processing technology to analyze the user's question and generate an appropriate response. For example, in response to a question such as “What are the features of this product?”, the server generates an answer such as “This product is made of high-quality materials and is durable.

In addition, the server uses an emotion engine to estimate the user's emotional state. For text input, emotions are analyzed using natural language processing technology, and for voice input, speech analysis technology is used. In addition, by analyzing the user's facial expressions and body movements through the camera, the emotional state is estimated more accurately.

The server returns the generated responses to the user. The response is displayed in a text chat window or played back with audio. For example, “This product is made of high quality materials and is durable.

Finally, the server records the interaction data with the user and summarizes it for later analysis and improvement. For example, the content of the user's questions and emotional state are recorded and used for the next dialogue.

### Specific Examples

User accesses the AI within the virtual space: the user clicks on the AI assistant's avatar in the virtual store and initiates a dialogue.

User enters a question by text or voice: The user enters the question “What are the features of this product?” by text or by voice using the microphone.

Server receives input and selects appropriate parsing technology: The server recognizes that the user's input is text and selects a natural language processing technology.

Server analyzes questions using natural language processing technology: The server analyzes questions using GPT-3 and extracts information about product features.

The server generates an appropriate response: the server generates a response such as “This product is made of high quality materials and is durable.

Server estimates the user's emotional state: The server analyzes the user's emotions from the user's text input and estimates whether the user is satisfied or not.

Server returns the answer to the user: The server displays the generated answer in a text chat window.

Server records and summarizes dialog data: The server records the user's questions and emotional state and summarizes them for use in the next dialog.

Example of a prompt statement: “I am a member of the

Tell me what makes this product unique.”

How long will this product last?”

Tell me about the pricing plan for this service.”

In this way, the server can generate appropriate answers to the user's questions and provide better service by estimating the user's emotional state.

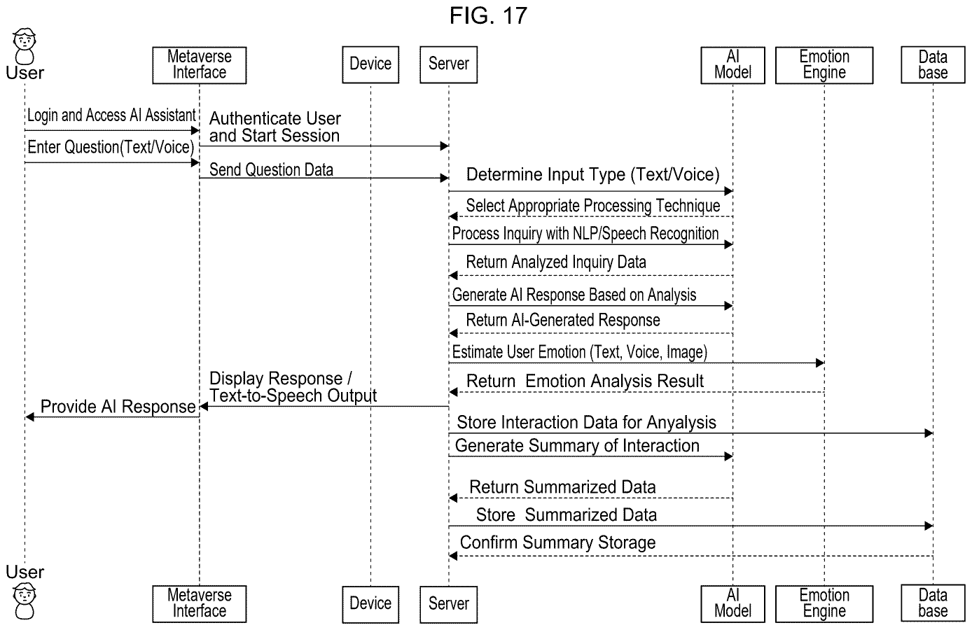

The flow of the identification process in Example 1 is described in FIG. 17.

### Step 1:

The user accesses the AI within the virtual space.

Specific behavior: The user logs into a virtual store in the virtual space and clicks on the AI assistant's icon or avatar to initiate a dialogue.
Input: User login information and location in the virtual space.
Output: Initiation of a dialogue session with the AI assistant.

### Step 2:

The user enters questions by text or voice.

Specific behavior: The user types a question in the text chat window or asks a question by voice using the microphone. For example, the user types, “What are the features of this product?
Input: User text or voice input.
Output: text or voice data.

### Step 3:

The server receives the input and selects the appropriate analysis technique.

Specific behavior: The server determines whether the user input is text or voice, and selects natural language processing technology for text input or speech analysis technology for voice input.
Input: text or voice data.
Output: Result of analysis technique selection.

### Step 4:

The server analyzes the questions using natural language processing technology.

Specific behavior: The server uses natural language processing techniques (e.g., GPT-3) to analyze the user's questions and understand the intent of the questions.
Input: text data.
Output: Results of analysis of question intent.

### Step 5:

The server generates the appropriate response.

Specific behavior: The server generates appropriate responses based on the analysis results. For example, it generates responses such as “This product is made of high-quality materials and is durable.
Input: Results of the analysis regarding the intent of the question.
Output: Response text.

### Step 6:

The server estimates the user's emotional state.

Specific behavior: The server uses an emotion engine to estimate the user's emotional state. For text input, emotions are analyzed using natural language processing technology; for voice input, speech analysis technology is used. In addition, the emotional state is estimated more accurately by analyzing the user's facial expressions and body movements through the camera.
Input: text data, voice data, image data.
Output: Estimated results of the emotional state.

### Step 7:

The server returns the answer to the user.

Specific behavior: The server returns the generated answers to the user. The answer is displayed in a text chat window or played back with audio. For example, “This product is made of high quality materials and is durable.
Input: Answer text.
Output: Display of answer to user or audio playback.

### Step 8:

The server records and summarizes the dialogue data.

Specific behavior: The server records the user interaction data and summarizes it for later analysis and improvement. For example, it records the user's questions and emotional state, which can be used for the next interaction.
Input: Dialogue data, emotional state estimation results.
Output: summarized dialog data.

### (Example of Application 1)

Next, example of application 1 of example of implement 1 will be described. In the following description, data processing device 12 will be referred to as the “server” and smart device 14 will be referred to as the “terminal.

Conventional user response systems within the virtual space have had difficulty providing ap propriate responses to user questions and taking into account the emotional state of the user. In addition, there was a lack of a means to effectively share interactions within the virtual space to the physical store, and there was a need to improve the user experience

The specific processing by the specific processing unit 290 of the data processing device 12 in example of application 1 is realized by the following means. In this invention, the server has the following means: a means to install an AI in the virtual space that can explain its services by learning CS data, etc.; a means to contact the person in charge of the physical store or make a reservation for a visit after the initial user response; a means to summarize the interaction in the virtual space so that it can be shared with the store; a means including an emotion engine that estimates the user's emotional state; a means to analyze the user's voice or text in put; a means to use natural language processing technology; and a means to analyze the user's voice or text input. The system includes an emotion engine to estimate the user's emotional state, natural language processing technology to analyze the user's voice and text input, and image analysis technology to analyze the user's facial expressions and actions. This makes it possible to provide appropriate answers to the user's questions and respond in consideration of the emotional state, effectively sharing the interaction within the virtual space to the physical store.

CS data” is data related to customer service and includes information such as the content of customer inquiries and response history.

A “virtual space” is a three-dimensional virtual environment constructed using computer technology, which users can experience interactively.

AI″ stands for artificial intelligence, a system that mimics human intelligence using techniques such as machine learning and natural language processing.

A “physical store” is a real store that actually exists and that customers can visit in person.

The “emotion engine” is a technology for estimating a user's emotional state, and is a system that recognizes emotions using voice and image analysis.

Natural language processing technology” refers to technology that enables computers to understand and generate human language, including text analysis and speech recognition.

Image analysis technology” refers to technology that analyzes image data and extracts information, including object recognition and face recognition.

A “summary” is a short summary of lengthy text or dialogue data, from which important information is extracted and expressed in a concise manner.

Communication” is the act of conveying information and is done by means of telephone, e-m ail, or other means.

The “visit reservation” is the act of reserving in advance a date and time for a customer to vis it a physical store so that the store can prepare to accommodate the customer.

The system for implementing this invention consists of the following

First, the server places an AI in the virtual space that can learn CS data and other data to explain its services. Users can access the virtual space using a smartphone or head-mounted display to interact with the AI, which automatically generates answers to their questions and provides those answers to the user.

The server then contacts the person in charge of the physical store after the initial user response or makes a reservation for a visit to the store. This allows the user to receive services at the physical store based on the information obtained in the virtual space.

In addition, the server summarizes the interactions in the virtual space so that they can be sha red with the store. This allows physical store personnel to see what questions users have asked and what answers they have received in the virtual space.

The system includes an emotion engine that estimates the user's emotional state. The emotion engine uses natural language processing technology to analyze the user's voice and text inpu t. It also uses image analysis technology to analyze the user's facial expressions and actions. This allows the system to estimate the user's emotional state and respond appropriately.

As a specific example, if a user asks, “Tell me about your latest smartphone,” the AI will res pond, “It is the latest smartphone. It has a high-performance camera and a long-lasting batter y.” The AI will respond, “It has a high-performance camera and a long battery life. And if the user asks, “Where can I buy this product?” the AI will answer, “This product is available at our online store. The AI replies, “This product can be purchased at the online store.

The following hardware and software are used to realize this system
Hardware: Smartphones, head-mounted displays
Software: OpenAI API (generative AI models), Transformers library (natural language processing technology), OpenCV (image analysis technology)
Examples of prompt statements include the following
Tell me about your latest smartphone.”
Where can I buy this product?”

Tell me about the features of your head-mounted display.”

This allows users to receive services at a physical storefront through an interactive experience in the virtual space.

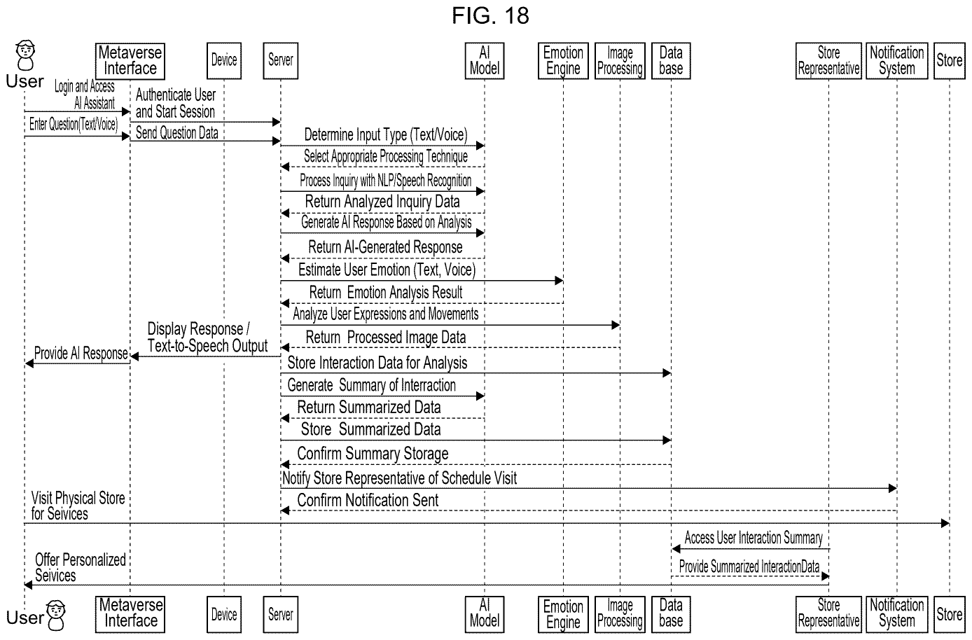

The flow of the identification process in Example of Application 1 is described in FIG. 18.

### Step 1:

The user accesses the virtual space using a smartphone or head-mounted display. The user in puts questions to the AI assistant within the virtual space. Input can be done by text or voice. The input data is sent to the server.

### Step 2:

The server analyzes the received user questions using natural language processing technology. Specifically, it uses the OpenAI API to understand the intent of the question and generate an appropriate response. The input is the user's question and the output is the generated answer.

### Step 3:

The server provides the generated answers to the user. The user checks the answers in the virtual space. The output is the answers provided to the user.

### Step 4:

The server analyzes the user's voice and text input with the emotion engine to estimate the us er's emotional state. The emotion engine uses the Transformers library to recognize emotions. The input is the user's voice or text data, and the output is the estimated emotional state.

### Step 5:

The server analyzes the user's facial expressions and actions using image analysis technology. Specifically, it uses OpenCV to recognize the user's facial expressions and actions to complement the emotional state. The input is the user's image data, and the output is the analyzed facial expression and behavior information.

### Step 6:

The server summarizes the interaction in the virtual space and shares it with the physical store personnel. The summary includes the user's questions and the AI's answers. The input is the interaction data in the virtual space and the output is the summarized information.

### Step 7:

After the initial user response, the server will contact the person in charge of the physical store or implement a reservation for a visit to the store. Email or telephone is used as the means of contact. The input is the user's contact information and the desired appointment date and time, and the output is a confirmation of the contact or appointment.

### Step 8:

Users visit a physical store and receive services based on information obtained in the virtual space. The person in charge of the physical store responds based on the summary information shared from the server. The input is the summary information and the output is the service provided to the user.

### Example 2

Next, example 2 of exemplary embodiment of implement will be described. In the following description, data processing device 12 is referred to as the “server” and smart device 14 is referred to as the “terminal.

Conventional systems provide a uniform response without taking into account the user's emotional state, and this has led to a problem of reduced user satisfaction. There was also the problem of the time and effort required to contact the person in charge at the real store after the initial response and the complicated procedures for making a visit appointment. Furthermore, the system lacked the ability to specify the date and time of the user's visit and the services to be provided, making it difficult to provide convenience to the user.

The specific processing by the specific processing unit 290 of the data processing device 12 in Example 2 is realized by the following means. In this invention, the server receives the use r's input data, analyzes the received input data to estimate the user's emotional state, generates a response using a generative AI model based on the estimated emotional state, provides the generated response to the user, and after the initial user response The system includes means to contact a person in charge of the real store or to make an appointment for the user to visit the store, and means by which the user can specify the date and time of his/her visit and the services to be provided. This enables appropriate responses according to the user's emotional state, and simplifies the contact and reservation procedures after the initial response, for the convenience of the user.

The “means of receiving user input data” is a function for sending and receiving text and voice data input by the user through the terminal to the server.

The “means for analyzing received input data to estimate the user's emotional state” is a function for analyzing received user input data and estimating the user's emotional state (joy, excitement, discomfort, confusion, etc.) from that data.

The “means for generating responses using a generative AI model” is a function for generating appropriate responses to users using a generative AI model based on the estimated emotion al state.

The “means of providing generated answers to users” is a function for transmitting and providing answers generated by the generative AI model to users.

The “means of contacting a real store representative or scheduling a visit after the initial user response” is a function for contacting a real store representative or scheduling a visit by the user after the initial response is complete.

The “means by which users can specify the date and time of their visit and the services they wish to receive” is a function for users to specify the date and time of their visit and the services they wish to receive.

An “emotion engine” is software or an algorithm that analyzes user input data and estimates the emotional state from that data.

A “generative AI model” is an artificial intelligence model for generating natural language responses based on user input data and emotional states.

An “e-mail, telephone, or dedicated reservation system” is a means of communication or reservation management system used to communicate between a user and a real store representative.

### Exemplary Embodiment of the Invention

This invention is a system that provides appropriate responses based on the user's emotional state and simplifies the contact and appointment procedures after the initial response. Specific exemplary embodiments of this system are described below.

### Means for Receiving User Input Data

A user accesses the system using a terminal (e.g., PC or smartphone) and enters questions or information. The data entered by the user is sent from the terminal to the server. The server is equipped with a high-performance processor (e.g., Intel Xeon processor) to process the received data.

### Means for Analyzing the Received Input Data to Estimate the Emotional State of the User

The server passes the received user input data to an emotion engine (e.g., IBM Watson (registered trademark) Tone Analyzer) for emotion analysis. The emotion engine estimates the emotional state (e.g., joy, excitement, discomfort, confusion, etc.) from the user's text. The results of this analysis are fed back to the generative AI model.

### Means of Generating Responses Using a Generative AI Model Based on the Estimated Emotion AI State

The server generates a response to the user using a generative AI model (e.g., OpenAI's GPT-4 (registered trademark)) based on the emotional state obtained from the emotion engine. For example, if the user is expressing joy, the AI will say, “That's great! We're glad you're inter ested.” and generates a positive response such as “I'm glad you're interested.

### Means of Providing the Generated Answers to the User

The server sends and provides the answers generated by the generative AI model to the user.

Users can receive these answers through their terminals.

Means of contacting a real store representative or scheduling a visit to the store after the initial user response.

If the user is satisfied with the initial response, the server will contact a real store representative or implement a reservation for a visit to the store. This contact may be made via email (e. g., Gmail API), telephone (e.g., Twilio API), or through a dedicated reservation system (e.g., Calendly).

A means of specifying the date and time of the user's visit and the services to be provided.

The user may specify the date and time of the visit and the services to be provided when making an appointment to visit the restaurant. The server inputs these information into the reservation system and sends a reservation confirmation e-mail to the user. It also notifies the person in charge of the real store of the reservation information.

### Concrete Example

### Example 1: a User Expresses Delight

User says, “I really like your new product!” and inputs “I love it!”. The emotion engine detects “joy” and the generative AI model says, “That's great! We're glad you're interested. If you need more information, please contact a representative or schedule a visit. The model replies, “That's great!

### Example 2: a User Expresses Confusion

A user types “I am not sure how to use this product. The emotion engine detects “confusion” and the generative AI model says, “Sorry for the inconvenience. If you need further explanation, please contact a representative or make an appointment to visit our store. The model replies, “I am sorry for the inconvenience.

### Example of Prompt Text

“Generate a positive response if the user expresses delight about the new product.”

“If a user is confused about how to use a product, generate a response that reassures them.”

In this way, the system responds appropriately to the user's emotional state and, if necessary, either contacts a real store representative or makes a reservation for a visit to the store.

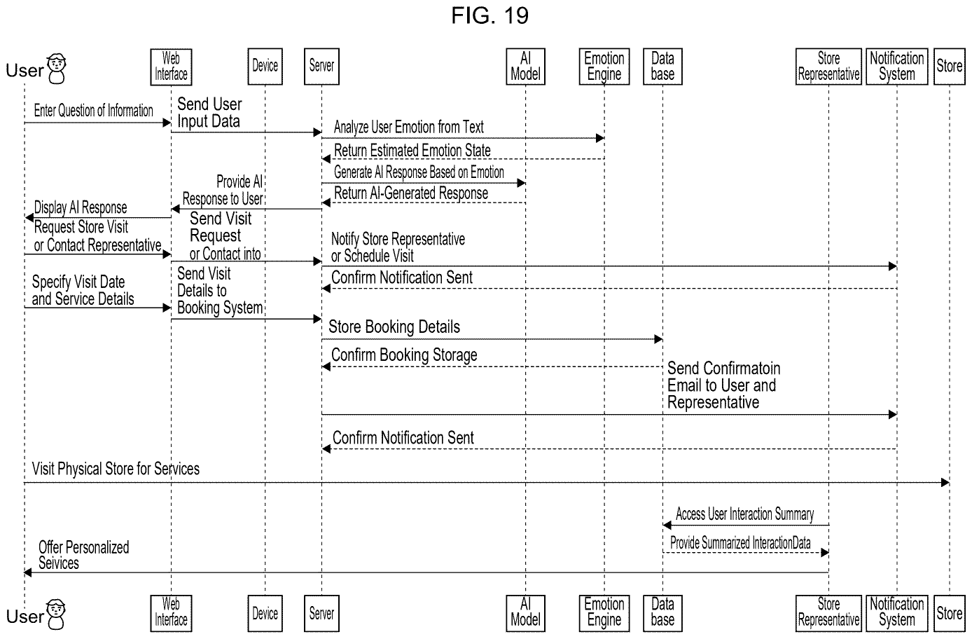

The flow of the identification process in Example 2 is described in FIG. 19.

### Step 1: Receive the User's Input Data

A user accesses the system using a terminal (e.g., PC or smartphone) and enters questions or information. The data entered by the user is sent from the terminal to the server. Specifically, the user opens a browser, accesses the system's web page, enters a question in the text box, and clicks the “Send” button. The input data is the user's question or information (e.g., “Tell me more about your new product”), and the output is the user's input data sent to the server.

### Step 2: Analyze the Received Input Data to Estimate the User's Emotional State.

The server passes the received user input data to the emotion engine (e.g., IBM Watson Tone Analyzer) for emotion analysis. The input data is the user's text data, and the emotion engine analyzes this data to estimate the emotional state (e.g., joy, excitement, discomfort, confusio n). Specifically, the server sends the user's input data to the emotion engine, which analyzes the text, estimates the emotional state, and returns the results to the server. The output is the estimated emotional state.

### Step 3: Generate Answers Using a Generative AI Model Based on the Estimated Emotional State

The server generates answers for the user using a generative AI model (e.g., OpenAI's GPT-4) based on the emotional state obtained from the emotion engine. The input data is the emotion analysis results, and the generative AI model uses this data to generate an appropriate respo nse. Specifically, the server passes the emotion analysis results to the generative AI model, and the generative AI model generates responses according to the emotional state. The output is the generated answers.

### Step 4: Provide the Generated Answers to the User.

The server sends and provides the answers generated by the generative AI model to the user. The input data is the generated answers, and the server sends these answers to the user. Specifically, the server sends the generated answers to the user's terminal, and the user receives the answers through the terminal. The output is the answers provided to the user.

Step 5: After the Initial User Response, Contact a Real Store Representative or Schedule a Visit tother Store.

If the user is satisfied with the initial response, the server contacts a real store representative or makes a reservation for a visit. The input data is the user's satisfaction level and desired contact or reservation information, which the server uses as the basis for the contact or reservati on. Specifically, the user clicks on the “Reserve Visit” button, the server accesses the reservation system, and the user's desired date, time, and service details are entered. The output is a reservation confirmation e-mail or contact notification.

Step 6: Users can Specify the Date and Time of their Visit and Services.

The user may specify the date and time of the visit and the services to be provided when making an appointment to visit the store. The input data is the user's desired visit date and time and service details, which are input by the server into the reservation system. Specifically, the server inputs the user's desired date, time, and service details into the reservation system, sends a reservation confirmation e-mail to the user, and also notifies the person in charge at the real store of the reservation information. The output is a reservation confirmation e-mail and a notification to the person in charge.

### (Example of Application 2)

Next, example of application 2 of example of implement 2 will be described. In the following description, data processing device 12 is referred to as the “server” and smart device 14 is referred to as the “terminal.

In conventional metaverse store systems, it was difficult to respond appropriately to users' emotional states, resulting in a poor user experience. In addition, it was difficult to improve us er satisfaction because there was a lack of a means to promptly contact a real store representative when a user expressed discomfort or confusion.

The specific processing by the specific processing unit 290 of the data processing device 12 in example of application 2 is realized by the following means.

In this invention, the server includes: a means to install an AI in the metaverse store that can learn CS data, etc. and explain its services; a means to contact the person in charge at the real store or make a reservation for a visit to the store after the initial user response; a means to summarize the communication in the metaverse so that it can be shared for the store; and a means to generate appropriate responses based on the user's emotional state estimated by the emotion engine. AI generates appropriate responses based on the user's emotional state as estimated by the emotion engine, and means to contact the person in charge if the user expresses discomfort or confusion. This enables appropriate responses based on the user's emotional stat e, thereby improving the user experience and quickly resolving problems.

CS data” is data related to customer service and includes information such as the content of customer inquiries and response history.

The term “AI” stands for artificial intelligence, a technology in which computers mimic hum an intelligence in learning and reasoning.

The term “metaverse” refers to a virtual space, a 3D virtual world constructed on the Internet.

An “emotion engine” is an algorithm or system for estimating a user's emotional state, a technology that uses natural language processing and machine learning to analyze emotions.

A “real store” is a store that exists in a physical location and can actually be visited by custo mers.

The term “visit reservation” refers to a reservation made by a customer to visit a store on a specific date and time.

A “summary” is a concise summary of detailed information, with key points extracted and ex pressed in a short form.

The term “user experience” refers to the experience or satisfaction a user feels when using a product or service.

Prompt problem-solving” refers to the rapid response and resolution of problems as they aris e.

The system for implementing this invention is configured as follows. First, the server will ins tall an AI in the metaverse store that can learn CS data and other data to explain its services. When a user makes an inquiry in the metaverse, the emotion engine estimates the user's emotional state and the AI generates an appropriate response based on that emotion.

If a user indicates discomfort or confusion, the server will contact a real store representative. The means of contact may be e-mail, telephone, or a dedicated reservation system. If the user wishes to make an appointment to visit the store, he or she can specify the date and time of the visit and the services to be provided.

Interactions in the metaverse are summarized and shared for the store. This summary includes the user's question and the AI's response. This allows real store personnel to quickly understand the user's situation and respond appropriately.
Hardware and software used
Hardware: Smartphones, servers
Software: Python, smtplib (sending email), random (simulation of emotion engine)
Data processing and computation

1. emotion engine: receives user input and estimates emotional states. Specifically, the emotion is analyzed from the user's text using a natural language processing model.

2. AI response generation: Generate appropriate responses based on estimated emotions. For example, if a user is confused, the system will ask, “Sorry for the inconvenience. How can we help you?” when the user is confused.

Contacting the person in charge: If a user expresses discomfort or confusion, the server will contact the person in charge. E-mail is used as the means of contact. The e-mail will include the date and time of the user's desired visit and the nature of the service.

### Concrete Example

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

### Example of Prompt Text

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

In this way, appropriate responses can be made according to the user's emotional state, improving the user experience and quickly resolving problems.

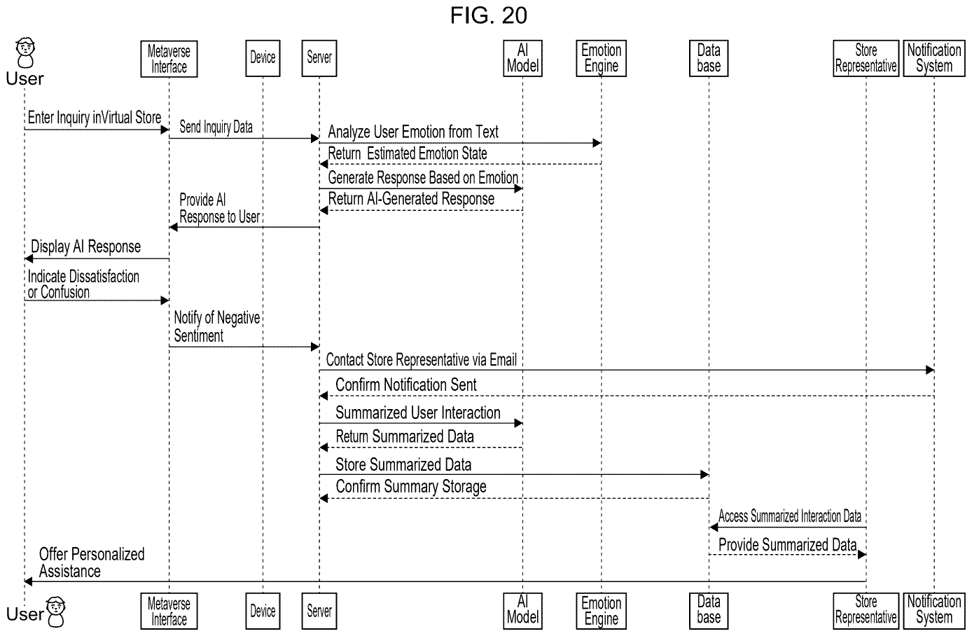

The flow of the identification process in example of application 2 is described in FIG. 20.

### Step 1:

A user makes an inquiry in the metaverse. The user uses a smartphone or computer to access the virtual storefront in the metaverse and enters a question in text format. The entered text is sent to the server.

### Step 2:

The server receives the user's input text and passes it to the emotion engine. The emotion engine uses a natural language processing model to estimate the user's emotional state. Specifically, it analyzes the text data and classifies emotions such as joy, excitement, discomfort, and confusion. The output of the emotion engine is the estimated emotional state.

### Step 3:

The server receives the output of the emotion engine and passes it to the generative AI model. The generative AI model generates appropriate responses based on the estimated emotional state. For example, if the user is confused, the model might say, “Sorry for the inconvenience. How can we help you?” The generated response is returned to the server. The generated answers are returned to the server.

### Step 4:

The server provides the generated answers to the user. The user can check the answers from the AI on the screen of his/her smartphone or computer. This allows users to obtain appropriate answers to their questions.

### Step 5:

If the user indicates discomfort or confusion, the server will contact the real store representative. The user enters the desired date and time of the visit and the services to be provided, and this information is sent to the server. The server uses e-mail to contact the person in charge. The e-mail includes the user's desired date and time of visit and the services to be provided.

### Step 6:

The server summarizes the interactions in the metaverse and shares them for the store. The summary includes the user's question and the AI's response. This allows real store personnel to quickly understand the user's situation and respond appropriately.

In this way, appropriate responses can be made according to the user's emotional state, improving the user experience and quickly resolving problems.

### Example 3

Next, example 3 of exemplary embodiment of implement will be described. In the following description, data processing device 12 is referred to as the “server” and smart device 14 is referred to as the “terminal.

Conventional interaction data between users and AI in the metaverse is often not used as useful information for real store personnel. In addition, it is difficult to provide services that take into account the emotional state of users. This makes it difficult for real store personnel to accurately understand users' needs and emotions and provide appropriate services

The specific processing unit 290 of the data processing device 12 in Example 3 is realized by the following means.

In this invention, the server includes means for collecting dialogue data in the metaverse, means for storing the collected dialogue data in a cloud-based database, means for analyzing the stored dialogue data and generating summary information, means for analyzing the emotion al state of the user using an emotion engine, means for storing the generated summary information and the emotional state are stored in a cloud-based database, and a person in charge of the real store accesses the cloud-based database to view the summary information. This enables real store personnel to understand the content of user interactions and emotional states in the metaverse and to provide more appropriate and personalized services.

The “metaverse” is a three-dimensional virtual space built using virtual reality technology, where users can interact with other users and AI through their avatars.

Dialogue data” is data that includes questions, answers, time stamps, and other information exchanged between users and AI in the metaverse.

A “cloud-based database” is a database service accessible via the Internet and is a platform for storing, managing, and analyzing data.

Summary information” is a concise summary of important information extracted from the dialogue data, including the user's question, the AI's response, and important dialogue points.

An “emotion engine” is software or an algorithm that analyzes user interaction data to identify the user's emotional state (e.g., excitement, frustration, joy, etc.).

A “generative AI model” is an artificial intelligence model that uses natural language processing techniques to analyze textual data and generate summaries and responses.

Real store personnel” are those staff members who provide customer service and provide ser vices in physical stores.

Access” is the act of connecting to a cloud-based database to view, retrieve, or manipulate stored data.

This invention is a system that collects dialogue data in the metaverse, analyzes it, generates summary information, and provides it to real store personnel. An exemplary embodiment of this system is described below.

The server obtains dialogue data from the metaverse platform (e.g., a three-dimensional virtu al space using virtual reality technology) through an API. When a user asks a question to the AI in the metaverse, the question and the AI's answer are sent to the server in real time. For example, if a user asks, “What are the features of your new smartphone?” the question and the AI's answer are collected as dialogue data.

The server stores the collected dialogue data in a cloud-based database (e.g., a database service accessible through the Internet). The database will record the details of each pair of conve rsations. For example, the following records are added

```
{
  “timestamp”: “2023-10-01T12:34:56Z”,.
  “user_question”: “What are the features of your new smartphone?” ,.
  “ai_response”: “The new smartphones feature high-resolution cameras and long-life batterie
s.”
}
```

The server then analyzes the stored dialogue data and generates summary information. A generative AI model (e.g., an artificial intelligence model using natural language processing techniques) is used to generate a summary of the dialogue data. This summary includes the user's question, the AI's response, and the key dialogue points. The generated summary will look like the following

Summary: User asked about features of new smartphone; AI answered about high-resolution camera and long-life battery.

In addition, the server uses an emotion engine (e.g., software or algorithms for analyzing the user's emotional state) to analyze the user's emotional state. The analysis results include the emotions (e.g., excitement, frustration, joy, etc.) that the user exhibited during the interaction. The analysis results are as follows.

### Emotional State: Excited

The server will store the generated summary information and emotional states in a cloud-based database. The records to be stored will be as follows

```
{
  “timestamp”: “2023-10-01T12:34:56Z”,.
  “summary”: “Users asked about the features of the new smartphone and the AI answered ab
out the high-resolution camera and long-life battery.” ,
  “emotion”: “excitement”
}
```

Using the terminal, a real store representative accesses a cloud-based database to view summary information. The representative can determine the user's interest in a new smartphone, provide a detailed description, and suggest relevant accessories.

Examples of prompt sentences to be input into the generative AI model are as follows

Summarize the data of the user's interaction with the AI in the metaverse. Include the following information User Question
AI Answer
Emotional state of the user

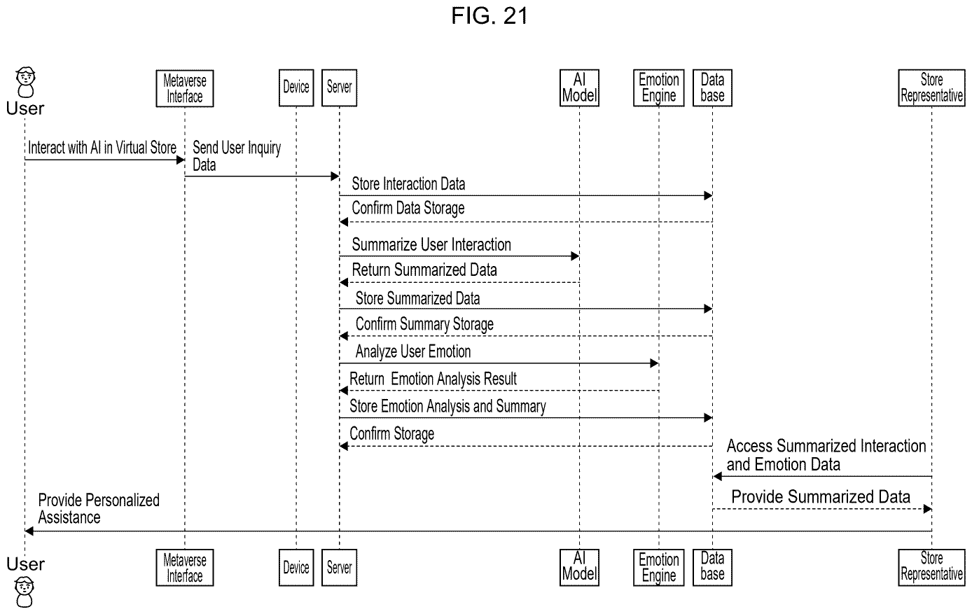

With this system, real store personnel will be able to understand the content of the user's inte reaction and emotional state in the metaverse and provide more appropriate and personalized s ervices. The flow of the identification process in Example 3 is explained using FIG. 21.

### Step 1:

The server obtains dialogue data from the metaverse platform through an API. When a user asks a question to the AI in the metaverse, the question and the AI's answer are sent to the server in real time. The input is the user's question and the AI's answer, and the output is the dialogue data. In concrete operation, the server sends an API request and receives the dialogue data.

### Step 2:

The server stores the collected dialogue data in a cloud-based database. The input is the dialogue data obtained in step 1 and the output is the records stored in the database. As a specific action, the server executes an INSERT query to the database and stores the dialogue data.

### Step 3:

The server analyzes the stored dialogue data and generates summary information. The input is the dialogue data stored in the database and the output is the generated summary information. Specifically, the server inputs dialogue data to a generative AI model and generates a summary. The generative AI model uses natural language processing techniques to generate a summary of the dialog data.

### Step 4:

The server uses an emotion engine to analyze the user's emotional state. The input is the dialog data and the output is the analyzed emotional state. Specifically, the server inputs dialogue data to the emotion engine and analyzes the emotional state. The emotion engine identifies the user's emotion (e.g., excitement, frustration, joy, etc.).

### Step 5:

The server stores the generated summary information and emotional states in a cloud-based d atabase. The input is the summary information and emotional state, and the output is the records stored in the database. Specifically, the server executes an INSERT query against the database and stores the summary information and emotional state.

### Step 6:

Using the terminal, the person in charge of the real store accesses the cloud-based database and views the summary information. The input is the summary information and emotional state stored in the database, and the output is the information the person in charge views. Specifically, the person in charge uses the terminal to send a query to the database to retrieve summary information and emotional states.

### (Example of Application 3)

Next, example 3 of application of example of implement 3 will be described. In the following description, data processing device 12 is referred to as the “server” and smart device 14 is referred to as the “terminal.

There is a need for a system that allows real store personnel to understand the interaction bet ween users and AI in the metaverse, which can be used to improve service and predict the popularity of products. However, current systems make it difficult to summarize interactions in the metaverse in real time and share them, including emotional states. They also lack the means to provide information in a form that can be easily accessed by real store personnel. This makes it difficult to quickly identify user needs and respond appropriately

Specific processing by specific processing unit 290 of data processing device 12 in example of application 3 is realized by the following means. In this invention, the server has the following means: a means to install an AI in the metaverse that can explain its services by learning CS data, etc., in the metaverse store; a means to contact the person in charge at the real store or make a reservation for a visit to the store after the initial user response; a means to summarize the communication in the metaverse so that it can be shared with the store; a means to store the summarized information to be stored in a cloud-based database and made accessible to real store personnel, recording the user's emotional state as part of the summary and sharing it with the store, and providing an application installed on a smart phone or tablet that allows real store personnel to review the summary information. Includes means to provide an ap plication. This makes it possible to summarize in real time the content of the dialog with the user in the metaverse and share it, including the emotional state, so that the real store personnel can quickly understand the user's needs and respond appropriately.

CS data” is data related to customer service and includes information such as customer inquiry details, response history, and satisfaction ratings.

AI″ stands for artificial intelligence, a system that mimics human intelligence using techniques such as machine learning and natural language processing.

A “metaverse” is a virtual reality space, a digital environment in which users can interact and engage in activities with other users and AI through avatars.

A “real store” is a store that exists in a physical location, a place where customers can actually visit to purchase products and receive services.

A “cloud-based database” is a database accessible via the Internet, where data is stored and managed on a cloud server.

The “summary information” is a concise summary of the user's interaction with the AI in the metaverse, including the user's questions, the AI's answers, and the emotional state of the use r.

The term “emotional state” refers to the feelings that a user exhibits during an interaction, such as excitement, frustration, joy, or sadness.

A “smart device” is a type of cell phone, a multifunctional device with Internet access and access to applications.

A “tablet” is a portable computer device with a touch screen and the ability to use applications in the same way as a smart device.

An “application” is a software program that provides a specific function or service and is installed on a smartphone or tablet.

The system for implementing this invention consists of the following

First, the server will install an AI in the metaverse store that can learn CS data and other data to explain the company's services. When a user interacts with the AI in Metaverse, the content of the interaction is recorded in real time. The recorded dialogue will be stored in a cloud-based database as summary information. This summary information includes the user's question, the AI's response, and the user's emotional state.

Real store personnel can then access this summary information using a dedicated application installed on their smartphones or tablets. The application has the ability to retrieve the summary information from a cloud-based database and display it to the person in charge. This allows the person in charge to understand the content of the interaction with the user in the meta verse and to respond appropriately.

As a specific example, if a user asks in the metaverse, “Do you have this item in stock?” the AI will respond, “Yes, we have this product in stock. Along with the content of this dialogue, the emotional state of excitement of the user is also recorded. This information is summarized and stored in a cloud-based database. Real store personnel can access this information using a smartphone or tablet and provide detailed information about the products the user is interested in.

An example of a prompt statement would be in the following form
Summarize the user's interaction with the AI in the metaverse and output in the following for mat
user ID
question
Answer.
emotional condition

### Example: The

User ID: user_001
Q: Do you have this item in stock?
Answer: Yes, we have them in stock.
Emotional State: Excited

In this way, the content of the dialogue in the metaverse can be summarized in real time and shared including the emotional state. This allows real store personnel to quickly understand the needs of users and respond appropriately.

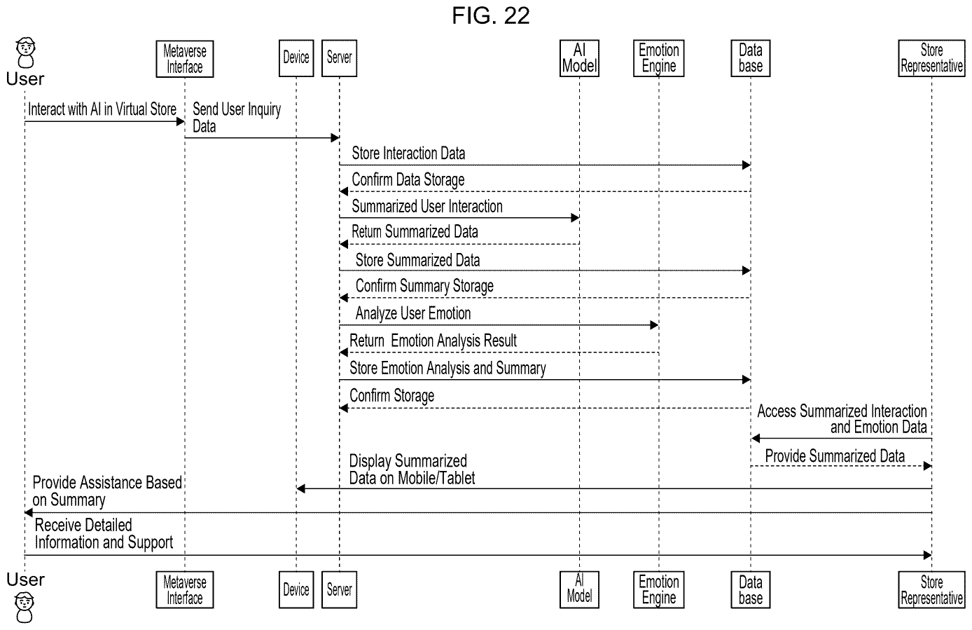

The flow of the identification process in example of application 3 is described in FIG. 22.

### Step 1:

The server will install an AI in the metaverse store that can learn CS data and other data to ex plain the company's services. When a user initiates a dialogue with the AI in the metaverse, the server records the content of the dialogue in real time. The input is the user's question and the AI's answer, and the output is the recorded dialogue data.

### Step 2:

The server stores the recorded dialogue data as summary information in a cloud-based databa se. The summary information includes the user's question, the AI's answer, and the user's emotional state. The input is the recorded dialog data and the output is the summary information stored in the cloud-based database.

### Step 3:

Real store personnel retrieve summary information from the cloud-based database using a dedicated application installed on their smartphones or tablets. The input is a request to access the cloud-based database and the output is the summary information retrieved.

### Step 4:

The terminal displays the retrieved summary information to the person in charge. The information displayed includes the user's question, the AI's answer, and the emotional state. The input is the acquired summary information and the output is the summary information displayed on the terminal screen.

### Step 5:

Based on the summary information displayed, the person in charge will assess the user's needs and respond appropriately. For example, if the user is excited, the person in charge responds by providing detailed information about the product. The input is the summary information displayed, and the output is the response behavior of the person in charge.

The specific processing unit 290 sends the results of the specific processing to the smart dev ice 14. In smart device 14, control unit 46A causes output device 40 to output the results of the specific processing. Microphone 38B acquires audio indicating user input to the results of the specific processing. The control unit 46A transmits the voice data indicating the user input acquired by the microphone 38B to the data processing device 12. In data processing device 12, specific processing unit 290 acquires the voice data.

The data generation model 58 is a so-called Generative AI (Artificial Intelligence). An example of a data generation model 58 is a generative AI such as ChatGPT (registered trademark) (Internet search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions given by the prompts, and outputs the results of the inference in data formats such as voice data and text data. He re, reasoning refers to, for example, analysis, classification, prediction, and/or summarization

Another example of generative AI is Gemini (registered trademark) (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the smart device 14.

### Second Exemplary Embodiment

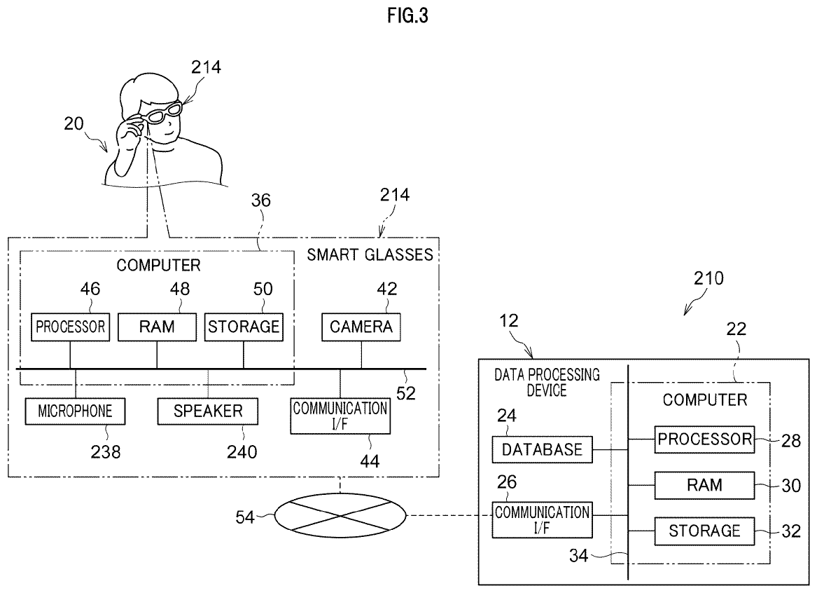

FIG. 3 shows an example of implement of a data processing system 210 for the second exemplary embodiment.

As shown in FIG. 3, data processing system 210 includes data processing device 12 and smart glasses 214. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Smart glasses 214 have a computer 36, microphone 238, speaker 240, camera 42, and communication I/F 44. The computer 36 has a processor 46, RAM 48, and storage 50. Processor 46, RAM 48, and storage 50 are connected to bus 52. The microphone 238, speaker 240, and camera 42 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and captures images of the surroundings of the user 20 (for example, an image range defined by an angle of view equivalent to the field of view of a typical healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

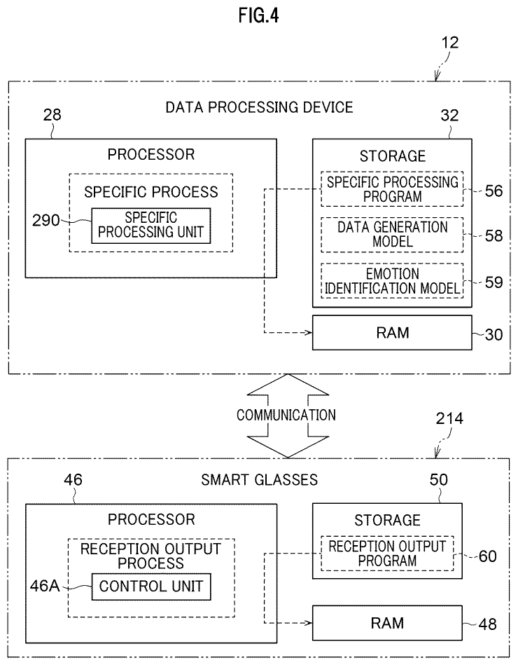

FIG. 4 shows an example of the key functions of data processing device 12 and smart glasses 214. As shown in FIG. 4, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

In smart glasses 214, the reception output process is performed by processor 46. The reception output program 60 is stored in storage 50. Processor 46 reads reception output program 60 from storage 50 and executes the read reception output program 60 on RAM 48. The reception output process is realized by the processor 46 operating as the control unit 46A according to the reception output program 60 executed by the processor 46 on RAM 48.

Next, the specific processing by the specific processing unit 290 of the data processing device e 12 is described.

### Example of Implement 1.”

As an exemplary embodiment of this invention, an AI that can learn CS data and other data to explain the company's services will be installed in the metaverse store. This AI will, for ex ample, use natural language processing technology to understand questions from users and generate appropriate responses. The AI will also record and summarize user questions and other interactive data.

### Example of Implement 2.”

After the initial user response, contact the person in charge of the real store OR make an app ointment to visit the store. This contact can be made, for example, by e-mail, telephone, or through a dedicated reservation system. For the convenience of the user, the date and time of the visit and the services to be provided can be specified at the time of the reservation. Example of implement 3.”

The interactions in the metaverse are summarized and shared for the stores. This sharing is accomplished, for example, by storing the summary information in a cloud-based database that can be accessed by real store personnel. The summary information would include the user's question, the AI's answer, and other important interaction data. This allows real store personnel to understand the content of the user's interaction in the metaverse and provide better servi ce.

The following is a description of the process flow for each example of implement.

### Example of Implement 1.”

Step 1: The AI learns CS data and other data. This learning is performed, for example, using machine learning methods such as supervised learning, unsupervised learning, and reinforcement learning.

Step 2: An AI is installed in the Metaverse store to take questions from users. Questions are entered in text or voice format, which the AI analyzes using natural language processing techniques.

Step 3: The AI generates appropriate answers and provides them to the user. Answers are generated based on training data and include the content that best fits the user's question.

Step 4: The AI records the user's questions and other dialogue data and summarizes this data. Summaries are generated, for example, using keyword extraction or sentence summarization techniques.

### Example of Implement 2.”

Step 1: After the initial user response is completed, the AI contacts the real store representative. The contact is made, for example, by accessing the real store's reservation system through the API and sending the user's information and summarized dialogue data.

Step 2: A real store representative receives the contact and confirms the user's appointment to visit the store. Notification of the confirmed reservation is sent to the user, for example, via e-mail or SMS.

### Example of Implement 3.”

Step 1: The AI summarizes the interactions in the metaverse and stores this in a cloud-based database. The storage is done, for example, by accessing the database through an API and submitting the summary data.

Step 2: A real store representative accesses the database and reviews the summary data. The review is done, for example, through a dedicated dashboard, which allows the representative to keep track of user questions and AI answers, as well as other important interaction data.

### Example 1

The following is an example of exemplary embodiment of implement. In the following description, the data processing device 12 will be referred to as the “server” and the smart glasses 214 will be referred to as the “terminal”.

Conventional user response systems in the virtual space have difficulty in quickly providing appropriate answers to users' questions, and are inadequate in recording and summarizing dialogue data. As a result, the user experience was degraded and the system was not smoothly linked to the physical store. Furthermore, the quality of answers to users' questions was not consistent, which sometimes resulted in reduced user satisfaction.

The specific processing by the specific processing unit 290 of the data processing device 12 in Example 1 is realized by the following means.

In this invention, the server has means to install an AI in the virtual space that can explain its services by learning CS data, etc.; means to contact a person in charge at the physical store or to make a reservation for a visit to the store after the initial user response; means to summarize the interaction in the virtual space so that it can be shared for the store; means to receive questions from the user and analyze the questions using natural language processing technology; means to input prompt sentences into the generated AI model and generate appropriate answers; and means to record the dialog data and provide the generated answers to the user. from the user, means to analyze the question using natural language processing technology, means to input prompt sentences into a generative AI model to generate appropriate responses, means to provide the generated responses to the user, and means to record and summarize the dialogue data. This enables the system to provide prompt and appropriate answers to the user's questions and effectively record and summarize the dialogue data.

CS data” is data related to customer service and includes information such as the content of customer inquiries and response history.

An “AI that can explain its services” is an artificial intelligence that automatically explains the services offered by a company in response to questions from users.

A “virtual space” is a three-dimensional virtual environment built on the Internet, where users can interact with other users and systems through avatars.

A “physical store” is a store that actually exists and that users can visit in person.

Natural language processing technology” is a technology that allows computers to understand and analyze human language.

A “generative AI model” is an artificial intelligence model that generates new information and answers based on input data.

A “prompt sentence” is a sentence that is input into a generative AI model and serves as an instruction for the model to generate an appropriate response.

Dialogue data” is a record of questions and answers exchanged between the user and the AI.

Summarizing” refers to extracting the important parts of the dialogue data and summarizing them in a concise manner.

This invention is a system that provides appropriate answers to questions from users in a virtual space and records and summarizes dialogue data. Specific exemplary embodiments of this system are described below.

First, the server generates an AI program using natural language processing technology. This program has the ability to understand questions from users and generate appropriate respons es. The hardware used should be a high-performance server (e.g., a server with a NVIDIA G PU). The software used will be a natural language processing library (e.g., TensorFlow, PyT orch) or database (e.g., MySQL).

The server places the generated AI program in the virtual space. When this AI receives a que stion from a user, it analyzes the question using natural language processing technology. Specifically, it performs the following data processing and data computation

1. data preprocessing: tokenize user questions and remove unnecessary characters and words

2. question analysis: Analyze the intent of the question using tokenized data.

Answer generation: Generate appropriate answers based on the intent of the question. In this case, a generative AI model (e.g., GPT-3) is used.

4. recording of dialogue data: user questions and AI answers are recorded in a database.

Data summarization: summarize the recorded dialog data for later reference.

As a concrete example, when a user asks the AI in the virtual space, “Please tell me the features of this product,” the following processing is performed.

1. the user enters a question through an interface in the virtual space.

The terminal sends the user's question to the server.

3. the server receives the questions and uses a natural language processing library to tokenize the questions and remove unnecessary characters and words.

4. the server analyzes the intent of the question using the tokenized data and enters the prompt sentence “User: Tell me about the features of this product. ai:” into the data generation mod el.

5. the generated AI model says, “The features of this product are as follows. First, . . . ” The generated AI model generates the answer “First of all . . . ”.

The server sends the generated answers to the terminal.

7. the terminal displays the answer to the user and the user confirms the answer.

8. the server records the user's questions and the AI's answers in a database and summarizes the dialogue data.

An example of a prompt statement would be in the following form

User: What are the features of this product?

AI: This product has the following features. First, . . .

In this way, the server, terminal, and user can work together to provide appropriate answers to user questions and effectively record and summarize dialogue data.

The flow of the identification process in Example 1 is described in FIG. 11.

### Step 1:

The user enters a question in the virtual space.

Specific behavior: The user enters a question through an interface in the virtual space. For ex ample, the user enters, “What are the features of this product?
Input: User's question text
Output: Question text is sent to the terminal

### Step 2:

The terminal sends the user's question to the server.

Specific operation: The terminal sends the questions entered by the user to the server. In this case, the data is transmitted via the Internet.
Input: Question text
Output: Question text is sent to the server

### Step 3:

The server receives the question and begins natural language processing.

Specific operation: The server receives questions sent from terminals. The received questions are analyzed using natural language processing libraries (e.g., TensorFlow, PyTorch).
Input: Question text
Output: Tokenized question data

### Step 4:

The server parses the questions and inputs prompt sentences into the generative AI model.

Specific behavior: The server tokenizes questions and removes unnecessary characters and w ords. It then analyzes the intent of the question and prompts a generative AI model (e.g., GP T-3) with a prompt sentence. For example, the input could be in the form “User: Tell me about the features of this product; AI:”.
Input: Tokenized question data
Output: Prompt statement

### Step 5:

Generative AI models generate appropriate responses.

Specific behavior: the Generate AI model generates appropriate responses based on the prom pt text entered. For example, “This product has the following features. First, . . . ” The model generates the response “First, . . . ”.
Input: Prompt statement
Output: Generated response text

### Step 6:

The server sends the generated responses to the terminal.

Specific behavior: The server sends the answers obtained from the generated AI model to the terminal. At this time, the server converts the response data into an appropriate format before sending it.
Input: Generated response text
Output: Answer text is sent to the terminal

### Step 7:

The terminal displays the answer to the user.

Specific behavior: The terminal displays the answers received from the server to the user. The user checks the answers through the interface in the virtual space.
Input: Answer text
Output: Answers displayed to user

### Step 8:

The server records and summarizes the dialogue data.

Specifics: The server records user questions and AI responses in a database. The recorded dialogue data is then summarized for later reference.
Input: User's question text and AI's answer text
Output: Recorded dialogue data and its summary

### (Example of Application 1)

Next, example of application 1 of example of implement 1 will be described. In the following description, the data processing device 12 will be referred to as the “server” and the smart glasses 214 will be referred to as the “terminal.

In conventional metaverse stores, users had difficulty getting appropriate answers to their questions about products and services. In addition, there was a lack of a means to effectively re cord, summarize, and share user questions and dialogue data with real store personnel, thus creating a need to improve the user experience. In addition, users were unable to provide real-time answers to their questions, which could potentially reduce user satisfaction

The specific processing by the specific processing unit 290 of the data processing device 12 in example of application 1 is realized by the following means.

In this invention, the server includes: a means of installing an AI in the metaverse store that can learn CS data and other data to explain its services; a means of contacting the person in charge of the real store or making a reservation for a store visit after the initial user response; a means of summarizing the interaction in the metaverse and making it available to the store for sharing; a means of generating real-time answers to user questions and providing them to the user; and a means of recording the interaction data, summarizing it, and providing it to the store administrator, The system includes means to generate real-time answers to user questions and provide them to the user, and means to record the dialogue data, summarize it, and provide it to the store administrator. This enables users to obtain appropriate answers in real time when they ask questions about products and services in the metaverse store, and the dialogue data can be effectively recorded, summarized, and shared with real store personnel, there by improving the user experience.

CS data” is data related to customer service and includes information such as the content of customer inquiries and response history.

AI″ stands for artificial intelligence, a system that uses machine learning and natural language processing techniques to mimic human intellectual tasks.

A “metaverse” is a virtual reality space, a digital environment in which users can interact with h other users and content through avatars.

Real-time” refers to the temporal immediacy with which the system can respond immediately to user input.

Dialogue data” is a record of conversations between a user and the AI, including questions and answers.

A “summary” is information that extracts and briefly summarizes the main points of the dialogue data.

A “store manager” is the person or organization responsible for the operation of a real or Met averse store.

A “user” is a consumer or user who visits a Metaverse store and asks questions about a product or service.

A “real store” is a store that exists in a physical location, where customers can visit and purchase goods and services in person.

The “Visit Reservation” is a procedure whereby a user reserves a date and time in advance for a visit to a real store.

The following system configuration is an exemplary embodiment of this invention.

The server will install an AI in the Metaverse store that can learn CS data and other data to explain the company's services. When a user asks a question about a product or service in a Metaverse store, the AI uses natural language processing technology to understand the user's question and generates an appropriate response in real time. This answer is then provided to the user.

The server also records the dialogue data, including the user's questions and AI responses, and provides a summary of this data to the store manager. This helps the store manager understand the needs and interests of the user. It also includes a means to contact a real store representative or implement a reservation for a visit to the store after the initial user response.

The system will be implemented using the following hardware and software
Hardware: (1)
Smartphone or head-mounted display
Software: C
Python
OpenAI API

When the user enters a question into the application, the server uses OpenAI's API to generate the appropriate answer to the user's question. The generated answers are displayed to the us er. Dialogue data is recorded, summarized, and provided to the store manager.

As a concrete example, when a user asks “Tell me about this product” in a virtual store, the AI will respond, “This product uses the latest technology and is very high performance. The dialogue data is recorded and summarized as “User: Tell me about this product; AI: This product uses the latest technology and is very high performance.
Example of a prompt statement: “I am a member of the
User: Tell me about this product.
AI: This product uses the latest technology and is very high performance.

In this way, when a user asks a question about a product or service in a Metaverse store, the user can get an appropriate response in real time, and the dialogue data can be effectively recorded, summarized, and shared with real store personnel, thereby improving the user experience.

The flow of the identification process in Example of Application 1 is described in FIG. 12.

### Step 1:

Users use a terminal (smartphone or head-mounted display) to access the Metaverse store and enter questions about products and services.
Input: User's question text
Output: User's question text is sent to the server

### Step 2:

The server receives the user's question text and analyzes the intent of the question using natural language processing techniques.
Input: User's question text
Output: Data parsed for question intent

### Step 3:

The server generates appropriate answers using the OpenAI API based on the intent of the parsed question.
Input: Data parsed for question intent
Output: Answer text generated from OpenAI API

### Step 4:

The server sends the generated response text to the user's terminal for display to the user.
Input: Answer text generated from OpenAI API
Output: Response text displayed on the user's terminal

### Step 5:

The server records the user's question text and the generated answer text as dialogue data.
Input: user's question text, generated answer text
Output: Recorded dialogue data

### Step 6:

The server summarizes the recorded dialogue data and provides it to the store manager.
Input: recorded dialog data
Output: summarized dialog data

### Step 7:

The server provides a means to contact a real store representative or implement an appointment to visit the store after the initial user response.
Input: user question text, generated answer text, recorded dialog data
Output: Contact a real store representative or make an appointment to visit the store

In this way, when a user asks a question about a product or service in a Metaverse store, the user can get an appropriate response in real time, and the dialogue data can be effectively recorded, summarized, and shared with real store personnel, thereby improving the user experience.

### Example 2

Next, example 2 of exemplary embodiment of implement will be described. In the following description, the data processing device 12 will be referred to as the “server” and the smart glasses 214 will be referred to as the “terminal”.

The conventional system required users to contact a real store representative after receiving initial response or to make an appointment to visit the store. In addition, there was a lack of an efficient and accurate means of conveying information to users when they specify the date and time of their visit and the services to be provided. Furthermore, when sharing interactions within the virtual space with real stores, information was not adequately summarized or organized, which sometimes delayed the store's response.

The specific processing unit 290 of the data processing device 12 in Example 2 is realized by the following means.

In this invention, the server provides a means to install an AI in the virtual space that can exp lain its services by learning CS data, etc., a means to contact the person in charge at the physical store or to make a reservation for a visit after the initial user response, a means to summarize the communication in the virtual space so that it can be shared with the store, a means to provide an interface for the user to input the date and time of the visit and the services provided, a means to store the input data in a database, a means to send notifications according to a specified contact method based on the stored data, and a means to send notifications based on the results of the user feedback. The system includes means to provide an interface for the user to enter the date and time of the visit and service details, means to store the entered data in a database, means to send a notification according to the specified contact method based on the stored data, and means to provide feedback to the user on the results of the notification transmission. This enables the user to efficiently and accurately specify the date and time of the visit and the services to be provided, and to quickly contact the person in charge of the real store. In addition, by summarizing and sharing the exchange within the virtual space, the store can respond quickly and accurately.

CS data” is data related to customer service and includes information such as the content of customer inquiries and response history.

AI″ stands for artificial intelligence, a technology that uses machine learning and natural language processing to automatically process information and provide appropriate answers and services to users.

A “virtual space” is a digital environment generated by computer simulation, which users can access through the Internet to perform various activities.

A “physical store” is a real store that actually exists and where users can visit and receive ser vices in person.

An “interface” is the means by which a user interacts with the system, including user interface elements such as input forms and buttons.

A “database” is a system for efficiently storing, managing, and retrieving data, and is operated using a query language such as SQL.

A “notice” is information sent from the system to a user or contact person, in the form of an e-mail, phone call, or message.

Feedback” is the response or result that the system provides to the user, informing him or her of the results of an operation he or she has performed.

A “summary” is a concise summary of the content of an exchange within a virtual space, extracting and organizing important information.

### Exemplary Embodiment of the Invention

This invention is a system that allows users to contact a real store representative or make an appointment to visit a store after receiving initial response. The system includes an AI, user interface, database, and notification functions installed in a virtual space.

### Hardware and Software Used

The server is developed using the Python programming language and implemented as a web application using the Flask framework. MySQL is used for the database, and the SMTP server and Twilio API are used for notification functions.

### Specific System Operation

The user accesses the system's web page using a web browser; the web page displays a form for entering the date and time of the visit and the services desired. The user enters, for example, that he/she wishes to have “Cut and Color” on “Oct. 15, 2023 at 14:00” and clicks on the submit button.

The server receives the data entered into the form by the user and processes the request using the Flask framework. The input data is stored in a MySQL database. Specifically, an SQL query is generated and inserted into the database.

The server then sends the notification according to the contact method specified by the user based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.

Finally, the server checks whether the notification was successfully sent and feeds back the result to the user. For example, if the notification is successful, the message “Reservation completed” is displayed; if not, the message “Reservation failed. Please try again” message is dis played.

### Examples of Specific Examples and Prompt Sentences

As a concrete example, consider the case where a user makes a reservation at a beauty salon. The user enters on the web form that he/she wishes to request a “cut and color” service on Oct. 15, 2023 at 14:00. The server receives this information and sends an e-mail notification to the person in charge.

### Example of a Prompt Statement:

If a user enters on a web form to make a reservation at a beauty salon that he/she would like to request a “cut and color” service on Oct. 15, 2023 at 14:00, the server should receive this information and send an e-mail notification to the person in charge.

In this way, a system is realized that allows the user to specify the date and time of the visit and the services to be provided for the convenience of the user.

The flow of the identification process in Example 2 is described in FIG. 13.

### Step 1:

The user enters the date and time of the visit and services in a web form.

The user accesses the system's web page using a web browser and enters information in a form to enter the date and time of the visit and the services desired. For example, the user enters that he/she wishes to have “Cut and Color” on “Oct. 15, 2023 at 14:00” and clicks on the submit button.
Input: Date and time of visit, service details
Output: Data input by user

### Step 2:

The server receives the input data and stores it in a database.

The server receives the data entered into the form by the user; it processes the request using the Flask framework and stores the input data in a MySQL database. Specifically, it generates an SQL query and inserts it into the database.
Input: Data entered by user
Output: Data stored in database

### Step 3:

The server sends notifications based on the stored data and according to the specified contact method.

The server sends notifications according to the contact method specified by the user, based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.
Input: data stored in database, contact method
Output: Result of sending notification

### Step 4:

The server feeds back the results of the notification transmission to the user.

The server checks whether the notification was successfully sent and feeds back the result tother user. For example, if the notification is successful, the message “Reservation completed” is displayed; if not, the message “Reservation failed. Please try again” message is displayed.
Input: Result of sending notification
Output: Feedback message to user

### (Example of Application 2)

Next, example of application 2 of example of implement 2 will be described. In the following description, data processing device 12 will be referred to as the “server” and smart glasses 214 will be referred to as the “terminal.

Conventional user response systems within the metaverse lacked coordination with real stores after the initial response, which was problematic and reduced user convenience. In addition, there was a lack of a means to select an appropriate contact person based on the content of the user's inquiry and contact them promptly, which could lead to a decrease in user satisfacti on. Furthermore, the lack of a reservation system that allowed users to specify the date and time of their visit and the services to be provided made it difficult to respond flexibly to user n eeds.

The specific processing by the specific processing unit 290 of the data processing device 12 in example of application 2 is realized by the following means.

In this invention, the server has a means of installing an AI in the metaverse store that can ex plain the company's services by learning CS data, etc., a means of contacting the person in chargeat the real store or making a reservation for a visit after the initial user response, and a means of summarizing the communication in the metaverse and making it available to be shared with the store, Means for the AI to automatically select an appropriate person in charge based on the user's inquiry, and to contact the person in charge via e-mail, telephone, or a dedicated reservation system, including a reservation system that allows the user to specify the date and time of the visit and the services to be provided. This makes it possible to quickly select and contact the appropriate person in charge based on the user's inquiry, thereby improving user convenience and satisfaction.

CS data” is data related to customer service and includes information such as the content of customer inquiries and response history.

AI″ stands for artificial intelligence, a technology that uses machine learning and natural language processing to automatically process information and provide appropriate answers and services to users.

A “metaverse” is a digital environment built on a virtual space, a platform that allows users to interact with other users and systems through their avatars.

A “real store” is a store that exists in a physical location, where users can actually visit and receive products and services.

The “person in charge” is a staff member or employee of the store designated to respond to user inquiries and reservations.

A “reservation system” is a system that allows users to make reservations by specifying the date, time, and services of their visit, either by e-mail, telephone, or through a dedicated online platform.

A “summary” is information that briefly summarizes the content of the exchange in the meta verse, including the user's questions and the AI's answers.

E-mail” is a digital message sent and received via the Internet and is a means of exchanging information between users and personnel.

A “phone call” is a means of exchanging information in real time through voice communication, and is intended for direct communication between a user and a contact person.

Automatic Selection” is the process by which AI automatically selects the best person for the job based on the user's inquiry.

The system for implementing this invention consists of the following

First, the server will install an AI in the metaverse store that can explain the company's services by learning CS data and other data. When a user makes an initial inquiry in the Metaverse, the AI automatically generates an answer based on the content of the inquiry and provides it to the user. This allows users to quickly obtain the information they need.

Next, if the user's inquiry meets certain conditions, the server contacts the person in charge at the real store or makes a reservation for a visit. Specifically, the AI automatically selects an appropriate person based on the user's inquiry and contacts the person via e-mail, telephone, or a dedicated reservation system. This contact includes the user's inquiry, desired visit date and time, and service details.

In addition, the interactions in the metaverse will be summarized and made available for stores to share. The summary will include the user's question and the AI's response, which will al low personnel to quickly understand the user's situation.

To implement this system, the server will use the following hardware and software. Hardwar e: The server must be connected to the Internet and the user's smart phone. Software includes a Python-based program, an SMTP server (e.g., smtp.example.com), and a reservation system.

As a specific example, if a user wishes to “discuss the purchase of a new smartphone” and wishes to make an appointment to visit the store at 14:00 on Oct. 15, 2023, the following prompt statement is generated.
User Name: Taro Yamada
Inquiry: Consultation on purchase of a new smartphone
Preferred date and time: 2023 Oct. 15 14:00
Contact: (phone number)
Email: taro.yamada@example.com
Phone: 090-1234-5678

Based on this prompt statement, the server contacts the person in charge and confirms the us er's appointment to visit the store. This allows the user to receive services at the real store smoothly.

The flow of the identification process in example of application 2 is described in FIG. 14.

### Step 1:

The user makes an initial query in the metaverse.
Input: User's inquiry (e.g., “Consultation on the purchase of a new smartphone”)

Processing: The AI receives the user's inquiry and analyzes its content.
Output: parsed query contents

### Step 2:

AI automatically generates answers based on the user's inquiry and provides them to the user.
Input: parsed query content

Processing: AI generates appropriate responses using a generative AI model.
Output: Generated answers (e.g., “Regarding the purchase of a new smartphone, the following models are recommended . . . ”)

### Step 3:

If the user's inquiry meets certain criteria, the server will contact the person in charge at the real store or make a reservation for the user to visit the store.
Input: parsed query, user's desired date and time of visit, and service details.

Processing: AI automatically selects the appropriate person in charge based on the content of the inquiry and generates prompt text.
Output: Generated prompt text (e.g., “User name: Taro Yamada, Inquiry: Consultation on purchase of new smartphone, Desired date: 2023 Oct. 15 14:00, Contact: E-mail: taro.yamada@example.com, Phone: 090-1234-5678”)

### Step 4:

The server will contact the person in charge via e-mail, telephone, or a dedicated reservation system.
Input: Generated prompt text

Processing: Server sends an email to the person in charge using an SMTP server, or automatically places a call using the phone API, or sends a prompt statement to the reservation system.
Output: Contact person in charge (e.g., reservation information is sent to the person's mailbox)

### Step 5:

Summarize the exchange in the metaverse and share it for the stores.
Input: user questions, AI answers

Processing: The server summarizes the exchange in the metaverse and generates summary in formation.
Output: Generated summary information (e.g., “User's question: How can I help you buy a new smartphone?)

### Step 6:

Share summary information for stores.
Input: Generated summary information

Processing: The server sends the summary information to the person in charge.
Output: Person in charge receives summary information and quickly assesses the user's situation.

### Example 3

Next, example 3 of exemplary embodiment of implement will be described. In the following description, the data processing device 12 will be referred to as the “server” and the smart glasses 214 will be referred to as the “terminal”.

There is a need to efficiently collect, summarize, and share dialogue data between users and AI in the metaverse with real store personnel to provide better service based on user needs and questions. However, current systems often collect, summarize, and share dialogue data manually, which is inefficient and lacks real-time performance.

The specific processing unit 290 of the data processing device 12 in Example 3 is realized by the following means.

In this invention, the server includes means for collecting dialogue data in the metaverse, storing the collected dialogue data in a cloud-based database, summarizing the dialogue data using a data generation AI model, storing the summarized data in a cloud-based database, and all owing a real store representative The summary data is stored in a cloud-based database and made available for viewing by personnel in real stores. This enables dialogue data to be efficiently collected, summarized, and shared in real time within the metaverse.

The “metaverse” is a three-dimensional virtual space built using virtual reality technology, where users can interact with other users and AI through their avatars.

Dialogue data” is data that contains questions, answers, and other important dialogue between the user and the AI in the metaverse.

A “cloud-based database” is a database service accessible via the Internet that stores, manages, and accesses data in a cloud environment.

A “generative AI model” is a model for generating, summarizing, and transforming text data using artificial intelligence techniques, e.g., natural language processing techniques.

Summary data” is a concise summary of important information extracted from the dialogue data by the data generation model.

Real store personnel” are those staff members who provide customer service and provide ser vices in physical stores.

Viewing” is the act of displaying and checking stored data and information.

This invention is a system that efficiently collects, summarizes, and shares dialogue data bet ween users and AI in the metaverse with real store personnel. The following describes a specific implementation of this system.

The server collects real-time dialogue data between the user and AI that takes place in the metaverse. This dialogue data includes the user's questions, the AI's answers, and other important dialogue content. The server stores the collected dialogue data in a cloud-based database (e.g., Amazon RDS or Google Cloud SQL).

The server then uses a data generation model (e.g., a model using natural language processing techniques) to summarize the collected dialogue data. This summary includes the key points of the user's question and the AI's response. The summarized information is again stored in a cloud-based database.

Real store representatives use their terminals to access the cloud-based database and view summary information. This allows the representative to understand the content of the interaction with the user in the metaverse and provide better service.

As a concrete example, consider a user asking in the metaverse, “Do you have the new product in stock?” and the AI responds, “Yes, we have it in stock. This interaction data is collected by the server, which uses a generative AI model to generate a summary that says, “The user asked if the new product is in stock, and the AI responded that it is in stock. This summary in formation is stored in a cloud-based database and can be accessed by real store personnel.

Example of a prompt statement:
Summarize the user's question and the AI's answer.
User Question: Do you have any new products in stock?
AI's response: Yes, we have them in stock.

By inputting this prompt text into a generative AI model, summarized information can be obtained. This system makes it possible to efficiently collect, summarize, and share dialogue data in the metaverse in real time. The flow of the identification process in Example 3 is described in FIG. 15.

### Step 1:

The server collects real-time dialogue data between the user and the AI that takes place in the metaverse. Specifically, if a user asks in the metaverse, “Do you have the new product in stock?” and the AI responds “Yes, we have it in stock,” this dialogue data is captured. The input is the user's question and the AI's response, and the output is the collected dialogue data.

### Step 2:

The server stores the collected dialogue data in a cloud-based database. Specifically, the dialogue data is inserted into the appropriate tables in the database. The input is the collected dialogue data and the output is the dialogue data stored in the database.

### Step 3:

The server inputs the stored dialogue data into the generative AI model to generate a summary. Specifically, inputs the following prompt sentences into the Generating AI Model:

Summarize the user's question and the AI's answer.

User Question: Do you have any new products in stock?

AI's response: Yes, we have them in stock.

The input is the prompt text and dialogue data, and the output is the generated summary data.

### Step 4:

The server stores the generated summary data again in the cloud-based database. Specifically, the summary data is inserted into the appropriate tables in the database. The input is the generated summary data and the output is the summary data stored in the database.

### Step 5:

Using the terminal, a real store representative accesses the cloud-based database and views the summary data. Specifically, the person in charge executes a query to the database to retrieve and display the summary data. The input is a request to access the database and the output is the summary data displayed.

This series of processes enables the efficient collection, summarization, and real-time sharing of dialogue data within the metaverse.

### (Example of Application 3)

Next, example 3 of application of example of implement 3 will be described. In the following description, the data processing device 12 will be referred to as the “server” and the smart glasses 214 will be referred to as the “terminal”.

In order for real store personnel to understand the content of dialogue with users in the metaverse and provide better service, a means to efficiently summarize and share dialogue content is needed. However, current systems make it difficult to summarize dialogue data in the meta verse in real time, store it in a cloud-based database, and allow real store personnel to access it using smartphones. This makes it difficult to quickly identify user needs and interests and provide personalized service.

The specific processing by the specific processing unit 290 of the data processing device 12 in example of application 3 is realized by the following means.

In this invention, the server includes: a means of installing an AI in the metaverse that can learn CS data and other data to explain the company's services; a means of contacting a real store representative or making a reservation for a store visit after the initial user response; a means of summarizing the interaction in the metaverse so that it can be shared with the store; a means of storing the summarized information in a cloud-based database and making it accessible to the real store representative using a smartphone; and a means of including the user's que stion, the AI's response, and other important interaction data in the summary. The summary information includes the user's questions and AI responses, as well as other important interact ion data. This allows the content of the dialogue in the metaverse to be efficiently summarized and quickly accessed by real store personnel, enabling them to understand the needs and interests of users and provide personalized service.

CS data” is data related to customer service, including customer inquiries, feedback, and ser vice history.

AI″ stands for artificial intelligence, a system that mimics human intelligence using techniques such as machine learning and natural language processing.

A “metaverse” is a virtual reality space, a digital environment where users can interact with other users and engage in various activities through their avatars.

A “real store” is a store that exists in a physical location, where customers can visit and purchase goods and services in person.

A “cloud-based database” is a database that can be accessed through the Internet, with data storage and management provided by a cloud service provider.

A “smart device” is a type of cell phone, a multifunctional device with Internet access and access to applications.

Summary information” is a concise summary of detailed data and dialogue, including important points and main points.

A “user question” is a query or question posed by a user to the AI in the metaverse.

An “AI response” is a response or explanation generated by the AI to a user's question.

Important dialogue data” refers to information and data that is considered particularly important in the dialogue between the user and AI, and includes content that is useful in the provision of services.

The following system configuration and processing procedures are used to implement this in vention.

First, the server will install an AI in the metaverse store that can learn CS data and other data to explain the company's services. When a user asks a question to the AI in the metaverse, the AI automatically generates an answer to the question and provides it to the user. This allows users to obtain information about the company's services in the metaverse.

Next, after the initial user response, the server contacts the person in charge of the real store and, if necessary, makes an appointment for the user to visit the store. The user is then ready to receive services at the real store.

In addition, the server will summarize the interactions in the metaverse and store the summary information in a cloud-based database. The summary information includes the user's question, the AI's answer, and other important interaction data. The person in charge of the physical store can use a smartphone to access the cloud-based database and review the summary information. This allows personnel to quickly understand the needs and interests of users and pro vide personalized service.

As a concrete example, consider a user asking in the metaverse, “What are the features of the new smartphone?” and the AI responds, “The new smartphone has a high-resolution camera and a long battery life. This dialogue is summarized and stored in a cloud-based database. Re al store representatives can use their smartphones to access this summarized information and understand the user's interest in the new smartphone.

Examples of prompt sentences to be input into the generative AI model include the following

A user asked in the metaverse, “What are the features of your new smartphone?” and the AI responded, “The new smartphone has a high-resolution camera and a long battery life.” Summarize this dialogue.

In this way, the server, terminal, and user can work together to efficiently summarize the content of the dialogue in the metaverse, which can then be quickly accessed by real store person nel. This will enable the system to understand the needs and interests of users and provide personalized services.

The flow of the identification process in example of application 3 is described in FIG. 16.

### Step 1:

The server will install an AI in the metaverse store that can learn CS data and other data to ex plain the company's services. When a user asks a question to the AI in the metaverse, the AI automatically generates an answer to that question and provides it to the user. The input is the user's question and the output is the AI's answer. Specifically, the AI uses natural language processing technology to analyze the user's question and generate an appropriate response.

### Step 2:

After the initial user response, the server contacts the person in charge at the real store and, if necessary, makes a reservation for the user to visit the store. The input is the user's question and the AI's response, and the output is the information for contacting the person in charge. The specific operation is to send a notification to the person in charge based on the user's quest ion and the AI's response, and then perform the procedures for making a reservation for a visit to the store.

### Step 3:

The server summarizes the interactions in the metaverse and stores the summary information in a cloud-based database. The input is the user's questions and AI responses, and the output is the summary information. Specifically, the server summarizes the dialogue using a generative AI model and stores it in a cloud-based database.

### Step 4:

The person in charge of the real store uses a smartphone to access the cloud-based database and review the summary information. The input is the summary information obtained from the cloud-based database, and the output is the person in charge's understanding. The specific operation is to access the database through the smartphone application and display the summary information.

### Step 5:

The person in charge uses the summary information to understand the needs and interests of the user and provide personalized services. The input is the summary information and the out put is the service provided. Specifically, the system refers to the summary information and suggests products and services suitable for the user.

Further, an emotion engine that estimates the user's emotion may be combined. In other words, the specific processing unit 290 may use the emotion identification model 59 to estimate the user's emotion and perform specific processing using the user's emotion.

### Example of Implement 1.”

In one exemplary embodiment of the invention, the AI includes an emotion engine. The emotion engine estimates the user's emotional state from the user's questions and other interaction data. Specifically, it uses natural language processing and speech analysis technologies to estimate emotions from the user's text and voice input. Image analysis and motion analysis technologies can also be used to analyze the user's facial expressions and body movements.

### Example of Implement 2.”

The user's emotional state, as estimated by the emotion engine, is reflected in the AI's response generation. Specifically, if the user is happy or excited, the AI will generate responses that emphasize those emotions. Conversely, if the user is uncomfortable or confused, the AI will generate a response that softens the emotion. This allows the AI to respond appropriately to the user's emotions.

### Example of Implement 3.”

The emotion engine also influences the summary of interactions in the metaverse. Specifically, the user's emotional state is recorded as part of the summary, which is then shared with the store. For example, if a user expresses strong excitement about a product, this information is shared with the store to help predict product popularity and sales. If a user expresses dissatisfaction with a service, this information is shared with the store to help them improve the serv ice.

The following is a description of the process flow for each example of implement.

### Example of Implement 1.”

Step 1: The AI receives questions and other interactive data from the user.

Step 2: The emotion engine estimates the emotional state of the user from the data received. Specifically, it uses natural language processing and speech analysis technologies to estimate emotions from text and voice input. It also uses image analysis and motion analysis technologies to estimate emotions from the user's facial expressions and body movements.

### Example of Implement 2.”

Step 1: The emotion engine estimates the user's emotional state.

Step 2: The AI generates responses based on the estimated emotional state. Specifically, if the user is happy or excited, it generates a response that emphasizes that emotion. Conversely, if the user is uncomfortable or confused, it generates a response that softens the emotion.

### Example of Implement 3.”

Step 1: The emotion engine estimates the user's emotional state and reflects the results in a summary of the interaction in the metaverse.

Step 2: Summaries are shared with the stores. Specifically, information about the user's strong excitement about the product or the user's dissatisfaction with the service is shared with the store.

Step 3: Stores use the shared information to forecast product popularity and sales, and to imp rove their services.

### Example 1

The following is an example of exemplary embodiment of implement. In the following description, the data processing device 12 will be referred to as the “server” and the smart glasses 214 will be referred to as the “terminal”.

Conventional user response systems in virtual spaces have difficulty generating appropriate responses to users' questions and cannot accurately grasp users' emotional states. As a result, the user experience was degraded, resulting in inducement to the actual store or inability to improve the quality of service. Furthermore, there was a lack of a means to effectively share interactions within the virtual space to the actual store, resulting in a lack of consistency in us er responses

The specific processing by the specific processing unit 290 of the data processing device 12 in Example 1 is realized by the following means.

In this invention, the server includes means to install an artificial intelligence in the virtual space that can learn CS data and other data to explain the company's services, means to contact a person in charge at the actual store or to make a reservation to visit the store after the initial user response, and means to summarize the interaction in the virtual space so that it can be shared for the store, Means to analyze user questions using natural language processing technology to generate appropriate responses, means to use speech analysis technology, image ana lysis technology, and motion analysis technology to estimate the user's emotional state, and means to record and summarize the dialogue data. This makes it possible to generate appropriate answers to the user's questions and to accurately ascertain the user's emotional state. In addition, by effectively sharing the interactions in the virtual space with the actual store, it is possible to maintain consistency in user responses and improve the quality of service.

Artificial Intelligence” is a system that includes technology to generate appropriate responses to user questions and to estimate the user's emotional state.

A “virtual space” is a three-dimensional virtual environment constructed on the Internet, where users can interact with other users and systems through avatars.

Natural language processing technology” is a technology that analyzes text input from users to understand their intentions and generate appropriate responses.

Speech analysis technology” is a technology for converting voice input from users into text and analyzing that text.

Image analysis technology” is a technology that uses a camera to capture a user's facial expressions and body movements, and analyzes the data to estimate the emotional state of the user.

Motion analysis technology” is a technology that analyzes the user's body movements and us es the data to estimate the emotional state of the user.

Dialogue data” is a record of the interaction between the user and the artificial intelligence, and includes information such as the content of questions and answers, as well as emotional st ates.

A “summary” is a concise summary of important information extracted from the dialogue dat a.

A “physical store” is a store that exists in a physical location and that users can actually visit.

The “Visit Reservation” is a procedure whereby a user reserves a date and time in advance for a visit to a physical store.

This invention relates to an artificial intelligence system that explains its services to users in a virtual space. The following is an exemplary embodiment of this system.

First, the server generates a program that combines natural language processing technology, speech analysis technology, image analysis technology, and motion analysis technology. This program includes artificial intelligence to understand questions from users and generate appropriate responses. Specifically, the following technologies will be used.

Natural language processing technology: The server analyzes text input from the user to understand the intent of the question. This technology uses, for example, BERT and GPT-3.

Speech analytics technology: The server converts the user's voice input into text and analyzes that text. Google Cloud Speech-to-Text and Amazon Transcribe are used for this technology

Image Analysis Technology: The server uses cameras to capture the user's facial expressions and body movements to estimate their emotional state. OpenCV and Google Cloud Vision are used for this technology.

Motion Analysis Technology: The server analyzes the user's body movements to estimate their emotional state. Microsoft Azure Kinect DK is used for this technology.

Next, the user accesses the AI within the virtual space. The user logs into a virtual store within the virtual space to access the AI assistant. The user initiates a dialogue by clicking on the AI assistant's icon or avatar within the virtual space.

When a user enters a question in text or voice, the server receives the input and selects the ap propriate analysis technology. For text input, the server selects natural language processing technology; for voice input, it selects speech analysis technology.

The server uses natural language processing technology to analyze the user's question and generate an appropriate response. For example, in response to a question such as “What are the features of this product?”, the server generates an answer such as “This product is made of high-quality materials and is durable.

In addition, the server uses an emotion engine to estimate the user's emotional state. For text input, emotions are analyzed using natural language processing technology, and for voice input, speech analysis technology is used. In addition, by analyzing the user's facial expressions and body movements through the camera, the emotional state is more accurately estimated.

The server returns the generated responses to the user. The response is displayed in a text chat window or played back with audio. For example, “This product is made of high quality materials and is durable.

Finally, the server records the interaction data with the user and summarizes it for later analysis and improvement. For example, the content of the user's questions and emotional state are recorded and used for the next dialogue.

### Specific Examples

User accesses the AI within the virtual space: the user clicks on the AI assistant's avatar in the virtual store and initiates a dialogue.

User enters a question by text or voice: The user enters the question “What are the features of this product?” by text or by voice using the microphone.

Server receives input and selects appropriate parsing technology: The server recognizes that the user's input is text and selects a natural language processing technology.

Server analyzes questions using natural language processing technology: The server analyzes questions using GPT-3 and extracts information about product features.

The server generates an appropriate response: the server generates a response such as “This product is made of high quality materials and is durable.

Server estimates the user's emotional state: The server analyzes the user's emotions from the user's text input and estimates whether the user is satisfied or not.

Server returns the answer to the user: The server displays the generated answer in a text chat window.

Server records and summarizes dialog data: The server records the user's questions and emotional state and summarizes them for use in the next dialog.

Example of a prompt statement: “I am a member of the Tell me what makes this product unique.”

How long will this product last?”

Tell me about the pricing plan for this service.”

In this way, the server can generate appropriate answers to the user's questions and provide better service by estimating the user's emotional state.

The flow of the identification process in Example 1 is described in FIG. 17.

### Step 1:

The user accesses the AI within the virtual space.

Specific behavior: The user logs into a virtual store in the virtual space and clicks on the AI assistant's icon or avatar to initiate a dialogue.
Input: User login information and location in the virtual space.
Output: Initiation of a dialogue session with the AI assistant.

### Step 2:

The user enters questions by text or voice.

Specific behavior: The user types a question in the text chat window or asks a question by voice using the microphone. For example, the user types, “What are the features of this product?
Input: User text or voice input.
Output: text or voice data.

### Step 3:

The server receives the input and selects the appropriate analysis technique.

Specific behavior: The server determines whether the user input is text or voice, and selects natural language processing technology for text input or speech analysis technology for voice i nput.
Input: text or voice data.
Output: Result of analysis technique selection.

### Step 4:

The server analyzes the questions using natural language processing technology.

Specific behavior: The server uses natural language processing techniques (e.g., GPT-3) to analyze the user's questions and understand the intent of the questions.
Input: text data.
Output: Results of analysis of question intent.

### Step 5:

The server generates the appropriate response.

Specific behavior: The server generates appropriate responses based on the analysis results. For example, it generates responses such as “This product is made of high-quality materials and is durable.
Input: Results of the analysis regarding the intent of the question.
Output: Response text.

### Step 6:

The server estimates the user's emotional state.

Specific behavior: The server uses an emotion engine to estimate the user's emotional state. For text input, emotions are analyzed using natural language processing technology; for voice input, speech analysis technology is used. In addition, the emotional state is estimated more accurately by analyzing the user's facial expressions and body movements through the camera.
Input: text data, voice data, image data.
Output: Estimated results of the emotional state.

### Step 7:

The server returns the answer to the user.

Specific behavior: The server returns the generated answers to the user. The answer is displayed in a text chat window or played back with audio. For example, “This product is made of high quality materials and is durable.
Input: Answer text.
Output: Display of answer to user or audio playback.

### Step 8:

The server records and summarizes the dialogue data.

Specific behavior: The server records the user interaction data and summarizes it for later analysis and improvement. For example, it records the user's questions and emotional state, which can be used for the next interaction.
Input: Dialogue data, emotional state estimation results.
Output: summarized dialog data.

### (Example of Application 1)

Next, example of application 1 of example of implement 1 will be described. In the following description, the data processing device 12 will be referred to as the “server” and the smart glasses 214 will be referred to as the “terminal.

Conventional user response systems within a virtual space have had difficulty providing appropriate responses to users' questions and taking into account users' emotional states. In addition, there was a lack of a means to effectively share interactions within the virtual space to the physical store, and there was a need to improve the user experience

The specific processing by specific processing unit 290 of data processing device 12 in example of application 1 is realized by the following means. In this invention, the server has the following means: a means to install an AI in the virtual space that can explain its services by learning CS data, etc.; a means to contact the person in charge at the physical store or make a reservation for a visit after the initial user response; a means to summarize the communication in the virtual space so that it can be shared with the store; a means including an emotion engine that estimates the user's emotional state; a means to analyze the user's voice or text input; a means to use natural language processing technology; and a means to analyze the user's voice or text input. The system includes an emotion engine to estimate the user's emotional state, natural language processing technology to analyze the user's voice and text input, and image analysis technology to analyze the user's facial expressions and actions. This makes it possible to provide appropriate answers to the user's questions and respond in consideration of the emotional state, effectively sharing the interaction within the virtual space to the physical store.

CS data” is data related to customer service and includes information such as the content of customer inquiries and response history.

A “virtual space” is a three-dimensional virtual environment constructed using computer technology, which users can experience interactively.

AI″ stands for artificial intelligence, a system that mimics human intelligence using techniques such as machine learning and natural language processing.

A “physical store” is a real store that actually exists and that customers can visit in person.

The “emotion engine” is a technology for estimating a user's emotional state, and is a system that recognizes emotions using voice and image analysis.

Natural language processing technology” refers to technology that enables computers to understand and generate human language, including text analysis and speech recognition.

Image analysis technology” refers to technology that analyzes image data and extracts information, including object recognition and face recognition.

A “summary” is a short summary of lengthy text or dialogue data, from which important information is extracted and expressed in a concise manner.

Contact” is the act of conveying information and is done by means of telephone, e-mail, or other means.

The “visit reservation” is the act of reserving in advance a date and time for a customer to vis it a physical store so that the store can prepare to accommodate the customer.

The system for implementing this invention consists of the following

First, the server places an AI in the virtual space that can learn CS data and other data to explain its services. Users can access the virtual space using a smartphone or head-mounted display to interact with the AI, which automatically generates answers to their questions and provides those answers to the user.

The server then contacts the person in charge of the physical store after the initial user response or makes a reservation for a visit to the store. This allows the user to receive services at the physical store based on the information obtained in the virtual space.

In addition, the server will summarize the interactions within the virtual space so that they can be shared for the store. This allows physical store personnel to see what questions users have asked and what answers they have received in the virtual space.

The system includes an emotion engine that estimates the user's emotional state. The emotion engine uses natural language processing technology to analyze the user's voice and text inpu t. It also uses image analysis technology to analyze the user's facial expressions and actions. This allows the system to estimate the user's emotional state and respond appropriately.

As a specific example, if a user asks, “Tell me about your latest smartphone,” the AI will res pond, “It is the latest smartphone. It has a high-performance camera and a long-lasting batter y.” The AI responds, “It has a high-performance camera and a long battery life. And if the us er asks, “Where can I buy this product?” the AI will answer, “This product is available at our online store. The AI replies, “This product can be purchased at the online store.

The following hardware and software are used to realize this system
Hardware: Smartphones, head-mounted displays
Software: OpenAI API (generative AI models), Transformers library (natural language processing technology), OpenCV (image analysis technology)
Examples of prompt statements include the following
Tell me about your latest smartphone.”
Where can I buy this product?”
Tell me about the features of your head-mounted display.”

This allows users to receive services at a physical storefront through an interactive experience in the virtual space.

The flow of the identification process in Example of Application 1 is described in FIG. 18.

### Step 1:

The user accesses the virtual space using a smartphone or head-mounted display. The user in puts questions to the AI assistant within the virtual space. Input can be done by text or voice. The input data is sent to the server.

### Step 2:

The server analyzes the received user questions using natural language processing technolog y. Specifically, it uses the OpenAI API to understand the intent of the question and generate an appropriate response. The input is the user's question and the output is the generated answ er.

### Step 3:

The server provides the generated answers to the user. The user checks the answers in the virtual space. The output is the answer provided to the user.

### Step 4:

The server analyzes the user's voice and text input with the emotion engine to estimate the us er's emotional state. The emotion engine uses the Transformers library to recognize emotions. The input is the user's voice or text data, and the output is the estimated emotional state.

### Step 5:

The server analyzes the user's facial expressions and actions using image analysis technology. Specifically, it uses OpenCV to recognize the user's facial expressions and actions to complement the emotional state. The input is the user's image data, and the output is the analyzed facial expression and behavior information.

### Step 6:

The server summarizes the interaction in the virtual space and shares it with the physical store personnel. The summary includes the user's questions and the AI's answers. The input is the interaction data in the virtual space and the output is the summarized information.

### Step 7:

After the initial user response, the server will contact the person in charge of the physical store or implement a reservation for a visit to the store. Email or telephone is used as the means of contact. The input is the user's contact information and the desired appointment date and time, and the output is a confirmation of the contact or appointment.

### Step 8:

Users visit a physical store and receive services based on information obtained in the virtual space. The person in charge of the physical store responds based on the summary information shared from the server. The input is the summary information and the output is the service provided to the user.

### Example 2

Next, example 2 of exemplary embodiment of implement will be described. In the following description, the data processing device 12 will be referred to as the “server” and the smart glasses 214 will be referred to as the “terminal”.

Conventional systems provide a uniform response without taking into account the user's emotional state, and this has led to a problem of reduced user satisfaction. There was also the problem of the time and effort required to contact the person in charge at the real store after the initial response and the complicated procedures for making a visit appointment. Furthermore, the system lacked the ability to specify the date and time of the user's visit and the services to be provided, making it difficult to provide convenience to the user.

The specific processing by the specific processing unit 290 of the data processing device 12 in Example 2 is realized by the following means. In this invention, the server receives the user's input data, analyzes the received input data to estimate the user's emotional state, generates a response using a generative AI model based on the estimated emotional state, provides the generated response to the user, and after the initial user response The system includes means to contact a person in charge of the real store or to make an appointment for the user to visit the store, and means by which the user can specify the date and time of his/her visit and the services to be provided. This allows for appropriate responses based on the user's emotional state, and simplifies the contact and reservation procedures after the initial response, for the convenience of the user.

The “means of receiving user input data” is a function for sending and receiving text and voice data input by the user through the terminal to the server.

The “means for analyzing received input data to estimate the user's emotional state” is a function for analyzing received user input data and estimating the user's emotional state (joy, excitement, discomfort, confusion, etc.) from that data.

The “means for generating responses using a generative AI model” is a function for generating appropriate responses to users using a generative AI model based on the estimated emotion al state.

The “means of providing generated answers to users” is a function for transmitting and providing answers generated by the generative AI model to users.

The “means of contacting a real store representative or scheduling a visit after the initial user response” is a function for contacting a real store representative or scheduling a visit by the user after the initial response is complete.

The “means by which users can specify the date and time of their visit and the services they wish to receive” is a function for users to specify the date and time of their visit and the services they wish to receive.

An “emotion engine” is software or an algorithm that analyzes user input data and estimates the emotional state from that data.

A “generative AI model” is an artificial intelligence model for generating natural language responses based on user input data and emotional states.

An “e-mail, telephone, or dedicated reservation system” is a means of communication or reservation management system used to communicate between a user and a real store representative.

### Exemplary Embodiment of the Invention

This invention is a system that provides appropriate responses based on the user's emotional state and simplifies the contact and appointment procedures after the initial response. Specific exemplary embodiments of this system are described below.

### Means for Receiving User Input Data

A user accesses the system using a terminal (e.g., PC or smartphone) and enters questions or information. The data entered by the user is sent from the terminal to the server. The server is equipped with a high-performance processor (e.g., Intel Xeon processor) to process the received data.

### Means for Analyzing the Received Input Data to Estimate the Emotional State of the User

The server passes the received user input data to an emotion engine (e.g., IBM Watson Tone Analyzer) for emotion analysis. The emotion engine estimates the emotional state (e.g., joy, excitement, discomfort, confusion, etc.) from the user's text. The results of this analysis are fed back to the generative AI model.

### Means of Generating Responses Using a Generative AI Model Based on the Estimated Emotion AI State

The server generates a response to the user using a generative AI model (e.g., OpenAI's GPT-4) based on the emotional state obtained from the emotion engine. For example, if the user is expressing pleasure, the AI will say, “That's great! We're glad you're interested.” and generates a positive response such as “I'm glad you're interested.

### Means of Providing the Generated Answers to the User

The server sends and provides the answers generated by the generative AI model to the user. Users can receive these answers through their terminals.

Means of contacting a real store representative or scheduling a visit to the store after the initial user response.

If the user is satisfied with the initial response, the server will contact a real store representative or implement a reservation for a visit to the store. This contact may be made via email (e. g., Gmail API), telephone (e.g., Twilio API), or through a dedicated reservation system (e.g., Calendly).

A means of specifying the date and time of the user's visit and the services to be provided.

The user may specify the date and time of the visit and the services to be provided when making an appointment to visit the restaurant. The server inputs these information into the reservation system and sends a reservation confirmation e-mail to the user. It also notifies the person in charge of the real store of the reservation information.

### Concrete Example

### Example 1: a User Expresses Delight

User says, “I really like your new product!” and inputs “I love it!”. The emotion engine detects “joy” and the generative AI model says, “That's great! We're glad you're interested. If you need more information, please contact a representative or schedule a visit. The model replies, “That's great!

### Example 2: a User Expresses Confusion

A user types “I am not sure how to use this product. The emotion engine detects “confusion” and the generative AI model says, “Sorry for the inconvenience. If you need further explanation, please contact a representative or make an appointment to visit our store. The model replies, “I am sorry for the inconvenience.

### Example of Prompt Text

“Generate a positive response if the user expresses delight about the new product.”

“If a user is confused about how to use a product, generate a response that reassures them.”

In this way, the system responds appropriately to the user's emotional state and, if necessary, either contacts a real store representative or makes a reservation for a visit to the store.

The flow of the identification process in Example 2 is described in FIG. 19.

### Step 1: Receive the User's Input Data

A user accesses the system using a terminal (e.g., PC or smartphone) and enters questions or information. The data entered by the user is sent from the terminal to the server. Specifically, the user opens a browser, accesses the system's web page, enters a question in the text box, and clicks the “Send” button. The input data is the user's question or information (e.g., “Tell me more about your new product”), and the output is the user's input data sent to the server.

### Step 2: Analyze the Received Input Data to Estimate the User's Emotional State.

The server passes the received user input data to the emotion engine (e.g., IBM Watson Tone Analyzer) for emotion analysis. The input data is the user's text data, and the emotion engine analyzes this data to estimate the emotional state (e.g., joy, excitement, discomfort, confusio n). Specifically, the server sends the user's input data to the emotion engine, which analyzes the text, estimates the emotional state, and returns the results to the server. The output is the estimated emotional state.

### Step 3: Generate Answers Using a Generative AI Model Based on the Estimated Emotional State

The server generates answers to users using a generative AI model (e.g., OpenAI's GPT-4) based on the emotional states obtained from the emotion engine. The input data is the emotion analysis results, and the generative AI model uses this data to generate an appropriate respon se. Specifically, the server passes the emotion analysis results to the generative AI model, and the generative AI model generates responses according to the emotional state. The output is the generated answers.

### Step 4: Provide the Generated Answers to the User.

The server sends and provides the answers generated by the generative AI model to the user. The input data is the generated answers, and the server sends these answers to the user. Specifically, the server sends the generated answers to the user's terminal, and the user receives the answers through the terminal. The output is the answers provided to the user.

Step 5: After the Initial User Response, Contact a Real Store Representative or Schedule a Visit tother Store.

If the user is satisfied with the initial response, the server contacts a real store representative or makes a reservation for a visit. The input data is the user's satisfaction level and desired contact or reservation information, which the server uses as the basis for the contact or reservation. Specifically, the user clicks on the “Reserve Visit” button, the server accesses the reservation system, and the user's desired date, time, and service details are entered. The output is a reservation confirmation e-mail or contact notification.

Step 6: Users can Specify the Date and Time of their Visit and Services.

The user may specify the date and time of the visit and the services to be provided when making an appointment to visit the store. The input data is the user's desired visit date and time and service details, which are input by the server into the reservation system. Specifically, the server inputs the user's desired date, time, and service details into the reservation system, sends a reservation confirmation e-mail to the user, and also notifies the person in charge at the real store of the reservation information. The output is a reservation confirmation e-mail and a notification to the person in charge.

### (Example of Application 2)

Next, example of application 2 of example of implement 2 will be described. In the following description, data processing device 12 will be referred to as the “server” and smart glasses 214 will be referred to as the “terminal.

In conventional metaverse store systems, it was difficult to respond appropriately to users' emotional states, resulting in a poor user experience. In addition, it was difficult to improve us er satisfaction because there was a lack of a means to promptly contact a real store representative when a user expressed discomfort or confusion.

The specific processing by the specific processing unit 290 of the data processing device 12 in example of application 2 is realized by the following means.

In this invention, the server includes: a means to install an AI in the metaverse store that can learn CS data, etc. and explain its services; a means to contact the person in charge at the real store or make a reservation for a visit to the store after the initial user response; a means to summarize the communication in the metaverse so that it can be shared for the store; and a means to generate appropriate responses based on the user's emotional state estimated by the emotion engine. AI generates appropriate responses based on the user's emotional state as estimated by the emotion engine, and means to contact the person in charge if the user expresses discomfort or confusion. This enables appropriate responses based on the user's emotional stat e, thereby improving the user experience and quickly resolving problems.

CS data” is data related to customer service and includes information such as the content of customer inquiries and response history.

The term “AI” stands for artificial intelligence, a technology in which computers mimic hum an intelligence in learning and reasoning.

The term “metaverse” refers to a virtual space, a 3D virtual world constructed on the Internet.

An “emotion engine” is an algorithm or system for estimating a user's emotional state, a technology that uses natural language processing and machine learning to analyze emotions.

A “real store” is a store that exists in a physical location and can actually be visited by custo mers.

The term “visit reservation” refers to a reservation made by a customer to visit a store on a specific date and time.

A “summary” is a concise summary of detailed information, with key points extracted and ex pressed in a short form.

The term “user experience” refers to the experience or satisfaction a user feels when using a product or service.

Prompt problem-solving” refers to the rapid response and resolution of problems as they aris e.

The system for implementing this invention is configured as follows. First, the server places an AI in the metaverse store that can explain its services by learning CS de data, etc. When a user makes an inquiry in the metaverse, the emotion engine estimates the user's emotional stathe, and the AI generates an appropriate response based on that emotion.

If a user indicates discomfort or confusion, the server will contact a real store representative. The means of contact may be e-mail, telephone, or a dedicated reservation system. If the user wishes to make an appointment to visit the store, he or she can specify the date and time of the visit and the services to be provided.

Interactions in the metaverse are summarized and shared for the store. This summary includes the user's question and the AI's response. This allows real store personnel to quickly understand the user's situation and respond appropriately.
Hardware and software used
Hardware: Smartphones, servers
Software: Python, smtplib (sending email), random (simulation of emotion engine)
Data processing and computation

1. emotion engine: receives user input and estimates emotional states. Specifically, the emotion is analyzed from the user's text using a natural language processing model.

2. AI response generation: Generate appropriate responses based on estimated emotions. For example, if a user is confused, the system will ask, “Sorry for the inconvenience. How can we help you?” when the user is confused.

Contacting the person in charge: If a user expresses discomfort or confusion, the server will contact the person in charge. E-mail is used as the means of contact. The e-mail will include the date and time of the user's desired visit and the nature of the service.

### Concrete Example

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

### Example of Prompt Text

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

In this way, appropriate responses can be made according to the user's emotional state, improving the user experience and quickly resolving problems.

The flow of the identification process in example of application 2 is described in FIG. 20.

### Step 1:

A user makes an inquiry in the metaverse. The user uses a smartphone or computer to access the virtual storefront in the metaverse and enters a question in text format. The entered text is sent to the server.

### Step 2:

The server receives the user's input text and passes it to the emotion engine. The emotion engine uses a natural language processing model to estimate the user's emotional state. Specifically, it analyzes the text data and classifies emotions such as joy, excitement, discomfort, and confusion. The output of the emotion engine is the estimated emotional state.

### Step 3:

The server receives the output of the emotion engine and passes it to the generative AI model.
The generative AI model generates appropriate responses based on the estimated emotional state. For example, if the user is confused, the model might say, “Sorry for the inconvenience.
How can we help you?” The generated response is returned to the server. The generated answers are returned to the server.

### Step 4:

The server provides the generated answers to the user. The user can check the answers from the AI on the screen of his/her smartphone or computer. This allows users to obtain appropriate answers to their questions.

Step 5:

If the user indicates discomfort or confusion, the server will contact the real store representative. The user enters the desired date and time of the visit and the services to be provided, and this information is sent to the server. The server uses e-mail to contact the person in charge. The e-mail includes the user's desired date and time of visit and the services to be provided.

### Step 6:

The server summarizes the interactions in the metaverse and shares them for the store. The summary includes the user's question and the AI's response. This allows real store personnel to quickly understand the user's situation and respond appropriately.

In this way, appropriate responses can be made according to the user's emotional state, improving the user experience and resolving problems quickly.

### Example 3

Next, example 3 of exemplary embodiment of implement will be described. In the following description, the data processing device 12 will be referred to as the “server” and the smart glasses 214 will be referred to as the “terminal”.

Conventional dialogue data between users and AI in the metaverse is often not used as useful information for real store personnel. In addition, it is difficult to provide services that take in to account the emotional state of users. This makes it difficult for real store personnel to accurately understand the needs and emotions of users and provide appropriate services.

The specific processing unit 290 of the data processing device 12 in Example 3 is realized by the following means.

In this invention, the server includes means for collecting dialogue data in the metaverse, means for storing the collected dialogue data in a cloud-based database, means for analyzing the stored dialogue data and generating summary information, means for analyzing the emotion al state of the user using an emotion engine, means for storing the generated summary information and the emotional state are stored in a cloud-based database, and a person in charge of the real store accesses the cloud-based database to view the summary information. This enables real store personnel to understand the content of user interaction and emotional states in the metaverse and to provide more appropriate and personalized service.

The “metaverse” is a three-dimensional virtual space built using virtual reality technology, where users can interact with other users and AI through their avatars.

Dialogue data” is data that includes questions, answers, time stamps, and other information exchanged between users and AI in the metaverse.

A “cloud-based database” is a database service accessible via the Internet and is a platform for storing, managing, and analyzing data.

Summary information” is a concise summary of important information extracted from the dialogue data, including the user's question, the AI's response, and important dialogue points.

An “emotion engine” is software or an algorithm that analyzes user interaction data to identify the user's emotional state (e.g., excitement, frustration, joy, etc.).

A “generative AI model” is an artificial intelligence model that uses natural language processing techniques to analyze textual data and generate summaries and responses.

Real store personnel” are those staff members who provide customer service and provide ser vices in physical stores.

Access” is the act of connecting to a cloud-based database to view, retrieve, or manipulate stored data.

This invention is a system that collects dialogue data in the metaverse, analyzes it, generates summary information, and provides it to real store personnel. An exemplary embodiment of this system is described below.

The server obtains dialogue data from the metaverse platform (e.g., a three-dimensional virtu al space using virtual reality technology) through an API. When a user asks a question to the AI in the metaverse, the question and the AI's answer are sent to the server in real time. For example, if a user asks, “What are the features of your new smartphone?” the question and the AI's answer are collected as dialogue data.

The server stores the collected dialogue data in a cloud-based database (e.g., a database service accessible through the Internet). The database will record the details of each dialogue. For example, the following records are added

```
{
  “timestamp”: “2023-10-01T12:34:56Z”,.
  “user_question”: “What are the features of your new smartphone?” ,.
  “ai_response”: “The new smartphones feature high-resolution cameras and long-life batterie
s.”
}
```

The server then analyzes the stored dialogue data and generates summary information. A generative AI model (e.g., an artificial intelligence model using natural language processing techniques) is used to generate a summary of the dialogue data. This summary includes the user's question, the AI's response, and the key dialogue points. The generated summary will look like the following

Summary: User asked about features of new smartphone; AI answered about high-resolution camera and long-life battery.

In addition, the server uses an emotion engine (e.g., software or algorithms for analyzing the user's emotional state) to analyze the user's emotional state. The analysis results include the emotions (e.g., excitement, frustration, joy, etc.) that the user exhibited during the interaction. The analysis results are as follows.

### Emotional State: Excited

The server will store the generated summary information and emotional states in a cloud-based database. The records to be stored will be as follows

```
{
  “timestamp”: “2023-10-01T12:34:56Z”,.
  “summary”: “Users asked about the features of the new smartphone and the AI answered ab
out the high-resolution camera and long-life battery.” ,
  “emotion”: “excitement”
}
```

Using the terminal, a real store representative accesses a cloud-based database to view summary information. The representative can determine the user's interest in a new smartphone, provide a detailed description, and suggest relevant accessories.

Examples of Prompt Sentences to be Input into the Generative AI Model are as Follows

Summarize the data of the user's interaction with the AI in the metaverse. Please include the following information:
User Question
AI Answer
Emotional state of the user

With this system, the person in charge of the real store will be able to understand the content of the user's interaction and emotional state in the metaverse and provide more appropriate and personalized services. The flow of the identification process in Example 3 is explained using FIG. 21.

### Step 1:

The server obtains dialogue data from the metaverse platform through an API. When a user asks a question to the AI in the metaverse, the question and the AI's answer are sent to the server in real time. The input is the user's question and the AI's answer, and the output is the dialogue data. In concrete operation, the server sends an API request and receives the dialogue d ata.

### Step 2:

The server stores the collected dialogue data in a cloud-based database. The input is the dialogue data obtained in step 1 and the output is the records stored in the database. As a specific action, the server executes an INSERT query to the database and stores the dialogue data.

### Step 3:

The server analyzes the stored dialogue data and generates summary information. The input is the dialogue data stored in the database and the output is the generated summary information. Specifically, the server inputs dialogue data to a generative AI model and generates a summary. The generative AI model uses natural language processing techniques to generate a summary of the dialog data.

### Step 4:

The server uses an emotion engine to analyze the user's emotional state. The input is the dialog data and the output is the analyzed emotional state. Specifically, the server inputs dialogue data to the emotion engine and analyzes the emotional state. The emotion engine identifies the user's emotion (e.g., excitement, frustration, joy, etc.).

### Step 5:

The server stores the generated summary information and emotional states in a cloud-based d atabase. The input is the summary information and emotional state, and the output is the records stored in the database. Specifically, the server executes an INSERT query against the database and stores the summary information and emotional state.

### Step 6:

Using a terminal, a real store representative accesses the cloud-based database and views the summary information at. The input is the summary information and emotional state stored in the database, and the output is the information the person in charge views. Specifically, the person in charge uses the terminal to send a query to the database to retrieve summary information and emotional states.

### (Example of Application 3)

Next, example 3 of application of example of implement 3 will be described. In the following description, the data processing device 12 will be referred to as the “server” and the smart glasses 214 will be referred to as the “terminal”.

There is a need for a system that allows real store personnel to understand the interaction bet ween users and AI in the metaverse, which can be used to improve service and predict the popularity of products. However, current systems make it difficult to summarize interactions in the metaverse in real time and share them, including emotional states. They also lack the means to provide information in a form that can be easily accessed by real store personnel. This makes it difficult to quickly identify user needs and respond appropriately

Specific processing by specific processing unit 290 of data processing device 12 in example of application 3 is realized by the following means. In this invention, the server has the following means: a means to install an AI in the metaverse that can explain its services by learning CS data, etc., in the metaverse store; a means to contact the person in charge at the real store or make a reservation for a visit to the store after the initial user response; a means to summarize the communication in the metaverse so that it can be shared with the store; a means to store the summarized information to be stored in a cloud-based database and made accessible to real store personnel, recording the user's emotional state as part of the summary and sharing it with the store, and providing an application installed on a smart phone or tablet that allows real store personnel to review the summary information. Includes means to provide an ap plication. This makes it possible to summarize in real time the content of the dialog with the user in the metaverse and share it, including the emotional state, so that the real store personnel can quickly understand the user's needs and respond appropriately.

CS data” is data related to customer service and includes information such as customer inquiry details, response history, and satisfaction ratings.

AI″ stands for artificial intelligence, a system that mimics human intelligence using techniques such as machine learning and natural language processing.

A “metaverse” is a virtual reality space, a digital environment in which users can interact and engage in activities with other users and AI through avatars.

A “real store” is a store that exists in a physical location, a place where customers can actually visit to purchase products and receive services.

A “cloud-based database” is a database accessible via the Internet, where data is stored and managed on a cloud server.

The “summary information” is a concise summary of the user's interaction with the AI in the metaverse, including the user's questions, the AI's answers, and the emotional state of the user.

The term “emotional state” refers to the feelings that a user exhibits during an interaction, such as excitement, frustration, joy, or sadness.

A “smart device” is a type of cell phone, a multifunctional device with Internet access and access to applications.

A “tablet” is a portable computer device with a touch screen and the ability to use applications in the same way as a smart device.

An “application” is a software program that provides a specific function or service and is installed on a smartphone or tablet.

The system for implementing this invention consists of the following

First, the server will install an AI in the metaverse store that can learn CS data and other data to explain the company's services. When a user interacts with the AI in Metaverse, the content of the interaction is recorded in real time. The recorded dialogue will be stored in a cloud-based database as summary information. This summary information includes the user's question, the AI's response, and the user's emotional state.

Real store personnel can then access this summary information using a dedicated application installed on their smartphones or tablets. The application has the ability to retrieve the summary information from a cloud-based database and display it to the person in charge. This allows the person in charge to understand the content of the interaction with the user in the meta verse and to respond appropriately.

As a specific example, if a user asks in the metaverse, “Do you have this item in stock?” the AI will respond, “Yes, we have this product in stock. Along with the content of this dialogue, the emotional state of excitement of the user is also recorded. This information is summarized and stored in a cloud-based database. Real store personnel can access this information using a smartphone or tablet and provide detailed information about the products the user is interested in.

An example of a prompt statement would be in the following form
Summarize the user's interaction with the AI in the metaverse and output in the following format user ID
question
Answer.
emotional condition
Example: The
User ID: user_001
Q: Do you have this item in stock?
Answer: Yes, we have them in stock.
Emotional State: Excited

In this way, the content of the dialogue in the metaverse can be summarized in real time and shared, including the emotional state. This allows real store personnel to quickly understand the needs of users and respond appropriately.

The flow of the identification process in example of application 3 is described in FIG. 22.

### Step 1:

The server will install an AI in the metaverse store that can learn CS data and other data to ex plain the company's services. When a user initiates a dialogue with the AI in the metaverse, the server records the content of the dialogue in real time. The input is the user's question and the AI's answer, and the output is the recorded dialogue data.

### Step 2:

The server stores the recorded dialogue data as summary information in a cloud-based databa se. The summary information includes the user's question, the AI's answer, and the user's emotional state. The input is the recorded dialog data and the output is the summary information stored in the cloud-based database.

### Step 3:

Real store personnel retrieve summary information from the cloud-based database using a dedicated application installed on their smartphones or tablets. The input is a request to access the cloud-based database and the output is the summary information retrieved.

### Step 4:

The terminal displays the retrieved summary information to the person in charge. The information displayed includes the user's question, the AI's answer, and the emotional state. The input is the acquired summary information and the output is the summary information displayed on the terminal screen.

### Step 5:

Based on the summary information displayed, the person in charge will assess the user's needs and respond appropriately. For example, if the user is excited, the person in charge responds by providing detailed information about the product. The input is the summary information displayed, and the output is the response behavior of the person in charge.

The specific processing unit 290 sends the results of the specific processing to the smart glasses 214. In smart glasses 214, control unit 46A causes speaker 240 to output the results of the specific processing. Microphone 238 acquires audio indicating user input to the results of the specific processing. The control unit 46A transmits the voice data indicating the user input acquired by the microphone 238 to the data processing device 12. In the data processing device 12, the specific processing unit 290 acquires the voice data.

The data generation model 58 is a so-called Generative AI (Artificial Intelligence). An example of a data generation model 58 is a generative AI such as ChatGPT (Internet Search <URL: https://openai.com/blog/chatgpt>). The data generation model 58 is obtained by having a neural network perform deep learning. Prompts containing instructions are input to the data generation model 58, as well as data for inference, such as voice data indicating audio, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.c
om/?hl=ja>).

In the above exemplary embodiment, an example of implement in which the specific processing is performed by the data processing device 12 is given, but the technology of the present disclosure is not limited to this, and the specific processing may be performed by the smart glasses 214.

### Third Exemplary Embodiment

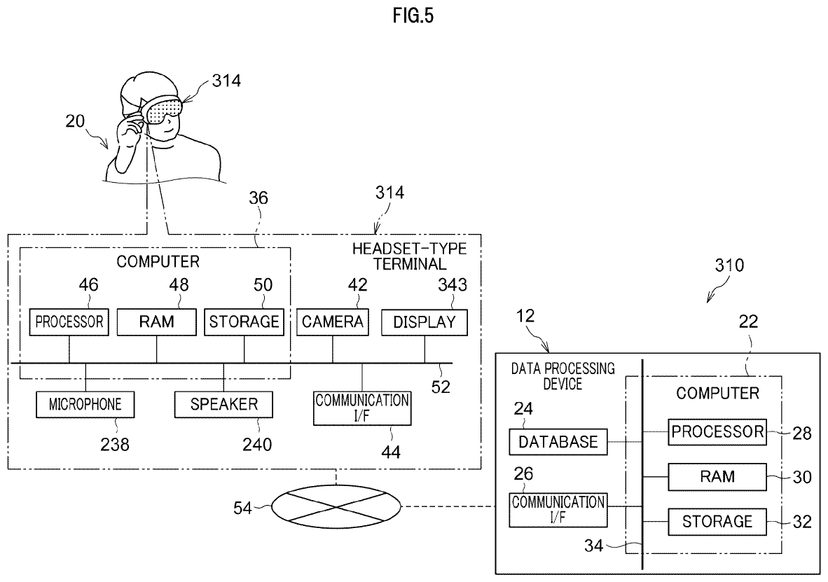

FIG. 5 shows an example of implement of a data processing system 310 for the third exemplary embodiment.

As shown in FIG. 5, data processing system 310 has data processing device 12 and headset-type terminal 314. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

The headset-type terminal 314 has a computer 36, microphone 238, speaker 240, camera 42, communication I/F 44, and display 343. The computer 36 has a processor 46, RAM 48, and storage 50. Processor 46, RAM 48, and storage 50 are connected to bus 52. The microphone 238, speaker 240, camera 42, and display 343 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and images the surroundings of the user 20 (for example, the imaging range defined by an angle of view equivalent to the field of view of an average healthy person).

Communication I/F 44 is connected to network 54. The communication I/Fs 44 and 26 are re sponsible for transferring and receiving various types of information between the processor 46 and the processor 28 via the network 54. The transfer of various information between the processor 46 and the processor 28 using the communication I/Fs 44 and 26 is performed in a secure manner.

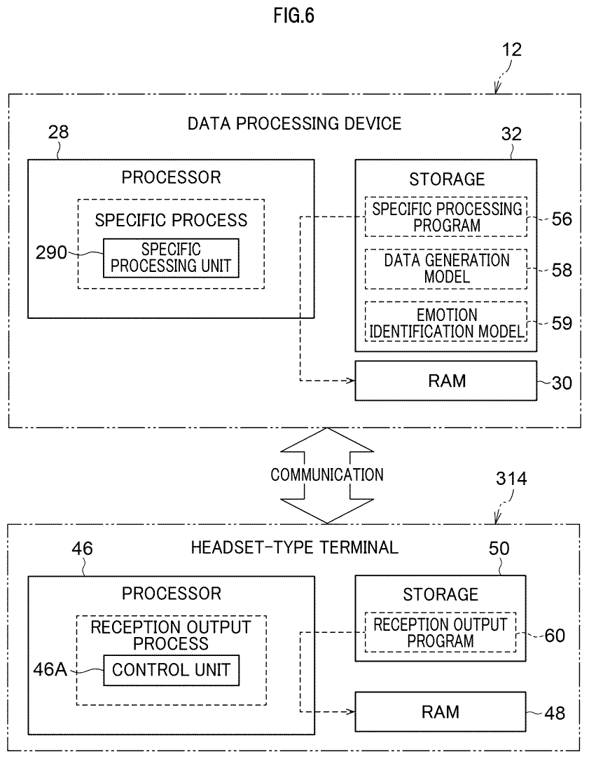

FIG. 6 shows an example of the key functions of data processing device 12 and headset-ty pe terminal 314. As shown in FIG. 6, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

At the headset-type terminal 314, the reception output process is performed by processor 46. The reception output program 60 is stored in the storage 50. Processor 46 reads reception output program 60 from storage 50 and executes the read reception output program 60 on RAM 48. The reception output process is realized by the processor 46 operating as the control unit 46A according to the reception output program 60 executed by the processor 46 on RAM 48

Next, the specific processing by the specific processing unit 290 of the data processing device e 12 is described.

### Example of Implement 1.”

As an exemplary embodiment of this invention, an AI that can learn CS data and other data to explain the company's services will be installed in the metaverse store. This AI will, for ex ample, use natural language processing technology to understand questions from users and generate appropriate responses. The AI will also record and summarize user questions and other interactive data.

### Example of Implement 2.”

After the initial user response, contact the person in charge of the real store OR make an app ointment to visit the store. This contact can be made, for example, by e-mail, telephone, or through a dedicated reservation system. For the convenience of the user, the date and time of the visit and the services to be provided can be specified at the time of the reservation. Example of implement 3.”

The interactions in the metaverse are summarized and shared for the stores. This sharing is accomplished, for example, by storing the summary information in a cloud-based database that can be accessed by real store personnel. The summary information would include the user's question, the AI's answer, and other important interaction data. This allows real store personnel to understand the content of the user's interaction in the metaverse and provide better service.

The following is a description of the process flow for each example of implement.

### Example of Implement 1.”

Step 1: The AI learns CS data and other data. This learning is performed, for example, using machine learning methods such as supervised learning, unsupervised learning, and reinforcement learning.

Step 2: An AI is installed in the Metaverse store to take questions from users. Questions are entered in text or voice format, which the AI analyzes using natural language processing technology.

Step 3: The AI generates appropriate answers and provides them to the user. Answers are generated based on training data and include the content that best fits the user's question.

Step 4: The AI records the user's questions and other dialogue data and summarizes this data. Summaries are generated, for example, using keyword extraction or sentence summarization techniques.

### Example of Implement 2.”

Step 1: After the initial user response is completed, the AI contacts the real store representative. The contact is made, for example, by accessing the real store's reservation system through the API and sending the user's information and summarized dialogue data.

Step 2: A real store representative receives the contact and confirms the user's appointment to visit the store. Notification of the confirmed reservation is sent to the user, for example, via e-mail or SMS.

### Example of Implement 3.”

Step 1: The AI summarizes the interactions in the metaverse and stores this in a cloud-based database. The storage is done, for example, by accessing the database through an API and submitting the summary data.

Step 2: A real store representative accesses the database and reviews the summary data. The review is done, for example, through a dedicated dashboard, which allows the representative to keep track of user questions and AI answers, as well as other important interaction data.

### Example 1

Next, example 1 of exemplary embodiment of implement will be described. In the following description, data processing device 12 is referred to as the “server” and headset-type terminal 314 is referred to as the “terminal.

Conventional user response systems in the virtual space have difficulty in quickly providing appropriate answers to users' questions, and are inadequate in recording and summarizing dialogue data. As a result, the user experience was degraded and the system was not smoothly linked to the physical store. Furthermore, the quality of answers to users' questions was not consistent, which sometimes resulted in reduced user satisfaction.

The specific processing by the specific processing unit 290 of the data processing device 12 in Example 1 is realized by the following means.

In this invention, the server has means to install an AI in the virtual space that can learn CS data and other data to explain its services, means to contact a person in charge of the physical store or make a reservation for a visit to the store after the initial user response, means to summarize the interaction in the virtual space and to be shared for the store, means to receive que stions from the user and analyze the questions using natural language processing technology, means to input prompt sentences into the generated AI model and generate appropriate responses, means to record the dialogue data and provide the generated responses to the user, means to record the dialogue data and provide the responses to the user, and means to analyze the questions using natural language processing technology. from the user, means to analyze the question using natural language processing techniques, means to input prompt sentences into a generative AI model to generate appropriate responses, means to provide the generated responses to the user, and means to record and summarize the dialogue data. This enables the system to provide prompt and appropriate answers to the user's questions and effectively record and summarize the dialogue data.

CS data” is data related to customer service and includes information such as the content of customer inquiries and response history.

An “AI that can explain its services” is an artificial intelligence that automatically explains the services offered by a company in response to questions from users.

A “virtual space” is a three-dimensional virtual environment built on the Internet, where users can interact with other users and systems through avatars.

A “physical store” is a store that actually exists and that users can visit in person.

Natural language processing technology” is a technology that allows computers to understand and analyze human language.

A “generative AI model” is an artificial intelligence model that generates new information and answers based on input data.

A “prompt sentence” is a sentence that is input into a generative AI model and serves as an instruction for the model to generate an appropriate response.

Dialogue data” is a record of questions and answers exchanged between the user and the AI.

Summarizing” refers to extracting the important parts of the dialogue data and summarizing them in a concise manner.

This invention is a system that provides appropriate answers to questions from users in a virtual space and records and summarizes dialogue data. Specific exemplary embodiments of this system are described below.

First, the server generates an AI program using natural language processing technology. This program has the ability to understand questions from users and generate appropriate respons es. The hardware used should be a high-performance server (e.g., a server with a NVIDIA G PU). The software used will be a natural language processing library (e.g., TensorFlow, PyT orch) or database (e.g., MySQL).

The server places the generated AI program in the virtual space. When this AI receives a que stion from a user, it analyzes the question using natural language processing technology. Specifically, it performs the following data processing and data computation
1. data preprocessing: tokenize user questions and remove unnecessary characters and words
2. question analysis: Analyze the intent of the question using tokenized data.

Answer generation: Generate appropriate answers based on the intent of the question. In this case, use a generative AI model (e.g. GPT-3).

4. recording of dialogue data: user questions and AI answers are recorded in a database.

Data summarization: summarize the recorded dialog data for later reference.

As a concrete example, when a user asks the AI in the virtual space, “Please tell me the features of this product,” the following processing is performed.

1. the user enters a question through an interface in the virtual space.

The terminal sends the user's question to the server.

3. the server receives the questions and uses a natural language processing library to tokenize the questions and remove unnecessary characters and words.

4. the server analyzes the intent of the question using the tokenized data and enters the prompt sentence “User: Tell me about the features of this product. ai:” into the data generation mod el.

5. the generated AI model says, “The features of this product are as follows. First, . . . ” The generated AI model generates the answer “First of all . . . ”.

The server sends the generated answers to the terminal.

7. the terminal displays the answer to the user and the user confirms the answer.

8. the server records the user's questions and the AI's answers in a database and summarizes the dialogue data.

An example of a prompt statement would be in the following form

User: What are the features of this product?

AI: This product has the following features. First, . . .

In this way, the server, terminal, and user can work together to provide appropriate answers to user questions and effectively record and summarize dialogue data.

The flow of the identification process in Example 1 is described in FIG. 11.

### Step 1:

The user enters a question in the virtual space.

Specific behavior: The user enters a question through an interface in the virtual space. For ex ample, the user enters, “What are the features of this product?
Input: User's question text
Output: Question text is sent to the terminal

### Step 2:

The terminal sends the user's question to the server.

Specific operation: The terminal sends the questions entered by the user to the server. In this case, the data is transmitted via the Internet.
Input: Question text
Output: Question text is sent to the server

### Step 3:

The server receives the question and begins natural language processing.

Specific operation: The server receives questions sent from terminals. The received questions are analyzed using natural language processing libraries (e.g., TensorFlow, PyTorch).
Input: Question text
Output: Tokenized question data

### Step 4:

The server parses the questions and inputs prompt sentences into the generative AI model.

Specific behavior: The server tokenizes questions and removes unnecessary characters and w ords. It then analyzes the intent of the question and prompts a generative AI model (e.g., GP T-3) with a prompt sentence. For example, the input could be in the form “User: Tell me about the features of this product; AI:”.
Input: Tokenized question data
Output: Prompt statement

### Step 5:

Generative AI models generate appropriate responses.

Specific behavior: the Generate AI model generates appropriate responses based on the prom pt text entered. For example, “This product has the following features. First, . . . ” The model generates the response “First, . . . ”.
Input: Prompt statement
Output: Generated response text

### Step 6:

The server sends the generated responses to the terminal.

Specific behavior: The server sends the answers obtained from the generated AI model to the terminal. At this time, the server converts the response data into an appropriate format before sending it.
Input: Generated response text
Output: Answer text is sent to the terminal

### Step 7:

The terminal displays the answer to the user.

Specific behavior: The terminal displays the answers received from the server to the user. The user checks the answers through the interface in the virtual space.
Input: Answer text
Output: Answers displayed to user

### Step 8:

The server records and summarizes the dialogue data.

Specifics: The server records user questions and AI responses in a database. The recorded dialogue data is then summarized for later reference.
Input: User's question text and AI's answer text
Output: Recorded dialogue data and its summary

### (Example of Application 1)

Next, example of application 1 of example of implement 1 will be described. In the following description, data processing device 12 is referred to as the “server” and headset-type terminal 314 is referred to as the “terminal.

In conventional metaverse stores, users had difficulty getting appropriate answers to their questions about products and services. In addition, there was a lack of a means to effectively re cord, summarize, and share user questions and dialogue data with real store personnel, thus creating a need to improve the user experience. In addition, users were unable to provide real-time answers to their questions, which could potentially reduce user satisfaction

The specific processing by the specific processing unit 290 of the data processing device 12 in example of application 1 is realized by the following means.

In this invention, the server includes: a means of installing an AI in the metaverse store that can learn CS data and other data to explain its services; a means of contacting the person in charge of the real store or making a reservation for a store visit after the initial user response; a means of summarizing the interaction in the metaverse and making it available to the store for sharing; a means of generating real-time answers to user questions and providing them to the user; and a means of recording the interaction data, summarizing it, and providing it to the store administrator, The system includes means to generate real-time answers to user questions and provide them to the user, and means to record the dialogue data, summarize it, and provide it to the store administrator. This enables users to obtain appropriate answers to their questions about products and services in the metaverse store in realta time, and the dialogue data can be effectively recorded, summarized, and shared with real store personnel, thereby improving the user experience.

CS data” is data related to customer service and includes information such as the content of customer inquiries and response history.

AI″ stands for artificial intelligence, a system that uses machine learning and natural language processing techniques to mimic human intellectual tasks.

A “metaverse” is a virtual reality space, a digital environment in which users can interact with h other users and content through avatars.

Real-time” refers to the temporal immediacy with which the system can respond immediately to user input.

Dialogue data” is a record of conversations between a user and the AI, including questions and answers.

A “summary” is information that extracts and briefly summarizes the main points of the dialogue data.

A “store manager” is the person or organization responsible for the operation of a real or Met averse store.

A “user” is a consumer or user who visits a Metaverse store and asks questions about a product or service.

A “real store” is a store that exists in a physical location, where customers can visit and purchase goods and services in person.

The “Visit Reservation” is a procedure whereby a user reserves a date and time in advance for a visit to a real store.

The following system configuration is an exemplary embodiment of this invention.

The server will install an AI in the Metaverse store that can learn CS data and other data to explain the company's services. When a user asks a question about a product or service in a Metaverse store, the AI uses natural language processing technology to understand the user's question and generates an appropriate response in real time. This answer is then provided to the user.

The server also records the dialogue data, including the user's questions and AI responses, and provides a summary of this data to the store manager. This helps the store manager understand the needs and interests of the user. It also includes a means to contact a real store representative or implement a reservation for a visit to the store after the initial user response.

The system will be implemented using the following hardware and software
Hardware: (1)
Smartphone or head-mounted display
Software: C
Python
OpenAI API

When the user enters a question into the application, the server uses OpenAI's API to generate the appropriate answer to the user's question. The generated answers are displayed to the us er. Dialogue data is recorded, summarized, and provided to the store manager.

As a concrete example, when a user asks “Tell me about this product” in a virtual store, the AI will respond, “This product uses the latest technology and is very high performance. The dialogue data is recorded and summarized as “User: Tell me about this product; AI: This product uses the latest technology and is very high performance.

Example of a prompt statement: “I am a member of the User: Tell me about this product.

AI: This product uses the latest technology and is very high performance.

In this way, when a user asks a question about a product or service in a Metaverse store, the user can get an appropriate response in real time, and the dialogue data can be effectively recorded, summarized, and shared with real store personnel, thereby improving the user experience.

The flow of the identification process in Example of Application 1 is described in FIG. 12.

### Step 1:

Users use a terminal (smartphone or head-mounted display) to access the Metaverse store and enter questions about products and services.
Output: User's question text is sent to the server

### Step 2:

The server receives the user's question text and analyzes the intent of the question using natural language processing techniques.
Input: User's question text
Output: Data parsed for question intent

### Step 3:

The server generates appropriate answers using the OpenAI API based on the intent of the parsed question.
Input: Data parsed for question intent
Output: Answer text generated from OpenAI API

### Step 4:

The server sends the generated response text to the user's terminal for display to the user.
Input: Answer text generated from OpenAI API
Output: Response text displayed on the user's terminal

### Step 5:

The server records the user's question text and the generated answer text as dialogue data.
Input: user's question text, generated answer text
Output: Recorded dialogue data

### Step 6:

The server summarizes the recorded dialogue data and provides it to the store manager.
Input: recorded dialog data
Output: summarized dialog data

### Step 7:

The server provides a means to contact a real store representative or implement an appointment to visit the store after the initial user response.
Input: user question text, generated answer text, recorded dialog data
Output: Contact a real store representative or make an appointment to visit the store

In this way, when a user asks a question about a product or service in a Metaverse store, the user can get an appropriate response in real time, and the dialogue data can be effectively recorded, summarized, and shared with real store personnel, thereby improving the user experience.

### Example 2

Next, example 2 of exemplary embodiment of implement will be described. In the following description, data processing device 12 is referred to as the “server” and headset-type terminal 314 is referred to as the “terminal.

The conventional system required users to contact a real store representative after receiving initial response or to make an appointment to visit the store. In addition, there was a lack of an efficient and accurate means of conveying information to users when they specify the date and time of their visit or the services they would like to receive. Furthermore, there was insufficient summarization and organization of information when sharing interactions within the virtual space to real stores, which sometimes delayed the stores' response.

The specific processing unit 290 of the data processing device 12 in Example 2 is realized by the following means.

In this invention, the server provides a means to install an AI in the virtual space that can exp lain its services by learning CS data, etc., a means to contact the person in charge at the physical store or to make a reservation for a visit after the initial user response, a means to summarize the communication in the virtual space so that it can be shared with the store, a means to provide an interface for the user to input the date and time of the visit and the services provided, a means to store the input data in a database, a means to send notifications according to a specified contact method based on the stored data, and a means to send notifications based on the results of the user feedback. The system includes means to provide an interface for the user to enter the date and time of the visit and service details, means to store the entered data in a database, means to send a notification according to the specified contact method based on the stored data, and means to provide feedback to the user on the results of the notification transmission. This enables the user to efficiently and accurately specify the date and time of the visit and the services to be provided, and to quickly contact the person in charge of the real store. In addition, by summarizing and sharing the exchange within the virtual space, the store can respond quickly and accurately.

CS data” is data related to customer service and includes information such as the content of customer inquiries and response history.

AI″ stands for artificial intelligence, a technology that uses machine learning and natural language processing to automatically process information and provide appropriate answers and services to users.

A “virtual space” is a digital environment generated by computer simulation, which users can access through the Internet to perform various activities.

A “physical store” is a real store that actually exists and where users can visit and receive ser vices in person.

An “interface” is the means by which a user interacts with the system, including user interface elements such as input forms and buttons.

A “database” is a system for efficiently storing, managing, and retrieving data, and is operated using a query language such as SQL.

A “notice” is information sent from the system to a user or contact person, in the form of an e-mail, phone call, or message.

Feedback” is the response or result that the system provides to the user, informing him or her of the results of an operation he or she has performed.

A “summary” is a concise summary of the content of an exchange within a virtual space, extracting and organizing important information.

### Exemplary Embodiment of the Invention

This invention is a system that allows users to contact a real store representative or make an appointment to visit a store after receiving initial response. The system includes an AI, user interface, database, and notification functions installed in a virtual space.

### Hardware and Software Used

The server is developed using the Python programming language and implemented as a web application using the Flask framework. MySQL is used for the database, and the SMTP server and Twilio API are used for notification functions.

### Specific System Operation

The user accesses the system's web page using a web browser; the web page displays a form for entering the date and time of the visit and the services desired. The user enters, for example, that he/she wishes to have “Cut and Color” on “Oct. 15, 2023 at 14:00” and clicks on the submit button.

The server receives the data entered into the form by the user and processes the request using the Flask framework. The input data is stored in a MySQL database. Specifically, an SQL query is generated and inserted into the database.

The server then sends the notification according to the contact method specified by the user based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.

Finally, the server checks whether the notification was successfully sent and feeds back the result to the user. For example, if the notification is successful, the message “Reservation completed” is displayed; if not, the message “Reservation failed. Please try again” message is dis played.

Examples of specific examples and prompt sentences

As a concrete example, consider the case where a user makes a reservation at a beauty salon. The user enters on the web form that he/she wishes to request a “cut and color” service on Oct. 15, 2023 at 14:00. The server receives this information and sends an e-mail notification to the person in charge.

### Example of a Prompt Statement:

If a user enters on a web form to make a reservation at a beauty salon that he/she would like to request a “cut and color” service on Oct. 15, 2023 at 14:00, the server should receive this information and send an e-mail notification to the person in charge.

In this way, a system is realized that allows the user to specify the date and time of the visit and the services to be provided for the convenience of the user.

The flow of the identification process in Example 2 is described in FIG. 13.

### Step 1:

The user enters the date and time of the visit and services in a web form.

The user accesses the system's web page using a web browser and enters information in a form to enter the date and time of the visit and the services desired. For example, the user enters the request for “Cut and Color” on “Oct. 15, 2023 at 14:00” and clicks on the submit but ton.
Input: Date and time of visit, service details
Output: Data input by user

### Step 2:

The server receives the input data and stores it in a database.

The server receives the data entered into the form by the user; it processes the request using the Flask framework and stores the input data in a MySQL database. Specifically, it generates an SQL query and inserts it into the database.
Input: Data entered by user
Output: Data stored in database

### Step 3:

The server sends notifications based on the stored data and according to the specified contact method.

The server sends notifications according to the contact method specified by the user, based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.
Input: data stored in database, contact method
Output: Result of sending notification

### Step 4:

The server feeds back the results of the notification transmission to the user.

The server checks whether the notification was successfully sent and feeds back the result tother user. For example, if the notification is successful, the message “Reservation completed” is displayed; if not, the message “Reservation failed. Please try again” message is displayed.
Input: Result of sending notification
Output: Feedback message to user

### (Example of Application 2)

Next, example of application 2 of example of implement 2 will be described. In the following description, data processing device 12 is referred to as the “server” and headset-type terminal 314 is referred to as the “terminal.

Conventional user response systems within the metaverse lacked coordination with real stores after the initial response, which was problematic and reduced user convenience. In addition, there was a lack of a means to select an appropriate contact person based on the content of the user's inquiry and contact them promptly, which could lead to a decrease in user satisfaction. Furthermore, the lack of a reservation system that allowed users to specify the date and time of their visit and the services to be provided made it difficult to respond flexibly to user needs.

The specific processing by the specific processing unit 290 of the data processing device 12 in example of application 2 is realized by the following means.

In this invention, the server has a means of installing an AI in the metaverse store that can ex plain the company's services by learning CS data, etc., a means of contacting the person in chargeat the real store or making a reservation for a visit after the initial user response, and a means of summarizing the communication in the metaverse and making it available to be shared with the store, Means for the AI to automatically select an appropriate person in charge based on the user's inquiry, and to contact the person in charge via e-mail, telephone, or a dedicated reservation system, including a reservation system that allows the user to specify the date and time of the visit and the services to be provided. This makes it possible to quickly select and contact the appropriate person in charge based on the user's inquiry, thereby improving user convenience and satisfaction.

CS data” is data related to customer service and includes information such as the content of customer inquiries and response history.

AI″ stands for artificial intelligence, a technology that uses machine learning and natural language processing to automatically process information and provide appropriate answers and services to users.

A “metaverse” is a digital environment built on a virtual space, a platform that allows users to interact with other users and systems through their avatars.

A “real store” is a store that exists in a physical location, where users can actually visit and receive products and services.

The “person in charge” is a staff member or employee of the store designated to respond to user inquiries and reservations.

A “reservation system” is a system that allows users to make reservations by specifying the date, time, and services of their visit, either by e-mail, telephone, or through a dedicated online platform.

A “summary” is information that briefly summarizes the content of the exchange in the meta verse, including the user's questions and the AI's answers.

E-mail” is a digital message sent and received via the Internet and is a means of exchanging information between users and personnel.

A “phone call” is a means of exchanging information in real time through voice communication, and is intended for direct communication between a user and a contact person.

Automatic Selection” is the process by which AI automatically selects the best person for the job based on the user's inquiry.

The system for implementing this invention consists of the following

First, the server will install an AI in the metaverse store that can explain its services by learning CS data and other data. When a user makes an initial inquiry in the metaverse, the AI automatically generates an answer based on the content of the inquiry and provides it to the user. This allows users to quickly obtain the information they need.

Next, if the user's inquiry meets certain conditions, the server contacts the person in charge at the real store or makes a reservation for a visit. Specifically, the AI automatically selects an appropriate person based on the user's inquiry and contacts the person via e-mail, telephone, or a dedicated reservation system. This contact includes the user's inquiry, desired visit date and time, and service details.

In addition, the interactions in the metaverse will be summarized and made available for stores to share. The summary will include the user's question and the AI's response, which will al low personnel to quickly understand the user's situation.

To implement this system, the server will use the following hardware and software. Hardwar e: The server must be connected to the Internet and the user's smart phone. Software includes a Python-based program, an SMTP server (e.g., smtp.example.com), and a reservation system.

As a specific example, if a user wishes to “discuss the purchase of a new smartphone” and wishes to make an appointment to visit the store at 14:00 on Oct. 15, 2023, the following prompt statement is generated.
User Name: Taro Yamada
Inquiry: Consultation on purchase of a new smartphone
Preferred date and time: 2023 Oct. 15 14:00
Contact: (phone number)
Email: taro.yamada@example.com
Phone: 090-1234-5678

Based on this prompt statement, the server contacts the person in charge and confirms the us er's appointment to visit the store. This allows the user to receive services at the real store sm oothly.

The flow of the identification process in example of application 2 is described in FIG. 14.

### Step 1:

The user makes an initial query in the metaverse.
Input: User's inquiry (e.g., “Consultation on the purchase of a new smartphone”)

Processing: The AI receives the user's inquiry and analyzes its content.
Output: parsed query contents

### Step 2:

AI automatically generates answers based on the user's inquiry and provides them to the user.
Input: parsed query content

Processing: AI generates appropriate responses using a generative AI model.
Output: Generated answers (e.g., “Regarding the purchase of a new smartphone, the following models are recommended . . . ”)

### Step 3:

If the user's inquiry meets certain criteria, the server will contact the person in charge at the real store or make a reservation for the user to visit the store.
Input: parsed query, user's desired date and time of visit, and service details.

Processing: AI automatically selects the appropriate person in charge based on the content of the inquiry and generates prompt text.
Output: Generated prompt text (e.g., “User name: Taro Yamada, Inquiry: Consultation on purchase of new smartphone, Desired date: 2023 Oct. 15 14:00, Contact: E-mail: taro.yamada@e xample.com, Phone: 090-1234-5678”)

### Step 4:

The server will contact the person in charge via e-mail, telephone, or a dedicated reservation system.
Input: Generated prompt text

Processing: Server sends an email to the person in charge using an SMTP server, or automatically places a call using the phone API, or sends a prompt statement to the reservation system.
Output: Contact person in charge (e.g., reservation information is sent to the person's mailbox)

### Step 5:

Summarize the exchange in the metaverse and share it for the stores.
Input: user questions, AI answers

Processing: The server summarizes the exchange in the metaverse and generates summary in formation.
Output: Generated summary information (e.g., “User's question: How can I help you buy a new smartphone?, AI's answer: The following models are recommended . . . ”)

### Step 6:

Share summary information for stores.
Input: Generated summary information

Processing: The server sends the summary information to the person in charge.
Output: Person in charge receives summary information and quickly assesses the user's situation.

### Example 3

Next, example 3 of exemplary embodiment of implement will be described. In the following description, data processing device 12 is referred to as the “server” and headset-type terminal 314 is referred to as the “terminal.

There is a need to efficiently collect, summarize, and share dialogue data between users and AI in the metaverse with real store personnel to provide better service based on user needs and questions. However, current systems often collect, summarize, and share dialogue data manually, which is inefficient and lacks real-time performance.

The specific processing unit 290 of the data processing device 12 in Example 3 is realized by the following means.

In this invention, the server includes means for collecting dialogue data in the metaverse, storing the collected dialogue data in a cloud-based database, summarizing the dialogue data using a data generation AI model, storing the summarized data in a cloud-based database, and all owing a real store representative The summary data is stored in a cloud-based database and made available for viewing by personnel in real stores. This enables dialogue data to be efficiently collected, summarized, and shared in real time within the metaverse.

The “metaverse” is a three-dimensional virtual space built using virtual reality technology, where users can interact with other users and AI through avatars.

Dialogue data” is data that contains questions, answers, and other important dialogue between the user and the AI in the metaverse.

A “cloud-based database” is a database service accessible via the Internet that stores, manages, and accesses data in a cloud environment.

A “generative AI model” is a model for generating, summarizing, and transforming text data using artificial intelligence techniques, e.g., natural language processing techniques.

Summary data” is a concise summary of important information extracted from the dialogue data by the data generation model.

Real store personnel” are those staff members who provide customer service and provide ser vices in physical stores.

Viewing” is the act of displaying and checking stored data and information.

This invention is a system that efficiently collects, summarizes, and shares dialogue data bet ween users and AI in the metaverse with real store personnel. An exemplary embodiment of this system is described below.

The server collects real-time dialogue data between the user and AI that takes place in the me taverse. This dialogue data includes the user's questions, the AI's answers, and other important dialogue content. The server stores the collected dialogue data in a cloud-based database (e.g., Amazon RDS or Google Cloud SQL).

The server then uses a data generation model (e.g., a model using natural language processing techniques) to summarize the collected dialogue data. This summary includes the key points of the user's question and the AI's response. The summarized information is again stored in a cloud-based database.

Real store representatives use their terminals to access the cloud-based database and view summary information. This allows the representative to understand the content of the interaction with the user in the metaverse and provide better service.

As a concrete example, consider a user asking in the metaverse, “Do you have the new product in stock?” and the AI responds, “Yes, we have it in stock. This interaction data is collected by the server, which uses a generative AI model to generate a summary that says, “The user asked if the new product is in stock, and the AI responded that it is in stock. This summary in formation is stored in a cloud-based database and can be accessed by real store personnel.

### Example of a Prompt Statement:

Summarize the user's question and the AI's answer.

User Question: Do you have any new products in stock?

AI's response: Yes, we have them in stock.

By inputting this prompt text into a generative AI model, summarized information can be obt ained. This system makes it possible to efficiently collect, summarize, and share dialogue data in the metaverse in real time. The flow of the identification process in Example 3 is described in FIG. 15.

### Step 1:

The server collects real-time dialogue data between the user and the AI that takes place in the metaverse. Specifically, if a user asks in the metaverse, “Do you have the new product in sto ck?” and the AI responds “Yes, we have it in stock,” this dialogue data is captured. The input is the user's question and the AI's response, and the output is the collected dialogue data.

### Step 2:

The server stores the collected dialogue data in a cloud-based database. Specifically, the dialogue data is inserted into the appropriate tables in the database. The input is the collected dialogue data and the output is the dialogue data stored in the database.

### Step 3:

The server inputs the stored dialogue data into the generative AI model to generate a summary. Specifically, the following prompt sentences are input to the generative AI model:

Summarize the user's question and the AI's answer.

User Question: Do you have any new products in stock?

AI's response: Yes, we have them in stock.

The input is the prompt text and dialogue data, and the output is the generated summary data.

### Step 4:

The server stores the generated summary data again in the cloud-based database. Specifically, the summary data is inserted into the appropriate tables in the database. The input is the generated summary data and the output is the summary data stored in the database.

### Step 5:

Using the terminal, a real store representative accesses the cloud-based database and views the summary data. Specifically, the person in charge executes a query to the database to retrieve and display the summary data. The input is a request to access the database and the output is the summary data displayed.

This series of processes enables the efficient collection, summarization, and real-time sharing of dialogue data within the metaverse.

### (Example of Application 3)

Next, example 3 of application of example of implement 3 will be described. In the following description, data processing device 12 is referred to as the “server” and headset-type terminal 314 is referred to as the “terminal.

In order for real store personnel to understand the content of dialogue with users in the metaverse and provide better service, a means to efficiently summarize and share dialogue content is needed. However, current systems make it difficult to summarize dialogue data in the meta verse in real time, store it in a cloud-based database, and allow real store personnel to access it using smartphones. This makes it difficult to quickly identify user needs and interests and provide personalized service.

The specific processing by the specific processing unit 290 of the data processing device 12 in example of application 3 is realized by the following means.

In this invention, the server has a means of installing an AI in the metaverse that can explain the company's services by learning CS data, etc., a means of contacting the person in charge of the real store or making a reservation for a visit to the store after the initial user response, a means of summarizing the communication in the metaverse and making it available to the store for sharing, and a means of storing the summarized information in a cloud-based database and making it accessible to the person in charge of the real store using a smart phone. The summary information includes the user's question and AI's response, and other important inter action data. This allows the content of the dialogue in the metaverse to be efficiently summarized and quickly accessed by real store personnel, allowing them to understand the needs and interests of users and provide personalized service.

CS data” is data related to customer service, including customer inquiries, feedback, and ser vice history.

AI″ stands for artificial intelligence, a system that mimics human intelligence using techniques such as machine learning and natural language processing.

A “metaverse” is a virtual reality space, a digital environment where users can interact with other users and engage in various activities through their avatars.

A “real store” is a store that exists in a physical location, where customers can visit and purchase goods and services in person.

A “cloud-based database” is a database that can be accessed through the Internet, with data storage and management provided by a cloud service provider.

A “smart device” is a type of cell phone, a multifunctional device with Internet access and access to applications.

Summary information” is a concise summary of detailed data and dialogue, including important points and main points.

A “user question” is a query or question posed by a user to the AI in the metaverse.

An “AI response” is a response or explanation generated by the AI to a user's question.

Important dialogue data” refers to information and data that is considered particularly important in the dialogue between the user and AI, and includes content that is useful in the provision of services.

The following system configuration and processing procedures are used to implement this in vention.

First, the server will install an AI in the metaverse store that can learn CS data and other data to explain the company's services. When a user asks a question to the AI in the metaverse, the AI automatically generates an answer to the question and provides it to the user. This allows users to obtain information about the company's services in the metaverse.

Next, after the initial user response, the server contacts the person in charge of the real store and, if necessary, makes an appointment for the user to visit the store. The user is then ready to receive services at the real store.

In addition, the server will summarize the interactions in the metaverse and store the summary information in a cloud-based database. The summary information would include the user's question, the AI's answer, and other important interaction data. Real store representatives can use their smartphones to access the cloud-based database and review the summary informati on. This allows personnel to quickly understand users' needs and interests and provide personalized service.

As a concrete example, consider a user asking in the metaverse, “What are the features of the new smartphone?” and the AI responds, “The new smartphone has a high-resolution camera and a long battery life. This dialogue is summarized and stored in a cloud-based database. Re al store representatives can use their smartphones to access this summarized information and understand the user's interest in the new smartphone.

Examples of prompt sentences to be input into the generative AI model include the following

A user asked in the metaverse, “What are the features of your new smartphone?” and the AIr esponded, “The new smartphone has a high-resolution camera and a long battery life.” Summarize this dialogue.

In this way, the server, terminal, and user can work together to efficiently summarize the content of the dialogue in the metaverse, which can then be quickly accessed by real store person nel. This will enable the system to understand the needs and interests of users and provide personalized services.

The flow of the identification process in example of application 3 is described in FIG. 16.

### Step 1:

The server will install an AI in the metaverse store that can learn CS data and other data to ex plain the company's services. When a user asks a question to the AI in the metaverse, the AI automatically generates an answer to that question and provides it to the user. The input is the user's question and the output is the AI's answer. Specifically, the AI uses natural language processing technology to analyze the user's question and generate an appropriate response.

### Step 2:

After the initial user response, the server contacts the person in charge at the real store and, if necessary, makes a reservation for the user to visit the store. The input is the user's question and the AI's response, and the output is the information for contacting the person in charge. The specific operation is to send a notification to the person in charge based on the user's quest ion and the AI's response, and then perform the procedures for making a reservation for a visit to the store.

### Step 3:

The server summarizes the interactions in the metaverse and stores the summary information in a cloud-based database. The input is the user's questions and AI responses, and the output is the summary information. Specifically, the server summarizes the dialogue using a generative AI model and stores it in a cloud-based database.

### Step 4:

The person in charge of the real store accesses the cloud-based database using a smartphone to review the summary information. The input is the summary information retrieved from the cloud-based database, and the output is the understanding of the person in charge. Specifically, the smart phone application accesses the database and displays the summary information.

### Step 5:

The person in charge uses the summary information to understand the needs and interests of the user and provide personalized services. The input is the summary information and the out put is the service provided. Specifically, the system refers to the summary information and suggests products and services suitable for the user.

Further, an emotion engine that estimates the user's emotion may be combined. In other words, the specific processing unit 290 may use the emotion identification model 59 to estimate the user's emotion and perform specific processing using the user's emotion.

### Example of Implement 1.”

In one exemplary embodiment of the invention, the AI includes an emotion engine. The emotion engine estimates the user's emotional state from the user's questions and other interaction data. Specifically, it uses natural language processing and speech analysis technologies to estimate emotions from the user's text and voice input. Image analysis and motion analysis technologies can also be used to analyze the user's facial expressions and body movements.

### Example of Implement 2.”

The user's emotional state, as estimated by the emotion engine, is reflected in the AI's response generation. Specifically, if the user is happy or excited, the AI will generate responses that emphasize those emotions. Conversely, if the user is uncomfortable or confused, the AI will generate a response that softens the emotion. This allows the AI to respond appropriately to the user's emotions.

### Example of Implement 3.”

The emotion engine also influences the summary of interactions in the metaverse. Specifically, the user's emotional state is recorded as part of the summary, which is then shared with the store. For example, if a user expresses strong excitement about a product, this information is shared with the store to help predict product popularity and sales. If a user expresses dissatisfaction with a service, this information is shared with the store to help them improve the serv ice.

The following is a description of the process flow for each example of implement.

### Example of Implement 1.”

Step 1: The AI receives questions and other interactive data from the user.

Step 2: The emotion engine estimates the emotional state of the user from the data received. Specifically, it uses natural language processing and speech analysis technologies to estimate emotions from text and voice input. It also uses image analysis and motion analysis technologies to estimate emotions from the user's facial expressions and body movements.

### Example of Implement 2.”

Step 1: The emotion engine estimates the user's emotional state.

Step 2: The AI generates responses based on the estimated emotional state. Specifically, if the user is happy or excited, it generates a response that emphasizes that emotion. Conversely, if the user is uncomfortable or confused, it generates a response that softens the emotion.

### Example of Implement 3.”

Step 1: The emotion engine estimates the user's emotional state and reflects the results in a summary of the interaction in the metaverse.

Step 2: Summaries are shared with the stores. Specifically, information about the user's strong excitement about the product or the user's dissatisfaction with the service is shared with the store.

Step 3: Stores use the shared information to forecast product popularity and sales, and to imp rove their services.

### (Example 1)

Next, example 1 of exemplary embodiment of implement will be described. In the following description, data processing device 12 is referred to as the “server” and headset-type terminal 314 is referred to as the “terminal.

Conventional user response systems in virtual spaces have difficulty generating appropriate responses to users' questions and cannot accurately grasp users' emotional states. As a result, the user experience was degraded, resulting in inducement to the actual store or inability to improve the quality of service. Furthermore, there was a lack of a means to effectively share interactions within the virtual space to the actual store, resulting in a lack of consistency in us er responses

The specific processing by the specific processing unit 290 of the data processing device 12 in Example 1 is realized by the following means.

In this invention, the server includes means to install an artificial intelligence in the virtual space that can learn CS data and other data to explain the company's services, means to contact a person in charge at the actual store or to make a reservation to visit the store after the initial user response, and means to summarize the interaction in the virtual space so that it can be shared for the store, Means to analyze user questions using natural language processing technology to generate appropriate responses, means to use speech analysis technology, image ana lysis technology, and motion analysis technology to estimate the user's emotional state, and means to record and summarize the dialogue data. This makes it possible to generate appropriate answers to the user's questions and to accurately ascertain the user's emotional state. In addition, by effectively sharing the interactions in the virtual space with the actual store, it is possible to maintain consistency in user responses and improve the quality of service.

Artificial Intelligence” is a system that includes technology to generate appropriate responses to user questions and to estimate the user's emotional state.

A “virtual space” is a three-dimensional virtual environment constructed on the Internet, where users can interact with other users and systems through avatars.

Natural language processing technology” is a technology that analyzes text input from users to understand their intentions and generate appropriate responses.

Speech analysis technology” is a technology for converting voice input from users into text and analyzing that text.

Image analysis technology” is a technology that uses a camera to capture a user's facial expressions and body movements, and analyzes the data to estimate the emotional state of the user.

Motion analysis technology” is a technology that analyzes the user's body movements and us es the data to estimate the emotional state of the user.

Dialogue data” is a record of the interaction between the user and the artificial intelligence, and includes information such as the content of questions and answers, as well as emotional states.

A “summary” is a concise summary of important information extracted from the dialogue data.

A “physical store” is a store that exists in a physical location and that users can actually visit.

The “Visit Reservation” is a procedure whereby a user reserves a date and time in advance for a visit to a physical store.

This invention relates to an artificial intelligence system that explains its services to users in a virtual space. The following is an exemplary embodiment of this system.

First, the server generates a program that combines natural language processing technology, speech analysis technology, image analysis technology, and motion analysis technology. This program includes artificial intelligence to understand questions from users and generate appropriate responses. Specifically, the following technologies will be used.

Natural language processing technology: The server analyzes text input from the user to understand the intent of the question. This technology uses, for example, BERT and GPT-3.

Speech analytics technology: The server converts the user's voice input into text and analyzes that text. Google Cloud Speech-to-Text and Amazon Transcribe are used for this technology

Image Analysis Technology: The server uses cameras to capture the user's facial expressions and body movements to estimate their emotional state. OpenCV and Google Cloud Vision are used for this technology.

Motion Analysis Technology: The server analyzes the user's body movements to estimate their emotional state. Microsoft Azure Kinect DK is used for this technology.

Next, the user accesses the AI within the virtual space. The user logs into a virtual store within the virtual space to access the AI assistant. The user initiates a dialogue by clicking on the AI assistant's icon or avatar within the virtual space.

When a user enters a question in text or voice, the server receives the input and selects the ap propriate analysis technology. For text input, the server selects natural language processing technology; for voice input, it selects speech analysis technology.

The server uses natural language processing technology to analyze the user's question and generate an appropriate response. For example, for a question such as “What are the features of this product?”, the server generates an answer such as “This product is made of high-quality materials and is durable.

In addition, the server uses an emotion engine to estimate the user's emotional state. For text input, emotions are analyzed using natural language processing technology, and for voice input, speech analysis technology is used. In addition, by analyzing the user's facial expressions and body movements through the camera, the emotional state is estimated more accurately.

The server returns the generated responses to the user. The response is displayed in a text chat window or played back with audio. For example, “This product is made of high quality materials and is durable.

Finally, the server records the interaction data with the user and summarizes it for later analysis and improvement. For example, the content of the user's questions and emotional state are recorded and used for the next dialogue.

Specific examples:

User accesses the AI within the virtual space: the user clicks on the AI assistant's avatar in the virtual store and initiates a dialogue.

User enters a question by text or voice: The user enters the question “What are the features of this product?” by text or by voice using the microphone.

Server receives input and selects appropriate parsing technology: The server recognizes that the user's input is text and selects a natural language processing technology.

Server analyzes questions using natural language processing technology: The server analyzes questions using GPT-3 and extracts information about product features.

The server generates an appropriate response: the server generates a response such as “This product is made of high quality materials and is durable.

Server estimates the user's emotional state: The server analyzes the user's emotions from the user's text input and estimates whether the user is satisfied or not.

Server returns the answer to the user: The server displays the generated answer in a text chat window.

Server records and summarizes dialog data: The server records the user's questions and emotional state and summarizes them for use in the next dialog.

Example of a prompt statement: “I am a member of the

Tell me what makes this product unique.”

How long will this product last?”

Tell me about the pricing plan for this service.”

In this way, the server can generate appropriate answers to the user's questions and provide better service by estimating the user's emotional state.

The flow of the identification process in Example 1 is described in FIG. 17.

### Step 1:

The user accesses the AI within the virtual space.

Specific behavior: The user logs into a virtual store in the virtual space and clicks on the AI assistant's icon or avatar to initiate a dialogue.
Input: User login information and location in the virtual space.
Output: Initiation of a dialogue session with the AI assistant.

### Step 2:

The user enters questions by text or voice.

Specific behavior: The user types a question in the text chat window or asks a question by voice using the microphone. For example, the user types, “What are the features of this product?
Input: User text or voice input.
Output: text or voice data.

### Step 3:

The server receives the input and selects the appropriate analysis technique.

Specific behavior: The server determines whether the user input is text or voice, and selects natural language processing technology for text input or speech analysis technology for voice i nput.
Input: text or voice data.
Output: Result of analysis technique selection.

### Step 4:

The server analyzes the questions using natural language processing technology.

Specific behavior: The server uses natural language processing techniques (e.g., GPT-3) to analyze the user's questions and understand the intent of the questions.
Input: text data.
Output: Results of analysis of question intent.

### Step 5:

The server generates the appropriate response.

Specific behavior: The server generates appropriate responses based on the analysis results. For example, it generates responses such as “This product is made of high-quality materials and is durable.
Input: Results of the analysis regarding the intent of the question.
Output: Response text.

### Step 6:

The server estimates the user's emotional state.

Specific behavior: The server uses an emotion engine to estimate the user's emotional state. For text input, emotions are analyzed using natural language processing technology; for voice input, speech analysis technology is used. In addition, the emotional state is estimated more accurately by analyzing the user's facial expressions and body movements through the camera.
Input: text data, voice data, image data.
Output: Estimated results of the emotional state.

### Step 7:

The server returns the answer to the user.

Specific behavior: The server returns the generated answers to the user. The answer is displayed in a text chat window or played back with audio. For example, “This product is made of high quality materials and is durable.
Input: Answer text.
Output: Display of answer to user or audio playback.

### Step 8:

The server records and summarizes the dialogue data.

Specific behavior: The server records the user interaction data and summarizes it for later analysis and improvement. For example, it records the user's questions and emotional state, which can be used for the next interaction.
Input: Dialogue data, emotional state estimation results.
Output: summarized dialog data.

### (Example of Application 1)

Next, example of application 1 of example of implement 1 will be described. In the following description, data processing device 12 is referred to as the “server” and headset-type terminal 314 is referred to as the “terminal.

Conventional user response systems within the virtual space have had difficulty providing ap propriate responses to user questions and taking into account the emotional state of the user. In addition, there was a lack of a means to effectively share interactions within the virtual space to the physical store, and there was a need to improve the user experience

The specific processing by specific processing unit 290 of data processing device 12 in example of application 1 is realized by the following means. In this invention, the server has the following means: a means to install an AI in the virtual space that can explain its services by learning CS data, etc.; a means to contact the person in charge at the physical store or make a reservation for a visit after the initial user response; a means to summarize the communication in the virtual space so that it can be shared with the store; a means including an emotion engine that estimates the user's emotional state; a means to analyze the user's voice or text input; a means to use natural language processing technology; and a means to analyze the user's voice or text input. The system includes an emotion engine to estimate the user's emotional state, natural language processing technology to analyze the user's voice and text input, and image analysis technology to analyze the user's facial expressions and actions. This makes it possible to provide appropriate answers to the user's questions and respond in consideration of the emotional state, effectively sharing the interaction within the virtual space to the physical store.

CS data” is data related to customer service and includes information such as the content of customer inquiries and response history.

A “virtual space” is a three-dimensional virtual environment constructed using computer technology, which users can experience interactively.

AI″ stands for artificial intelligence, a system that mimics human intelligence using techniques such as machine learning and natural language processing.

A “physical store” is a real store that actually exists and that customers can visit in person.

The “emotion engine” is a technology for estimating a user's emotional state, and is a system that recognizes emotions using voice and image analysis.

Natural language processing technology” refers to technology that enables computers to understand and generate human language, including text analysis and speech recognition.

Image analysis technology” refers to technology that analyzes image data and extracts information, including object recognition and face recognition.

A “summary” is a short summary of lengthy text or dialogue data, from which important information is extracted and expressed in a concise manner.

Communication” is the act of conveying information and is done by means of telephone, e-m ail, or other means.

The “visit reservation” is the act of reserving in advance a date and time for a customer to vis it a physical store so that the store can prepare to accommodate the customer.

The system for implementing this invention consists of the following

First, the server places an AI in the virtual space that can explain its services by learning CS data and other data. Users can access the virtual space using a smartphone or head-mounted display to interact with the AI, which will automatically generate answers to the user's questions and provide those answers to the user.

The server then contacts the person in charge of the physical store after the initial user response or makes a reservation for a visit to the store. This allows the user to receive services at the physical store based on the information obtained in the virtual space.

In addition, the server will summarize the interactions within the virtual space so that they can be shared for the store. This allows physical store personnel to see what questions users have asked and what answers they have received in the virtual space.

The system includes an emotion engine that estimates the user's emotional state. The emotion engine uses natural language processing technology to analyze the user's voice and text input. It also uses image analysis technology to analyze the user's facial expressions and actions. This allows the system to estimate the user's emotional state and respond appropriately.

As a specific example, if a user asks, “Tell me about your latest smartphone,” the AI will res pond, “It is the latest smartphone. It has a high-performance camera and a long-lasting batter y.” The AI responds, “It has a high-performance camera and a long battery life. Also, if the user asks, “Where can I buy this product?” the AI will answer, “This product is available at our online store. The AI replies, “This product can be purchased at the online store.

The following hardware and software are used to realize this system
Hardware: Smartphones, head-mounted displays
Software: OpenAI API (generative AI models), Transformers library (natural language processing technology), OpenCV (image analysis technology)
Examples of prompt statements include the following
Tell me about your latest smartphone.”
Where can I buy this product?”
Tell me about the features of your head-mounted display.”

This allows users to receive services at a physical storefront through an interactive experience in the virtual space.

The flow of the identification process in Example of Application 1 is described in FIG. 18.

### Step 1:

The user accesses the virtual space using a smartphone or head-mounted display. The user in puts questions to the AI assistant within the virtual space. Input can be done by text or voice. The input data is sent to the server.

### Step 2:

The server analyzes the received user questions using natural language processing technology. Specifically, it uses the OpenAI API to understand the intent of the question and generate an appropriate response. The input is the user's question and the output is the generated answer.

### Step 3:

The server provides the generated answers to the user. The user checks the answers in the virtual space. The output is the answers provided to the user.

### Step 4:

The server analyzes the user's voice and text input with the emotion engine to estimate the us er's emotional state. The emotion engine uses the Transformers library to recognize emotions. The input is the user's voice or text data, and the output is the estimated emotional state.

### Step 5:

The server analyzes the user's facial expressions and actions using image analysis technology. Specifically, it uses OpenCV to recognize the user's facial expressions and actions to complement the emotional state. The input is the user's image data, and the output is the analyzed facial expression and behavior information.

### Step 6:

The server summarizes the interaction in the virtual space and shares it with the physical store personnel. The summary includes the user's questions and the AI's answers. The input is the interaction data in the virtual space and the output is the summarized information.

### Step 7:

After the initial user response, the server will contact the person in charge of the physical store or implement a reservation for a visit to the store. Email or telephone is used as the means of contact. The input is the user's contact information and the desired appointment date and time, and the output is a confirmation of the contact or appointment.

### Step 8:

Users visit a physical store and receive services based on information obtained in the virtual space. The person in charge of the physical store responds based on the summary information shared from the server. The input is the summary information and the output is the service provided to the user.

### (Example 2)

Next, example 2 of exemplary embodiment of implement will be described. In the following description, data processing device 12 is referred to as the “server” and headset-type terminal 314 is referred to as the “terminal.

Conventional systems provide a uniform response without taking into account the user's emotional state, and this has led to a problem of reduced user satisfaction. There was also the problem of the time and effort required to contact the person in charge at the real store after the initial response and the complicated procedures for making a visit appointment. Furthermore, the system lacked the ability to specify the date and time of the user's visit and the services to be provided, making it difficult to provide convenience to the user.

The specific processing by the specific processing unit 290 of the data processing device 12 in Example 2 is realized by the following means. In this invention, the server has the following means: means for receiving the user's input data, means for analyzing the received input data and estimating the user's emotional state, means for generating a response using a generation AI model based on the estimated emotional state, means for providing the generated response to the user, means for providing the user with a response after the initial user response The system includes means to contact a person in charge of the real store or to make an appointment for the user to visit the store, and means by which the user can specify the date and time of his/her visit and the services to be provided. This enables appropriate responses according to the user's emotional state, and simplifies the contact and reservation procedures after the initial response, for the convenience of the user.

The “means of receiving user input data” is a function for sending and receiving text and voice data input by the user through the terminal to the server.

The “means for analyzing received input data to estimate the user's emotional state” is a function for analyzing received user input data and estimating the user's emotional state (joy, excitement, discomfort, confusion, etc.) from that data.

The “means for generating responses using a generative AI model” is a function for generating appropriate responses to users using a generative AI model based on the estimated emotion al state.

The “means of providing generated answers to users” is a function for transmitting and providing answers generated by the generative AI model to users.

The “means of contacting a real store representative or scheduling a visit after the initial user response” is a function for contacting a real store representative or scheduling a visit by the user after the initial response is complete.

The “means by which users can specify the date and time of their visit and the services they wish to receive” is a function for users to specify the date and time of their visit and the services they wish to receive.

An “emotion engine” is software or an algorithm that analyzes user input data and estimates the emotional state from that data.

A “generative AI model” is an artificial intelligence model for generating natural language responses based on user input data and emotional states.

An “e-mail, telephone, or dedicated reservation system” is a means of communication or reservation management system used to communicate between a user and a real store representative.

### Exemplary Embodiment of the Invention

This invention is a system that provides appropriate responses based on the user's emotional state and simplifies the contact and appointment procedures after the initial response. Specific exemplary embodiments of this system are described below.

### Means for Receiving User Input Data

A user accesses the system using a terminal (e.g., PC or smartphone) and enters questions or information. The data entered by the user is sent from the terminal to the server. The server is equipped with a high-performance processor (e.g., Intel Xeon processor) to process the received data.

### Means for Analyzing the Received Input Data to Estimate the Emotional State of the User

The server passes the received user input data to an emotion engine (e.g., IBM Watson Tone Analyzer) for emotion analysis. The emotion engine estimates the emotional state (e.g., joy, excitement, discomfort, confusion, etc.) from the user's text. The results of this analysis are fed back to the generative AI model.

### Means of Generating Responses Using a Generative AI Model Based on the Estimated Emotional State

The server generates a response to the user using a generative AI model (e.g., OpenAI's GPT-4) based on the emotional state obtained from the emotion engine. For example, if the user is expressing pleasure, the AI will say, “That's great! We're glad you're interested.” and generates a positive response such as “I'm glad you're interested.

### Means of Providing the Generated Answers to the User

The server sends and provides the answers generated by the generative AI model to the user. Users can receive these answers through their terminals.

Means of contacting a real store representative or scheduling a visit to the store after the initial user response.

If the user is satisfied with the initial response, the server will contact a real store representative or implement a reservation for a visit to the store. This contact may be made via email (e. g., Gmail API), telephone (e.g., Twilio API), or through a dedicated reservation system (e.g., Calendly).

A means of specifying the date and time of the user's visit and the services to be provided.

The user may specify the date and time of the visit and the services to be provided when making an appointment to visit the restaurant. The server inputs these information into the reservation system and sends a reservation confirmation e-mail to the user. It also notifies the person in charge of the real store of the reservation information.

### Concrete Example

### Example 1: a User Expresses Delight

User says, “I really like your new product!” and inputs “I love it!”. The emotion engine detects “joy” and the generative AI model says, “That's great! We're glad you're interested. If you need more information, please contact a representative or schedule a visit. The model replies, “That's great!

### Example 2: a User Expresses Confusion

A user types “I am not sure how to use this product. The emotion engine detects “confusion” and the generative AI model says, “Sorry for the inconvenience. If you need further explanation, please contact a representative or make an appointment to visit our store. The model replies, “I am sorry for the inconvenience.

### Example of Prompt Text

“Generate a positive response if the user expresses delight about the new product.”

“If a user is confused about how to use a product, generate a response that reassures them.”

In this way, the system responds appropriately to the user's emotional state and, if necessary, either contacts a real store representative or makes a reservation for a visit to the store.

The flow of the identification process in Example 2 is described in FIG. 19.

### Step 1: Receive the User's Input Data

A user accesses the system using a terminal (e.g., PC or smartphone) and enters questions or information. The data entered by the user is sent from the terminal to the server. Specifically, the user opens a browser, accesses the system's web page, enters a question in the text box, and clicks the “Send” button. The input data is the user's question or information (e.g., “Tell me more about your new product”), and the output is the user's input data sent to the server.

### Step 2: Analyze the Received Input Data to Estimate the User's Emotional State.

The server passes the received user input data to the emotion engine (e.g., IBM Watson Tone Analyzer) for emotion analysis. The input data is the user's text data, and the emotion engine analyzes this data to estimate the emotional state (e.g., joy, excitement, discomfort, confusio n). Specifically, the server sends the user's input data to the emotion engine, which analyzes the text, estimates the emotional state, and returns the results to the server. The output is the estimated emotional state.

### Step 3: Generate Answers Using a Generative AI Model Based on the Estimated Emotional State

The server generates answers to users using a generative AI model (e.g., OpenAI's GPT-4) based on the emotional states obtained from the emotion engine. The input data is the emotion analysis results, and the generative AI model uses this data to generate an appropriate respon se. Specifically, the server passes the emotion analysis results to the generative AI model, and the generative AI model generates responses according to the emotional state. The output is the generated answers.

### Step 4: Provide the Generated Answers to the User.

The server sends and provides the answers generated by the generative AI model to the user. The input data is the generated answers, and the server sends these answers to the user. Specifically, the server sends the generated answers to the user's terminal, and the user receives the answers through the terminal. The output is the answers provided to the user.

Step 5: After the Initial User Response, Contact a Real Store Representative or Schedule a Visit tother Store.

If the user is satisfied with the initial response, the server contacts a real store representative or makes a reservation for a visit. The input data is the user's satisfaction level and desired contact or reservation information, which the server uses as the basis for the contact or reservati on. Specifically, the user clicks on the “Reserve Visit” button, the server accesses the reservation system, and the user's desired date, time, and service details are entered. The output is a reservation confirmation e-mail or contact notification.

Step 6: Users can Specify the Date and Time of their Visit and Services.

The user may specify the date and time of the visit and the services to be provided when making an appointment to visit the store. The input data is the user's desired visit date and time and service details, which are input by the server into the reservation system. Specifically, the server inputs the user's desired date, time, and service details into the reservation system, sends a reservation confirmation e-mail to the user, and also notifies the person in charge at the real store of the reservation information. The output is a reservation confirmation e-mail and a notification to the person in charge.

### (Example of Application 2)

Next, example of application 2 of example of implement 2 will be described. In the following description, data processing device 12 is referred to as the “server” and headset-type terminal 314 is referred to as the “terminal.

In conventional metaverse store systems, it was difficult to respond appropriately to users' emotional states, resulting in a poor user experience. In addition, it was difficult to improve us er satisfaction because there was a lack of a means to promptly contact a real store representative when a user expressed discomfort or confusion.

The specific processing by the specific processing unit 290 of the data processing device 12 in example of application 2 is realized by the following means.

In this invention, the server includes: a means to install an AI in the metaverse store that can learn CS data, etc. and explain its services; a means to contact the person in charge at the real store or make a reservation for a visit to the store after the initial user response; a means to summarize the communication in the metaverse so that it can be shared for the store; and a means to generate appropriate responses based on the user's emotional state estimated by the emotion engine. AI generates appropriate responses based on the user's emotional state as estimated by the emotion engine, and means to contact the person in charge if the user expresses discomfort or confusion. This enables appropriate responses based on the user's emotional stat e, thereby improving the user experience and quickly resolving problems.

CS data” is data related to customer service and includes information such as the content of customer inquiries and response history.

The term “AI” stands for artificial intelligence, a technology in which computers mimic hum an intelligence in learning and reasoning.

The term “metaverse” refers to a virtual space, a 3D virtual world constructed on the Internet.

An “emotion engine” is an algorithm or system for estimating a user's emotional state, a technology that uses natural language processing and machine learning to analyze emotions.

A “real store” is a store that exists in a physical location and can actually be visited by custo mers.

The term “visit reservation” refers to a reservation made by a customer to visit a store on a specific date and time.

A “summary” is a concise summary of detailed information, with key points extracted and ex pressed in a short form.

The term “user experience” refers to the experience and satisfaction that users experience when using a product or service.

Prompt problem-solving” refers to the rapid response and resolution of problems as they aris e.

The system for implementing this invention is configured as follows. First, the server will ins tall an AI in the metaverse store that can learn CS data and other data to explain its services. When a user makes an inquiry in the metaverse, the emotion engine estimates the user's emotional state, and the AI generates an appropriate response based on that emotion.

If a user indicates discomfort or confusion, the server will contact a real store representative. The means of contact may be e-mail, telephone, or a dedicated reservation system. If the user wishes to make an appointment to visit the store, he or she can specify the date and time of the visit and the services to be provided.

Interactions in the metaverse are summarized and shared for the store. This summary includes the user's question and the AI's response. This allows real store personnel to quickly understand the user's situation and respond appropriately.
Hardware and software used
Hardware: Smartphones, servers
Software: Python, smtplib (sending email), random (simulation of emotion engine)
Data processing and computation

1. emotion engine: receives user input and estimates emotional states. Specifically, the emotion is analyzed from the user's text using a natural language processing model.

2. AI response generation: Generate appropriate responses based on estimated emotions. For example, if a user is confused, the system will ask, “Sorry for the inconvenience. How can we help you?” when the user is confused.

Contacting the person in charge: If a user expresses discomfort or confusion, the server will contact the person in charge. E-mail is used as the means of contact. The e-mail will include the date and time of the user's desired visit and the nature of the service.

### Concrete Example

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

### Example of Prompt Text

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

In this way, appropriate responses can be made according to the user's emotional state, improving the user experience and quickly resolving problems.

The flow of the identification process in example of application 2 is described in FIG. 20.

### Step 1:

A user makes an inquiry in the metaverse. The user uses a smartphone or computer to access the virtual storefront in the metaverse and enters a question in text format. The entered text is sent to the server.

### Step 2:

The server receives the user's input text and passes it to the emotion engine. The emotion engine uses a natural language processing model to estimate the user's emotional state. Specifically, it analyzes the text data and classifies emotions such as joy, excitement, discomfort, and confusion. The output of the emotion engine is the estimated emotional state.

### Step 3:

The server receives the output of the emotion engine and passes it to the generative AI model. The generative AI model generates appropriate responses based on the estimated emotional state. For example, if the user is confused, the model might say, “Sorry for the inconvenience. How can we help you?” The generated response is returned to the server. The generated answers are returned to the server.

### Step 4:

The server provides the generated answers to the user. The user can check the answers from the AI on the screen of his/her smartphone or computer. This allows users to obtain appropriate answers to their questions.

### Step 5:

If the user indicates discomfort or confusion, the server will contact the real store representative. The user enters the desired date and time of the visit and the services to be provided, and this information is sent to the server. The server uses e-mail to contact the person in charge. The e-mail includes the user's desired date and time of visit and the services to be provided.

### Step 6:

The server summarizes the interactions in the metaverse and shares them for the store. The summary includes the user's question and the AI's response. This allows real store personnel to quickly understand the user's situation and respond appropriately.

In this way, appropriate responses can be made according to the user's emotional state, improving the user experience and resolving problems quickly.

### (Example 3)

Next, example 3 of exemplary embodiment of implement will be described. In the following description, data processing device 12 is referred to as the “server” and headset-type terminal 314 is referred to as the “terminal.

Conventional interaction data between users and AI in the metaverse is often not used as useful information for real store personnel. In addition, it is difficult to provide services that take into account the emotional state of users. This makes it difficult for real store personnel to accurately understand users' needs and emotions and provide appropriate services

The specific processing unit 290 of the data processing device 12 in Example 3 is realized by the following means.

In this invention, the server includes means for collecting dialogue data in the metaverse, means for storing the collected dialogue data in a cloud-based database, means for analyzing the stored dialogue data and generating summary information, means for analyzing the emotion al state of the user using an emotion engine, means for storing the generated summary information and the emotional state are stored in a cloud-based database, and a person in charge of the real store accesses the cloud-based database to view the summary information. This enables real store personnel to understand the content of user interaction and emotional states in the metaverse and to provide more appropriate and personalized service.

The “metaverse” is a three-dimensional virtual space built using virtual reality technology, where users can interact with other users and AI through their avatars.

Dialogue data” is data that includes questions, answers, time stamps, and other information exchanged between users and AI in the metaverse.

A “cloud-based database” is a database service accessible via the Internet and is a platform for storing, managing, and analyzing data.

Summary information” is a concise summary of important information extracted from the dialogue data, including the user's question, the AI's response, and important dialogue points.

An “emotion engine” is software or an algorithm that analyzes user interaction data to identify the user's emotional state (e.g., excitement, frustration, joy, etc.).

A “generative AI model” is an artificial intelligence model that uses natural language processing techniques to analyze textual data and generate summaries and responses.

Real store personnel” are those staff members who provide customer service and provide ser vices in physical stores.

Access” is the act of connecting to a cloud-based database to view, retrieve, or manipulate stored data.

This invention is a system that collects dialogue data in the metaverse, analyzes it, generates summary information, and provides it to real store personnel. An exemplary embodiment of this system is described below.

The server obtains dialogue data from the metaverse platform (e.g., between the three-dimensional virtual sky using virtual reality technology) through an API. When a user asks a question to the AI in the metaverse, the question and the AI's answer are sent to the server in real time. For example, if a user asks, “What are the features of your new smartphone?” the question and the AI's answer are collected as dialogue data.

The server stores the collected dialogue data in a cloud-based database (e.g., a database service accessible through the Internet). The database will record the details of each dialogue. For example, the following records are added

```
{
  “timestamp”: “2023-10-01T12:34:56Z”,.
  “user_question”: “What are the features of your new smartphone?” ,.
  “ai_response”: “The new smartphones feature high-resolution cameras and long-life batterie
s.”
}
```

The server then analyzes the stored dialogue data and generates summary information. A generative AI model (e.g., an artificial intelligence model using natural language processing techniques) is used to generate a summary of the dialogue data. This summary includes the user's question, the AI's response, and the key dialogue points. The generated summary will look like the following

Summary: User asked about features of new smartphone; AI answered about high-resolution camera and long-life battery.

In addition, the server uses an emotion engine (e.g., software or algorithms for analyzing the user's emotional state) to analyze the user's emotional state. The analysis results include the emotions (e.g., excitement, frustration, joy, etc.) that the user exhibited during the interaction. The analysis results are as follows.

### Emotional State: Excited

The server will store the generated summary information and emotional states in a cloud-based database. The records to be stored will be as follows

```
{
  “timestamp”: “2023-10-01T12:34:56Z”,.
  “summary”: “Users asked about the features of the new smartphone and the AI answered ab
out the high-resolution camera and long-life battery.” ,
  “emotion”: “excitement”
}
```

Using the terminal, a real store representative accesses a cloud-based database to view summary information. The representative can determine that the user is interested in a new smartphone and can provide a detailed description and suggestions for relevant accessories.

Examples of prompt sentences to be input into the generative AI model are as follows

Summarize the data of the user's interaction with the AI in the metaverse. Include the following information
User Question
AI Answer
Emotional state of the user

With this system, real store personnel will be able to understand the content of the user's intereaction and emotional state in the metaverse and provide more appropriate and personalized services. The flow of the identification process in Example 3 is explained using FIG. 21.

### Step 1:

The server obtains dialogue data from the metaverse platform through an API. When a user asks a question to the AI in the metaverse, the question and the AI's answer are sent to the server in real time. The input is the user's question and the AI's answer, and the output is the dialogue data. In concrete operation, the server sends an API request and receives the dialogue data.

### Step 2:

The server stores the collected dialogue data in a cloud-based database. The input is the dialogue data obtained in step 1 and the output is the records stored in the database. As a specific action, the server executes an INSERT query to the database and stores the dialogue data.

### Step 3:

The server analyzes the stored dialogue data and generates summary information. The input is the dialogue data stored in the database and the output is the generated summary information. Specifically, the server inputs dialogue data to a generative AI model and generates a summary. The generative AI model uses natural language processing techniques to generate a summary of the dialog data.

### Step 4:

The server uses an emotion engine to analyze the user's emotional state. The input is the dialog data and the output is the analyzed emotional state. Specifically, the server inputs dialogue data to the emotion engine and analyzes the emotional state. The emotion engine identifies the user's emotion (e.g., excitement, frustration, joy, etc.).

### Step 5:

The server stores the generated summary information and emotional states in a cloud-based d atabase. The input is the summary information and emotional state, and the output is the records stored in the database. Specifically, the server executes an INSERT query against the database and stores the summary information and emotional state.

### Step 6:

Using the terminal, the person in charge of the real store accesses the cloud-based database and views the summary information. The input is the summary information and emotional state stored in the database, and the output is the information the person in charge views. Specifically, the person in charge uses the terminal to send a query to the database to retrieve summary information and emotional states.

### (Example of Application 3)

Next, example 3 of application of example of implement 3 will be described. In the following description, data processing device 12 is referred to as the “server” and headset-type terminal 314 is referred to as the “terminal.

There is a need for a system that allows real store personnel to understand the interaction bet ween users and AI in the metaverse, which can be used to improve service and predict the popularity of products. However, current systems make it difficult to summarize interactions in the metaverse in real time and share them, including emotional states. They also lack the means to provide information in a form that can be easily accessed by real store personnel. This makes it difficult to quickly identify user needs and respond appropriately

Specific processing by specific processing unit 290 of data processing device 12 in example of application 3 is realized by the following means. In this invention, the server has the following means: a means to install an AI in the metaverse that can explain its services by learning CS data, etc., in the metaverse store; a means to contact the person in charge at the real store or make a reservation for a visit to the store after the initial user response; a means to summarize the communication in the metaverse so that it can be shared with the store; a means to store the summarized information to be stored in a cloud-based database and made accessible to real store personnel, recording the user's emotional state as part of the summary and sharing it with the store, and providing an application installed on a smart phone or tablet that allows real store personnel to review the summary information. Includes means to provide an ap plication. This makes it possible to summarize in real time the content of the dialog with the user in the metaverse and share it, including the emotional state, so that the real store personnel can quickly understand the user's needs and respond appropriately.

CS data” is data related to customer service and includes information such as customer inquiry details, response history, and satisfaction ratings.

AI″ stands for artificial intelligence, a system that mimics human intelligence using techniques such as machine learning and natural language processing.

A “metaverse” is a virtual reality space, a digital environment in which users can interact and engage in activities with other users and AI through avatars.

A “real store” is a store that exists in a physical location, a place where customers can actually visit to purchase products and receive services.

A “cloud-based database” is a database accessible via the Internet, where data is stored and managed on a cloud server.

The “summary information” is a concise summary of the user's interaction with the AI in the metaverse, including the user's questions, the AI's answers, and the emotional state of the user.

The term “emotional state” refers to the feelings that a user exhibits during an interaction, such as excitement, frustration, joy, or sadness.

A “smart device” is a type of cell phone, a multifunctional device with Internet access and access to applications.

A “tablet” is a portable computer device with a touch screen and the ability to use applications in the same way as a smart device.

An “application” is a software program that provides a specific function or service and is installed on a smartphone or tablet.

The System for Implementing this Invention Consists of the Following

First, the server will install an AI in the metaverse store that can learn CS data and other data to explain the company's services. When a user interacts with the AI in Metaverse, the content of the interaction is recorded in real time. The recorded dialogue will be stored in a cloud-based database as summary information. This summary information includes the user's question, the AI's response, and the user's emotional state.

Real store personnel can then access this summary information using a dedicated application installed on their smartphones or tablets. The application has the ability to retrieve the summary information from a cloud-based database and display it to the person in charge. This allows the person in charge to understand the content of the interaction with the user in the meta verse and to respond appropriately.

As a specific example, if a user asks in the metaverse, “Do you have this item in stock?” the AI will respond, “Yes, we have this product in stock. Along with the content of this dialogue, the emotional state of excitement of the user is also recorded. This information is summarized and stored in a cloud-based database. Real store personnel can access this information using a smartphone or tablet and provide detailed information about the products the user is interested in.

An example of a prompt statement would be in the following form

Summarize the user's interaction with the AI in the metaverse and output in the following for mat
user ID
question
Answer.
emotional condition
Example: The
User ID: user_001
Q: Do you have this item in stock?
Answer: Yes, we have them in stock.
Emotional State: Excited

In this way, the content of the dialogue in the metaverse can be summarized in real time and shared, including the emotional state. This allows real store personnel to quickly understand the needs of users and respond appropriately.

The flow of the identification process in example of application 3 is described in FIG. 22.

### Step 1:

The server will install an AI in the metaverse store that can learn CS data and other data to ex plain the company's services. When a user initiates a dialogue with the AI in the metaverse, the server records the content of the dialogue in real time. The input is the user's question and the AI's answer, and the output is the recorded dialogue data.

### Step 2:

The server stores the recorded dialogue data as summary information in a cloud-based database. The summary information includes the user's question, the AI's answer, and the user's emotional state. The input is the recorded dialog data and the output is the summary information stored in the cloud-based database.

### Step 3:

Real store personnel retrieve summary information from the cloud-based database using a dedicated application installed on their smartphones or tablets. The input is a request to access the cloud-based database and the output is the summary information retrieved.

### Step 4:

The terminal displays the retrieved summary information to the person in charge. The information displayed includes the user's question, the AI's answer, and the emotional state. The input is the acquired summary information and the output is the summary information displayed on the terminal screen.

### Step 5:

Based on the summary information displayed, the person in charge will assess the user's needs and respond appropriately. For example, if the user is excited, the person in charge responds by providing detailed information about the product. The input is the summary information displayed, and the output is the response behavior of the person in charge.

The specific processing unit 290 transmits the results of the specific processing to the headset-type terminal 314. At headset-type terminal 314, control unit 46A causes speaker 240 and display 343 to output the results of the specific processing. Microphone 238 acquires audio indicating user input to the results of the specific processing. The control unit 46A transmits the voice data indicating the user input acquired by the microphone 238 to the data processing device 12. At the data processing device 12, the specific processing unit 290 acquires the voice data.

The data generation model 58 is a so-called Generative AI (Artificial Intelligence). An example of a data generation model 58 is a generative AI such as ChatGPT (Internet Search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.c om/?hl=ja>).

In the above exemplary embodiment, an example of implement in which the specific processing is performed by the data processing device 12 is given, but the technology of the present disclosure is not limited to this, and the specific processing may be performed by the headset-type terminal 314.

### Fourth Exemplary Embodiment

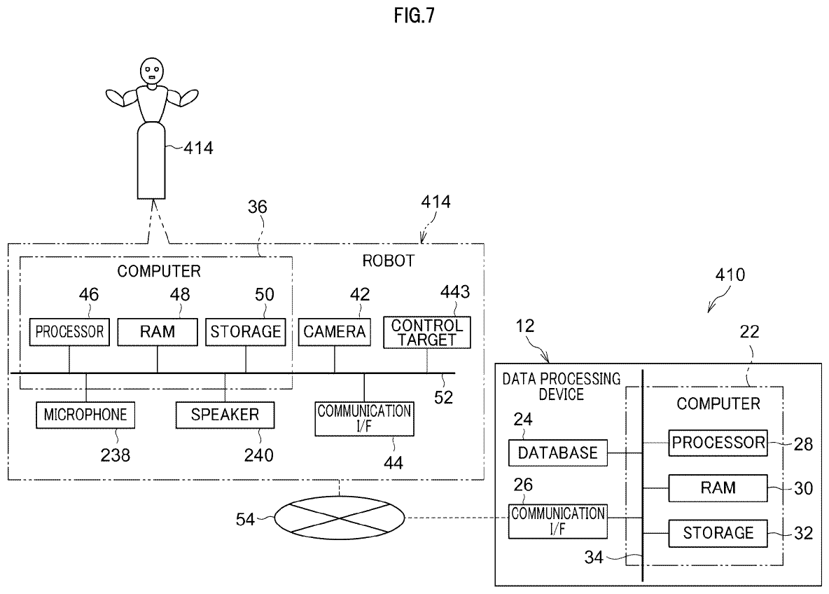

FIG. 7 shows an example of implement of a data processing system 410 for the fourth exemplary embodiment.

As shown in FIG. 7, the data processing system 410 has a data processing device 12 and a robot 414. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Robot 414 has computer 36, microphone 238, speaker 240, camera 42, communication I/F 44, and control target 443. The computer 36 has a processor 46, RAM 48, and storage 50. Processor 46, RAM 48, and storage 50 are connected to bus 52. The microphone 238, speaker 240, camera 42, and control target 443 are also connected to the bus 52.

Microphone 238 accepts the voice emitted by user 20 and receives instructions, etc., from us er 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and captures images of the surroundings of the user 20 (e.g., an image area defined by an angle of view equivalent to the field of view of a typical healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner. The control target 443 includes the display unit, the LEDs in the eyes, and the motors that drive the arms, hands, and feet, etc. The posture and gestures of robot 414 are controlled by controlling the motors of the arms, hands, and feet, etc. Some of the emotions of the robot 414 can be expressed by controlling these motors. The facial expressions of the robot 414 can also be expressed by controlling the light emission state of the LEDs in the eyes of the robot 414.

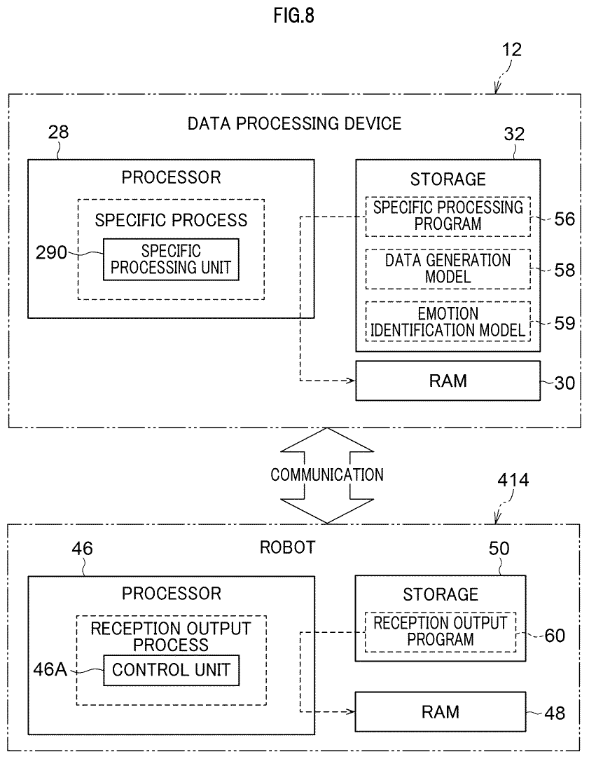

FIG. 8 shows an example of the key functions of data processing device 12 and robot 414. As shown in FIG. 8, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

In robot 414, the reception output process is performed by processor 46. The reception output program 60 is stored in the storage 50. The processor 46 reads the reception output program 60 from the storage 50 and executes the read reception output program 60 on the RAM 48. The reception output process is realized by the processor 46 operating as the control unit 46A according to the reception output program 60 executed by the processor 46 on RAM 48.

Next, the specific processing by the specific processing unit 290 of the data processing device e 12 is described.

### Example of Implement 1.”

As an exemplary embodiment of this invention, an AI that can learn CS data and other data to explain the company's services will be installed in the metaverse store. This AI will, for ex ample, use natural language processing technology to understand questions from users and generate appropriate responses. The AI will also record and summarize user questions and other interactive data.

### Example of Implement 2.”

After the initial user response, contact the person in charge of the real store OR make an app ointment to visit the store. This contact can be made, for example, by e-mail, telephone, or through a dedicated reservation system. For the convenience of the user, the date and time of the visit and the services to be provided can be specified at the time of the reservation. Example of implement 3.”

The interactions in the metaverse will be summarized and shared for the stores. This sharing is accomplished, for example, by storing the summary information in a cloud based database that can be accessed by real store personnel. The summary information would include the use r's question, the AI's answer, and other important interaction data. This would allow real store personnel to understand the content of user interactions in the metaverse and provide better service.

The following is a description of the process flow for each example of implement.

### Example of Implement 1.”

Step 1: The AI learns CS data and other data. This learning is performed, for example, using machine learning methods such as supervised learning, unsupervised learning, and reinforcement learning.

Step 2: An AI is installed in the Metaverse store to take questions from users. Questions are entered in text or voice format, which the AI analyzes using natural language processing techn ology.

Step 3: The AI generates appropriate answers and provides them to the user. Answers are generated based on training data and include the content that best fits the user's question.

Step 4: The AI records the user's questions and other dialogue data and summarizes this data. Summaries are generated, for example, using keyword extraction or sentence summarization techniques.

### Example of Implement 2.”

Step 1: After the initial user response is completed, the AI contacts the real store representati ve. The contact is made, for example, by accessing the real store's reservation system through the API and sending the user's information and summarized dialogue data.

Step 2: A real store representative receives the contact and confirms the user's appointment to visit the store. Notification of the confirmed reservation is sent to the user, for example, via e-mail or SMS.

### Example of Implement 3.”

Step 1: The AI summarizes the interactions in the metaverse and stores this in a cloud-based database. The storage is done, for example, by accessing the database through an API and submitting the summary data.

Step 2: A real store representative accesses the database and reviews the summary data. The review is done, for example, through a dedicated dashboard, which allows the representative to keep track of user questions and AI answers, as well as other important interaction data.

### (Example 1)

Next, example 1 of exemplary embodiment of implement will be described. In the following description, data processing device 12 will be referred to as the “server” and robot 414 will be referred to as the “terminal.

Conventional user response systems in the virtual space have difficulty in quickly providing appropriate answers to users' questions, and are inadequate in recording and summarizing dialogue data. As a result, the user experience was degraded and the system was not smoothly linked to the physical store. Furthermore, the quality of answers to users' questions was not consistent, resulting in reduced user satisfaction.

The specific processing by the specific processing unit 290 of the data processing device 12 in Example 1 is realized by the following means.

In this invention, the server has means to install an AI in the virtual space that can explain its services by learning CS data, etc.; means to contact a person in charge at the physical store or to make a reservation for a visit to the store after the initial user response; means to summarize the interaction in the virtual space so that it can be shared for the store; means to receive questions from the user and analyze the questions using natural language processing technology; means to input prompt sentences into the generated AI model and generate appropriate answers; and means to record the dialog data and provide the generated answers to the user. from the user, means to analyze the question using natural language processing technology, means to input prompt sentences into a generative AI model to generate appropriate responses, means to provide the generated responses to the user, and means to record and summarize the dialogue data. This enables the system to provide prompt and appropriate answers to the user's questions and effectively record and summarize the dialogue data.

CS data” is data related to customer service and includes information such as the content of customer inquiries and response history.

An “AI that can explain its services” is an artificial intelligence that automatically explains the services offered by a company in response to questions from users.

A “virtual space” is a three-dimensional virtual environment built on the Internet, where users can interact with other users and systems through avatars.

A “physical store” is a store that actually exists and that users can visit in person.

Natural language processing technology” is a technology that allows computers to understand and analyze human language.

A “generative AI model” is an artificial intelligence model that generates new information and answers based on input data.

A “prompt sentence” is a sentence that is input into a generative AI model and serves as an instruction for the model to generate an appropriate response.

Dialogue data” is a record of questions and answers exchanged between the user and the AI.

Summarizing” refers to extracting the important parts of the dialogue data and summarizing them in a concise manner.

This invention is a system that provides appropriate answers to questions from users in a virtual space and records and summarizes dialogue data. Specific exemplary embodiments of this system are described below.

First, the server generates an AI program using natural language processing technology. This program has the ability to understand questions from users and generate appropriate respons es. The hardware used should be a high-performance server (e.g., a server with a NVIDIA G PU). The software used will be a natural language processing library (e.g., TensorFlow, PyT orch) or database (e.g., MySQL).

The server places the generated AI program in the virtual space. When this AI receives a que stion from a user, it analyzes the question using natural language processing techniques. Specifically, it performs the following data processing and data computation

1. data preprocessing: tokenize user questions and remove unnecessary characters and words

2. question analysis: Analyze the intent of the question using tokenized data.

Answer generation: Generate appropriate answers based on the intent of the question. In this case, a generative AI model (e.g., GPT-3) is used.

4. recording of dialogue data: user questions and AI answers are recorded in a database.

Data summarization: summarize the recorded dialog data for later reference.

As a concrete example, when a user asks the AI in the virtual space, “Please tell me the features of this product,” the following processing is performed.

1. the user enters a question through an interface in the virtual space.

The terminal sends the user's question to the server.

3. the server receives the questions and uses a natural language processing library to tokenize the questions and remove unnecessary characters and words.

4. the server analyzes the intent of the question using the tokenized data and enters the prompt sentence “User: Tell me about the features of this product. ai:” into the data generation mod el.

5. the generated AI model says, “The features of this product are as follows. First, . . . ” The generated AI model generates the answer “First of all . . . ”.

The server sends the generated answers to the terminal.

7. the terminal displays the answer to the user and the user confirms the answer.

8. the server records the user's questions and the AI's answers in a database and summarizes the dialogue data.

An example of a prompt statement would be in the following form

User: What are the features of this product?

AI: This product has the following features. First, . . .

In this way, the server, terminal, and user can work together to provide appropriate answers to user questions and effectively record and summarize dialogue data.

The flow of the identification process in Example 1 is described in FIG. 11.

### Step 1:

The user enters a question in the virtual space.

Specific behavior: The user enters a question through an interface in the virtual space. For ex ample, the user enters, “What are the features of this product?
Input: User's question text
Output: Question text is sent to the terminal

### Step 2:

The terminal sends the user's question to the server.

Specific operation: The terminal sends the questions entered by the user to the server. In this case, the data is transmitted via the Internet.
Input: Question text
Output: Question text is sent to the server

### Step 3:

The server receives the question and begins natural language processing.

Specific operation: The server receives questions sent from terminals. The received questions are analyzed using natural language processing libraries (e.g., TensorFlow, PyTorch).
Input: Question text
Output: Tokenized question data

### Step 4:

The server parses the questions and inputs prompt sentences into the generative AI model.

Specific behavior: The server tokenizes questions and removes unnecessary characters and w ords. It then analyzes the intent of the question and prompts a generative AI model (e.g., GP T-3) with a prompt sentence. For example, the input could be in the form “User: Tell me about the features of this product; AI:”.
Input: Tokenized question data
Output: Prompt statement

### Step 5:

Generative AI models generate appropriate responses.

Specific behavior: the Generate AI model generates appropriate responses based on the prom pt text entered. For example, “This product has the following features. First, . . . ” The model generates the response “First, . . . ”.
Input: Prompt statement
Output: Generated response text

### Step 6:

The server sends the generated responses to the terminal.

Specific behavior: The server sends the answers obtained from the generated AI model to the terminal. At this time, the server converts the response data into an appropriate format before sending it.
Input: Generated response text
Output: Answer text is sent to the terminal

### Step 7:

The terminal displays the answer to the user.

Specific behavior: The terminal displays the answers received from the server to the user. The user checks the answers through the interface in the virtual space.
Input: Answer text
Output: Answers displayed to user

### Step 8:

The server records and summarizes the dialogue data.

Specifics: The server records user questions and AI responses in a database. The recorded dialogue data is then summarized for later reference.
Input: User's question text and AI's answer text
Output: Recorded dialogue data and its summary

### (Example of Application 1)

Next, example of application 1 of example of implement 1 will be described. In the following description, the data processing device 12 is referred to as the “server” and the robot 414 is referred to as the “terminal.

In conventional metaverse stores, users had difficulty getting appropriate answers to their questions about products and services. In addition, there was a lack of a means to effectively re cord, summarize, and share user questions and dialogue data with real store personnel, thus creating a need to improve the user experience. In addition, users were unable to provide real-time answers to their questions, which could potentially reduce user satisfaction

The specific processing by the specific processing unit 290 of the data processing device 12 in example of application 1 is realized by each of the following means.

In this invention, the server includes: a means of installing an AI in the metaverse store that can learn CS data and other data to explain its services; a means of contacting the person in charge of the real store or making a reservation for a store visit after the initial user response; a means of summarizing the interaction in the metaverse and making it available to the store for sharing; a means of generating real-time answers to user questions and providing them to the user; and a means of recording the interaction data, summarizing it, and providing it to the store administrator, The system includes means to generate real-time answers to user questions and provide them to the user, and means to record the dialogue data, summarize it, and provide it to the store administrator. This enables users to obtain appropriate answers in real time when they ask questions about products and services in the metaverse store, and the dialogue data can be effectively recorded, summarized, and shared with real store personnel, there by improving the user experience.

CS data” is data related to customer service and includes information such as the content of customer inquiries and response history.

AI″ stands for artificial intelligence, a system that uses machine learning and natural language processing techniques to mimic human intellectual tasks.

A “metaverse” is a virtual reality space, a digital environment in which users can interact with h other users and content through avatars.

Real-time” refers to the temporal immediacy with which the system can respond immediately to user input.

Dialogue data” is a record of conversations between a user and the AI, including questions and answers.

A “summary” is information that extracts and briefly summarizes the main points of the dialogue data.

A “store manager” is the person or organization responsible for the operation of a real or Met averse store.

A “user” is a consumer or user who visits a Metaverse store and asks questions about a product or service.

A “real store” is a store that exists in a physical location, where customers can visit and purchase goods and services in person.

The “Visit Reservation” is a procedure whereby a user reserves a date and time in advance for a visit to a real store.

The following system configuration is an exemplary embodiment of this invention.

The server will install an AI in the Metaverse store that can learn CS data and other data to explain the company's services. When a user asks a question about a product or service in a Metaverse store, the AI uses natural language processing technology to understand the user's question and generates an appropriate response in real time. This answer is then provided to the user.

The server also records the dialogue data, including the user's questions and AI responses, and provides a summary of this data to the store manager. This will help store managers understand the needs and interests of users. It also includes a means to contact a real store representative or conduct a visit reservation after the initial user response.

The system will be implemented using the following hardware and software
Hardware: (1)
Smartphone or head-mounted display
Software: C
Python
OpenAI API

When the user enters a question into the application, the server uses OpenAI's API to generate the appropriate answer to the user's question. The generated answers are displayed to the us er. Dialogue data is recorded, summarized, and provided to the store manager.

As a concrete example, when a user asks “Tell me about this product” in a virtual store, the AI will respond, “This product uses the latest technology and is very high performance. The dialogue data is recorded and summarized as “User: Tell me about this product; AI: This product uses the latest technology and is very high performance.

Example of a prompt statement: “I am a member of the User: Tell me about this product.

AI: This product uses the latest technology and is very high performance.

In this way, when a user asks a question about a product or service in a Metaverse store, the user can get an appropriate response in real time, and the dialogue data can be effectively recorded, summarized, and shared with real store personnel, thereby improving the user experience.

The flow of the identification process in Example of Application 1 is described in FIG. 12.

### Step 1:

Users use a terminal (smartphone or head-mounted display) to access the Metaverse store and enter questions about products and services.
Input: User's question text
Output: User's question text is sent to the server

### Step 2:

The server receives the user's question text and analyzes the intent of the question using natural language processing techniques.
Input: User's question text
Output: Data parsed for question intent

### Step 3:

The server generates appropriate answers using the OpenAI API based on the intent of the parsed question.
Input: Data parsed for question intent
Output: Answer text generated from OpenAI API

### Step 4:

The server sends the generated response text to the user's terminal for display to the user.
Input: Answer text generated from OpenAI API
Output: Response text displayed on the user's terminal

### Step 5:

The server records the user's question text and the generated answer text as dialogue data.
Input: user's question text, generated answer text
Output: Recorded dialogue data

### Step 6:

The server summarizes the recorded dialogue data and provides it to the store manager.
Input: recorded dialog data
Output: summarized dialog data

### Step 7:

The server provides a means to contact a real store representative or implement an appointment to visit the store after the initial user response.
Input: user question text, generated answer text, recorded dialog data
Output: Contact a real store representative or make an appointment to visit the store

In this way, when a user asks a question about a product or service in a Metaverse store, the user can get an appropriate response in real time, and the dialogue data can be effectively recorded, summarized, and shared with real store personnel, thereby improving the user experience.

### Example 2

Next, example 2 of exemplary embodiment of implement will be described. In the following description, data processing device 12 is referred to as the “server” and robot 414 is referred to as the “terminal.

The conventional system required users to contact a real store representative after receiving initial response or to make an appointment to visit the store. In addition, there was a lack of an efficient and accurate means of conveying information to users when they specify the date and time of their visit and the services to be provided. Furthermore, when sharing interactions within the virtual space with real stores, information was not adequately summarized or organized, which sometimes delayed the store's response.

The specific processing unit 290 of the data processing device 12 in Example 2 is realized by the following means.

In this invention, the server provides a means to install an AI in the virtual space that can exp lain its services by learning CS data, etc., a means to contact the person in charge at the physical store or to make a reservation for a visit after the initial user response, a means to summarize the communication in the virtual space so that it can be shared with the store, a means to provide an interface for the user to input the date and time of the visit and the services provided, a means to store the input data in a database, a means to send notifications according to a specified contact method based on the stored data, and a means to send notifications based on the results of the user feedback. The system includes means to provide an interface for the user to enter the date and time of the visit and service details, means to store the entered data in a database, means to send a notification according to the specified contact method based on the stored data, and means to provide feedback to the user on the results of the notification transmission. This enables the user to efficiently and accurately specify the date and time of the visit and the services to be provided, and to quickly contact the person in charge of the real store. In addition, by summarizing and sharing the exchange within the virtual space, the store can respond quickly and accurately.

CS data” is data related to customer service and includes information such as the content of customer inquiries and response history.

AI″ stands for artificial intelligence, a technology that uses machine learning and natural language processing to automatically process information and provide appropriate answers and services to users.

A “virtual space” is a digital environment generated by computer simulation, which users can access through the Internet to perform various activities.

A “physical store” is a real store that actually exists and where users can visit and receive ser vices in person.

An “interface” is the means by which a user interacts with the system, including user interface elements such as input forms and buttons.

A “database” is a system for efficiently storing, managing, and retrieving data, and is operated using a query language such as SQL.

A “notice” is information sent from the system to a user or contact person, in the form of an e-mail, phone call, or message.

Feedback” is the response or result that the system provides to the user, informing him or her of the results of an operation he or she has performed.

A “summary” is a concise summary of the content of an exchange within a virtual space, extracting and organizing important information.

### Exemplary Embodiment of the Invention

This invention is a system that allows users to contact a real store representative or make an appointment to visit a store after receiving initial response. The system includes an AI, user interface, database, and notification functions installed in a virtual space.

### Hardware and Software Used

The server is developed using the Python programming language and implemented as a web application using the Flask framework. MySQL is used for the database, and the SMTP server and Twilio API are used for notification functions.

### Specific System Operation

The user accesses the system's web page using a web browser; the web page displays a form for entering the date and time of the visit and the services desired. The user enters, for example, that he/she wishes to have “Cut and Color” on “Oct. 15, 2023 at 14:00” and clicks on the submit button.

The server receives the data entered into the form by the user and processes the request using the Flask framework. The input data is stored in a MySQL database. Specifically, an SQL query is generated and inserted into the database.

The server then sends the notification according to the contact method specified by the user based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.

Finally, the server checks whether the notification was successfully sent and feeds back the result to the user. For example, if the notification is successful, the message “Reservation completed” is displayed; if not, the message “Reservation failed. Please try again” message is dis played.

### Examples of Specific Examples and Prompt Sentences

As a concrete example, consider the case where a user makes a reservation at a beauty salon. The user enters on the web form that he/she wishes to request a “cut and color” service on Oct. 15, 2023 at 14:00. The server receives this information and sends an e-mail notification to the person in charge.

### Example of a Prompt Statement:

If a user enters on a web form to make a reservation at a beauty salon that he/she would like to request a “cut and color” service on Oct. 15, 2023 at 14:00, the server should receive this information and send an e-mail notification to the person in charge.

In this way, a system is realized that allows the user to specify the date and time of the visit and the services to be provided for the convenience of the user.

The flow of the identification process in Example 2 is described in FIG. 13.

### Step 1:

The user enters the date and time of the visit and services in a web form.

The user accesses the system's web page using a web browser and enters information in a form to enter the date and time of the visit and the services desired. For example, the user enters that he/she wishes to have “Cut and Color” on “Oct. 15, 2023 at 14:00” and clicks on the submit button.
Input: Date and time of visit, service details
Output: Data input by user

### Step 2:

The server receives the input data and stores it in a database.

The server receives the data entered into the form by the user; it processes the request using the Flask framework and stores the input data in a MySQL database. Specifically, it generates an SQL query and inserts it into the database.
Input: Data entered by user
Output: Data stored in database

### Step 3:

The server sends notifications based on the stored data and according to the specified contact method.

The server sends notifications according to the contact method specified by the user, based on the information stored in the database. For example, in the case of e-mail, the SMTP server is used to send mail. In the case of a telephone call, an automated voice call is made using the Twilio API. If a dedicated reservation system is used, the reservation information is sent through the API of the reservation system.
Input: data stored in database, contact method
Output: Result of sending notification

### Step 4:

The server feeds back the results of the notification transmission to the user.

The server checks whether the notification was successfully sent and feeds back the result tother user. For example, if the notification is successful, the message “Reservation completed” is displayed; if not, the message “Reservation failed. Please try again” message is displayed.
Input: Result of sending notification
Output: Feedback message to user

### (Example of Application 2)

Next, example of application 2 of example of implement 2 will be described. In the following description, the data processing device 12 is referred to as the “server” and the robot 414 is referred to as the “terminal.

Conventional user response systems within the metaverse lacked coordination with real stores after the initial response, which was problematic and reduced user convenience. In addition, there was a lack of a means to select an appropriate contact person based on the content of the user's inquiry and contact them promptly, which could lead to a decrease in user satisfaction. Furthermore, the lack of a reservation system that allowed users to specify the date and time of their visit and the services to be provided made it difficult to respond flexibly to user needs.

The specific processing by the specific processing unit 290 of the data processing device 12 in example of application 2 is realized by the following means.

In this invention, the server has a means of installing an AI in the metaverse store that can ex plain the company's services by learning CS data, etc., a means of contacting the person in chargeat the real store or making a reservation for a visit after the initial user response, and a means of summarizing the communication in the metaverse and making it available to be shared with the store, Means for the AI to automatically select an appropriate person in charge based on the user's inquiry, and to contact the person in charge via e-mail, telephone, or a dedicated reservation system, including a reservation system that allows the user to specify the date and time of the visit and the services to be provided. This makes it possible to quickly select and contact the appropriate person in charge based on the user's inquiry, thereby improving user convenience and satisfaction.

CS data” is data related to customer service and includes information such as the content of customer inquiries and response history.

AI″ stands for artificial intelligence, a technology that uses machine learning and natural language processing to automatically process information and provide appropriate answers and services to users.

A “metaverse” is a digital environment built on a virtual space, a platform that allows users to interact with other users and systems through their avatars.

A “real store” is a store that exists in a physical location, where users can actually visit and receive products and services.

The “person in charge” is a staff member or employee of the store designated to respond to user inquiries and reservations.

A “reservation system” is a system that allows users to make reservations by specifying the date, time, and services of their visit, either by e-mail, telephone, or through a dedicated online platform.

A “summary” is information that briefly summarizes the content of the exchange in the meta verse, including the user's questions and the AI's answers.

E-mail” is a digital message sent and received via the Internet and is a means of exchanging information between users and personnel.

A “phone call” is a means of exchanging information in real time through voice communication, and is intended for direct communication between a user and a contact person.

Automatic Selection” is the process by which AI automatically selects the best person for the job based on the user's inquiry.

The system for implementing this invention consists of the following

First, the server will install an AI in the metaverse store that can explain its services by learning CS data and other data. When a user makes an initial inquiry in the metaverse, the AI automatically generates an answer based on the content of the inquiry and provides it to the user. This allows users to quickly obtain the information they need.

Next, if the user's inquiry meets certain conditions, the server contacts the person in charge at the real store or makes a reservation for a visit. Specifically, the AI automatically selects an appropriate person based on the user's inquiry and contacts the person via e-mail, telephone, or a dedicated reservation system. This contact includes the user's inquiry, desired visit date and time, and service details.

In addition, the interactions in the metaverse will be summarized and made available for stores to share. The summary will include the user's question and the AI's response, which will al low personnel to quickly understand the user's situation.

To implement this system, the server will use the following hardware and software. Hardwar e: The server must be connected to the Internet and the user's smart phone. Software includes a Python-based program, an SMTP server (e.g., smtp.example.com), and a reservation system.

As a specific example, if a user wishes to “discuss the purchase of a new smartphone” and wishes to make an appointment to visit the store at 14:00 on Oct. 15, 2023, the following prompt statement is generated.
User Name: Taro Yamada
Inquiry: Consultation on purchase of a new smartphone
Preferred date and time: 2023 Oct. 15 14:00
Contact: (phone number)
Email: taro.yamada@example.com
Phone: 090-1234-5678

Based on this prompt statement, the server contacts the person in charge and confirms the us er's appointment to visit the store. This allows the user to receive services at the real store sm oothly.

The flow of the identification process in example of application 2 is described in FIG. 14.

### Step 1:

The user makes an initial query in the metaverse.
Input: User's inquiry (e.g., “Consultation on the purchase of a new smartphone”)

Processing: The AI receives the user's inquiry and analyzes its content.
Output: parsed query contents

### Step 2:

AI automatically generates answers based on the user's inquiry and provides them to the user.
Input: parsed query content

Processing: AI generates appropriate responses using a generative AI model.
Output: Generated answers (e.g., “Regarding the purchase of a new smartphone, the following models are recommended . . . ”)

### Step 3:

If the user's inquiry meets certain criteria, the server will contact the person in charge at the real store or make a reservation for the user to visit the store.
Input: parsed query, user's desired date and time of visit, and service details.

Processing: AI automatically selects the appropriate person in charge based on the content of the inquiry and generates prompt text.
Output: Generated prompt text (e.g., “User name: Taro Yamada, Inquiry: Consultation on purchase of new smartphone, Desired date: 2023 Oct. 15 14:00, Contact: E-mail: taro.yamada@example.com, Phone: 090-1234-5678”)

### Step 4:

The server will contact the person in charge via e-mail, telephone, or a dedicated reservation system.
Input: Generated prompt text

Processing: Server sends an email to the person in charge using an SMTP server, or automatically places a call using the phone API, or sends a prompt statement to the reservation system.
Output: Contact person in charge (e.g., reservation information is sent to the person's mailbox)

### Step 5:

Summarize the exchange in the metaverse and share it for the stores.
Input: user questions, AI answers

Processing: The server summarizes the exchange in the metaverse and generates summary in formation.
Output: Generated summary information (e.g., “User's question: How can I help you buy a new smartphone?)

### Step 6:

Share summary information for stores.
Input: Generated summary information

Processing: The server sends the summary information to the person in charge.
Output: Person in charge receives summary information and quickly assesses the user's situation.

### (Example 3)

Next, example 3 of exemplary embodiment of implement will be described. In the following description, the data processing device 12 is referred to as the “server” and the robot 414 is referred to as the “terminal.

There is a need to efficiently collect, summarize, and share dialogue data between users and AI in the metaverse with real store personnel to provide better service based on user needs and questions. However, current systems often collect, summarize, and share dialogue data manually, which is inefficient and lacks real-time performance.

The specific processing unit 290 of the data processing device 12 in Example 3 is realized by the following means.

In this invention, the server includes means for collecting dialogue data in the metaverse, storing the collected dialogue data in a cloud-based database, summarizing the dialogue data using a data generation AI model, storing the summarized data in a cloud-based database, and all owing a real store representative The summary data is stored in a cloud-based database and made available for viewing by personnel in real stores. This enables dialogue data to be efficiently collected, summarized, and shared in real time within the metaverse.

The “metaverse” is a three-dimensional virtual space built using virtual reality technology, where users can interact with other users and AI through their avatars.

Dialogue data” is data that contains questions, answers, and other important dialogue between the user and the AI in the metaverse.

A “cloud-based database” is a database service accessible via the Internet that stores, manages, and accesses data in a cloud environment.

A “generative AI model” is a model for generating, summarizing, and transforming text data using artificial intelligence techniques, e.g., natural language processing techniques.

Summary data” is a concise summary of important information extracted from the dialogue data by the data generation model.

Real store personnel” are those staff members who provide customer service and provide ser vices in physical stores.

Viewing” is the act of displaying and checking stored data and information.

This invention is a system that efficiently collects, summarizes, and shares dialogue data bet ween users and AI in the metaverse with real store personnel. An exemplary embodiment of this system is described below.

The server collects real-time dialogue data between the user and AI that takes place in the metaverse. This dialogue data includes the user's questions, the AI's answers, and other important dialogue content. The server stores the collected dialogue data in a cloud-based database (e.g., Amazon RDS or Google Cloud SQL).

The server then uses a data generation model (e.g., a model using natural language processing techniques) to summarize the collected dialogue data. This summary includes the key points of the user's question and the AI's response. The summarized information is again stored in a cloud-based database.

Real store representatives use their terminals to access the cloud-based database and view summary information. This allows the representative to understand the content of the interaction with the user in the metaverse and provide better service.

As a concrete example, consider a user asking in the metaverse, “Do you have the new product in stock?” and the AI responds, “Yes, we have it in stock. This interaction data is collected by the server, which uses a generative AI model to generate a summary that says, “The user asked if the new product is in stock, and the AI responded that it is in stock. This summary in formation is stored in a cloud-based database and can be accessed by real store personnel.

### Example of a Prompt Statement:

Summarize the user's question and the AI's answer.

User Question: Do you have any new products in stock?

AI's response: Yes, we have them in stock.

By inputting this prompt text into a generative AI model, summarized information can be obt ained. This system makes it possible to efficiently collect, summarize, and share dialogue data in the metaverse in real time. The flow of the identification process in Example 3 is described in FIG. 15.

### Step 1:

The server collects real-time data on user-AI interactions that take place in the metaverse at. Specifically, if a user asks in the metaverse, “Do you have the new product in stock?” and the

AI responds “Yes, we have it in stock,” this dialogue data is captured. The input is the user's question and the AI's response, and the output is the collected dialogue data.

### Step 2:

The server stores the collected dialogue data in a cloud-based database. Specifically, the dialogue data is inserted into the appropriate tables in the database. The input is the collected dialogue data and the output is the dialogue data stored in the database.

### Step 3:

The server inputs the stored dialogue data into the generative AI model to generate a summary. Specifically, the following prompt sentences are input to the generative AI model:

Summarize the user's question and the AI's answer.

User Question: Do you have any new products in stock?

AI's response: Yes, we have them in stock.

The input is the prompt text and dialogue data, and the output is the generated summary data.

### Step 4:

The server stores the generated summary data again in the cloud-based database. Specifically, the summary data is inserted into the appropriate tables in the database. The input is the generated summary data and the output is the summary data stored in the database.

### Step 5:

Using the terminal, a real store representative accesses the cloud-based database and views the summary data. Specifically, the person in charge executes a query to the database to retrieve and display the summary data. The input is a request to access the database and the output is the summary data displayed.

This series of processes enables the efficient collection, summarization, and real-time sharing of dialogue data within the metaverse.

### (Example of Application 3)

Next, example 3 of application of example of implement 3 will be described. In the following description, data processing device 12 is referred to as the “server” and robot 414 is referred to as the “terminal.

In order for real store personnel to understand the content of dialogue with users in the metaverse and provide better service, a means to efficiently summarize and share dialogue content is needed. However, current systems make it difficult to summarize dialogue data in the meta verse in real time, store it in a cloud-based database, and allow real store personnel to access it using smartphones. This makes it difficult to quickly identify user needs and interests and provide personalized service.

The specific processing by the specific processing unit 290 of the data processing device 12 in example of application 3 is realized by the following means.

In this invention, the server includes: a means of installing an AI in the metaverse that can learn CS data and other data to explain the company's services; a means of contacting a real store representative or making a reservation for a store visit after the initial user response; a means of summarizing the interaction in the metaverse so that it can be shared with the store; a means of storing the summarized information in a cloud-based database and making it accessible to the real store representative using a smartphone; and a means of including the user's que stion, the AI's response, and other important interaction data in the summary. The summary information includes the user's questions and AI responses, as well as other important interact ion data. This allows the content of the dialogue in the metaverse to be efficiently summarized and quickly accessed by real store personnel, enabling them to understand the needs and interests of users and provide personalized service.

CS data” is data related to customer service, including customer inquiries, feedback, and ser vice history.

AI″ stands for artificial intelligence, a system that mimics human intelligence using techniques such as machine learning and natural language processing.

A “metaverse” is a virtual reality space, a digital environment where users can interact with other users and engage in various activities through their avatars.

A “real store” is a store that exists in a physical location, where customers can visit and purchase goods and services in person.

A “cloud-based database” is a database that can be accessed through the Internet, with data storage and management provided by a cloud service provider.

A “smart device” is a type of cell phone, a multifunctional device with Internet access and access to applications.

Summary information” is a concise summary of detailed data and dialogue, including important points and main points.

A “user question” is a query or question posed by a user to the AI in the metaverse.

An “AI response” is a response or explanation generated by the AI to a user's question.

Important dialogue data” refers to information and data that is considered particularly important in the dialogue between the user and AI, and includes content that is useful in the provision of services.

The following system configuration and processing procedures are used to implement this invention.

First, the server will install an AI in the metaverse store that can learn CS data and other data to explain the company's services. When a user asks a question to the AI in the metaverse, the AI automatically generates an answer to the question and provides it to the user. This allows users to obtain information about the company's services in the metaverse.

Next, after the initial user response, the server contacts the person in charge of the real store and, if necessary, makes an appointment for the user to visit the store. The user is then ready to receive services at the real store.

In addition, the server will summarize the interactions in the metaverse and store the summary information in a cloud-based database. The summary information includes the user's question, the AI's answer, and other important interaction data. The person in charge of the physical store can use a smartphone to access the cloud-based database and review the summary information. This allows personnel to quickly understand the needs and interests of users and pro vide personalized service.

As a concrete example, consider a user asking in the metaverse, “What are the features of the new smartphone?” and the AI responds, “The new smartphone has a high-resolution camera and a long battery life. This dialogue is summarized and stored in a cloud-based database. Re al store representatives can use their smartphones to access this summarized information and understand the user's interest in the new smartphone.

Examples of prompt sentences to be input into the generative AI model include the following

A user asked in the metaverse, “What are the features of your new smartphone?” and the AI responded, “The new smartphone has a high-resolution camera and a long battery life.” Summarize this dialogue.

In this way, the server, terminal, and user can work together to efficiently summarize the content of the dialogue in the metaverse, which can then be quickly accessed by real store personnel. This will enable the system to understand the needs and interests of users and provide personalized services.

The flow of the identification process in example of application 3 is described in FIG. 16.

### Step 1:

The server will install an AI in the metaverse store that can learn CS data and other data to ex plain the company's services. When a user asks a question to the AI in the metaverse, the AI automatically generates an answer to that question and provides it to the user. The input is the user's question and the output is the AI's answer. Specifically, the AI uses natural language processing technology to analyze the user's question and generate an appropriate response.

### Step 2:

After the initial user response, the server contacts the person in charge at the real store and, if necessary, makes a reservation for the user to visit the store. The input is the user's question and the AI's response, and the output is the information for contacting the person in charge. The specific operation is to send a notification to the person in charge based on the user's quest ion and the AI's response, and then perform the procedures for making a reservation for a visit to the store.

### Step 3:

The server summarizes the interactions in the metaverse and stores the summary information in a cloud-based database. The input is the user's questions and AI responses, and the output is the summary information. Specifically, the server summarizes the dialogue using a generative AI model and stores it in a cloud-based database.

### Step 4:

The person in charge of the real store uses a smartphone to access the cloud-based database and review the summary information. The input is the summary information obtained from the cloud-based database, and the output is the person in charge's understanding. The specific operation is to access the database through the smartphone application and display the summary information.

### Step 5:

The person in charge uses the summary information to understand the needs and interests of the user and provide personalized services. The input is the summary information and the out put is the service provided. Specifically, the system refers to the summary information and suggests products and services suitable for the user.

Further, an emotion engine that estimates the user's emotion may be combined. In other words, the specific processing unit 290 may use the emotion identification model 59 to estimate the user's emotion and perform specific processing using the user's emotion.

### Example of Implement 1.”

In one exemplary embodiment of the invention, the AI includes an emotion engine. The emotion engine estimates the user's emotional state from the user's questions and other interaction data. Specifically, it uses natural language processing and speech analysis technologies to estimate emotions from the user's text and voice input. Image analysis and motion analysis technologies can also be used to analyze the user's facial expressions and body movements.

### Example of Implement 2.”

The user's emotional state, as estimated by the emotion engine, is reflected in the AI's response generation. Specifically, if the user is happy or excited, the AI will generate responses that emphasize those emotions. Conversely, if the user is uncomfortable or confused, the AI will generate a response that softens the emotion. This allows the AI to respond appropriately to the user's emotions.

### Example of Implement 3.”

The emotion engine also influences the summary of interactions in the metaverse. Specifically, the user's emotional state is recorded as part of the summary, which is then shared with the store. For example, if a user expresses strong excitement about a product, this information is shared with the store to help predict product popularity and sales. If a user expresses dissatisfaction with a service, this information is shared with the store to help them improve the serv ice.

The following is a description of the process flow for each example of implement.

### Example of Implement 1.”

Step 1: The AI receives questions and other interactive data from the user.

Step 2: The emotion engine estimates the emotional state of the user from the data received. Specifically, it uses natural language processing and speech analysis technologies to estimate emotions from text and voice input. It also uses image analysis and motion analysis technologies to estimate emotions from the user's facial expressions and body movements.

### Example of Implement 2.”

Step 1: The emotion engine estimates the user's emotional state.

Step 2: The AI generates responses based on the estimated emotional state. Specifically, if the user is happy or excited, it generates a response that emphasizes that emotion. Conversely, if the user is uncomfortable or confused, it generates a response that softens the emotion.

### Example of Implement 3.”

Step 1: The emotion engine estimates the user's emotional state and reflects the results in a summary of the interaction in the metaverse.

Step 2: Summaries are shared with the stores. Specifically, information about the user's strong excitement about the product or the user's dissatisfaction with the service is shared with the store.

Step 3: Stores use the shared information to forecast product popularity and sales, and to imp rove their services.

### (Example 1)

Next, example 1 of exemplary embodiment of implement will be described. In the following description, data processing device 12 will be referred to as the “server” and robot 414 will be referred to as the “terminal.

Conventional user response systems in virtual spaces have difficulty generating appropriate responses to users' questions and cannot accurately grasp users' emotional states. As a result, the user experience was degraded, resulting in inducement to the actual store or inability to improve the quality of service. Furthermore, there was a lack of a means to effectively share interactions within the virtual space to the actual store, resulting in a lack of consistency in us er responses

The specific processing by the specific processing unit 290 of the data processing device 12 in Example 1 is realized by the following means.

In this invention, the server includes means to install an artificial intelligence in the virtual space that can learn CS data and other data to explain the company's services, means to contact a person in charge at the actual store or to make a reservation to visit the store after the initial user response, and means to summarize the interaction in the virtual space so that it can be shared for the store, Means to analyze user questions using natural language processing technology to generate appropriate responses, means to use speech analysis technology, image ana lysis technology, and motion analysis technology to estimate the user's emotional state, and means to record and summarize the dialogue data. This makes it possible to generate appropriate answers to the user's questions and to accurately ascertain the user's emotional state. In addition, by effectively sharing the interactions in the virtual space with the actual store, it is possible to maintain consistency in user responses and improve the quality of service.

Artificial Intelligence” is a system that includes technology to generate appropriate answers to user questions and to estimate the user's emotional state.

A “virtual space” is a three-dimensional virtual environment constructed on the Internet, where users can interact with other users and systems through avatars.

Natural language processing technology” is a technology that analyzes text input from users to understand their intentions and generate appropriate responses.

Speech analysis technology” is a technology for converting voice input from users into text and analyzing that text.

Image analysis technology” is a technology that uses a camera to capture a user's facial expressions and body movements, and analyzes the data to estimate the emotional state of the user.

Motion analysis technology” is a technology that analyzes the user's body movements and us es the data to estimate the emotional state of the user.

Dialogue data” is a record of the interaction between the user and the artificial intelligence, and includes information such as the content of questions and answers, as well as the emotion al state of the user.

A “summary” is a concise summary of important information extracted from the dialogue dat a.

A “physical store” is a store that exists in a physical location and that users can actually visit.

The “Visit Reservation” is a procedure whereby a user reserves a date and time in advance for a visit to a physical store.

This invention relates to an artificial intelligence system that explains its services to users in a virtual space. The following is an exemplary embodiment of this system.

First, the server generates a program that combines natural language processing technology, speech analysis technology, image analysis technology, and motion analysis technology. This program includes artificial intelligence to understand questions from users and generate appropriate responses. Specifically, the following technologies will be used.

Natural language processing technology: The server analyzes text input from the user to understand the intent of the question. This technology uses, for example, BERT and GPT-3.

Speech analytics technology: The server converts the user's voice input into text and analyzes that text. Google Cloud Speech-to-Text and Amazon Transcribe are used for this technology

Image Analysis Technology: The server uses cameras to capture the user's facial expressions and body movements to estimate their emotional state. OpenCV and Google Cloud Vision are used for this technology.

Motion Analysis Technology: The server analyzes the user's body movements to estimate their emotional state. Microsoft Azure Kinect DK is used for this technology.

Next, the user accesses the AI within the virtual space. The user logs into a virtual store within the virtual space to access the AI assistant. The user initiates a dialogue by clicking on the icon or avatar of the AI assistant within the virtual space.

When a user enters a question in text or voice, the server receives the input and selects the ap propriate analysis technology. For text input, the server selects natural language processing technology; for voice input, it selects speech analysis technology.

The server uses natural language processing technology to analyze the user's question and generate an appropriate response. For example, in response to a question such as “What are the features of this product?”, the server generates an answer such as “This product is made of high-quality materials and is durable.

In addition, the server uses an emotion engine to estimate the emotional state of the user. For text input, emotions are analyzed using natural language processing technology, and for voice input, speech analysis technology is used. In addition, by analyzing the user's facial express ions and body movements through the camera, the emotional state is estimated more accurately.

The server returns the generated responses to the user. The answer is displayed in a text chat window or played back with audio. For example, “This product is made of high quality materials and is durable.

Finally, the server records the interaction data with the user and summarizes it for later analysis and improvement. For example, the content of the user's questions and emotional state are recorded and used for the next dialogue.

### Specific Examples

User accesses the AI within the virtual space: the user clicks on the AI assistant's avatar in the virtual store and initiates a dialogue.

User enters a question by text or voice: The user enters the question “What are the features of this product?” by text or by voice using the microphone.

Server receives input and selects appropriate parsing technology: The server recognizes that the user's input is text and selects a natural language processing technology.

Server analyzes questions using natural language processing technology: The server analyzes questions using GPT-3 and extracts information about product features.

The server generates an appropriate response: the server generates a response such as “This product is made of high quality materials and is durable.

Server estimates the user's emotional state: The server analyzes the user's emotions from the user's text input and estimates whether the user is satisfied or not.

Server returns the answer to the user: The server displays the generated answer in a text chat window.

Server records and summarizes dialog data: The server records the user's questions and emotional state and summarizes them for use in the next dialog.

Example of a prompt statement: “I am a member of the Tell me what makes this product unique.”

How long will this product last?”

Tell me about the pricing plan for this service.”

In this way, the server can generate appropriate answers to the user's questions and provide better service by estimating the user's emotional state.

The flow of the identification process in Example 1 is described in FIG. 17.

### Step 1:

The user accesses the AI within the virtual space.

Specific behavior: The user logs into a virtual store in the virtual space and clicks on the AI assistant's icon or avatar to initiate a dialogue.
Input: User login information and location in the virtual space.
Output: Initiation of a dialogue session with the AI assistant.

### Step 2:

The user enters questions by text or voice.

Specific behavior: The user types a question in the text chat window or asks a question by voice using the microphone. For example, the user types, “What are the features of this product?
Input: User text or voice input.
Output: text or voice data.

### Step 3:

The server receives the input and selects the appropriate analysis technique.

Specific behavior: The server determines whether the user input is text or voice, and selects natural language processing technology for text input or speech analysis technology for voice i nput.
Input: text or voice data.
Output: Result of analysis technique selection.

### Step 4:

The server analyzes the questions using natural language processing technology.

Specific behavior: The server uses natural language processing techniques (e.g., GPT-3) to analyze the user's questions and understand the intent of the questions.
Input: text data.
Output: Results of analysis of question intent.

### Step 5:

The server generates the appropriate response.

Specific behavior: The server generates appropriate responses based on the analysis results. For example, it generates responses such as “This product is made of high-quality materials and is durable.
Input: Results of the analysis regarding the intent of the question.
Output: Response text.

### Step 6:

The server estimates the user's emotional state.

Specific behavior: The server uses an emotion engine to estimate the user's emotional state. For text input, emotions are analyzed using natural language processing technology; for voice input, speech analysis technology is used. In addition, the emotional state is estimated more accurately by analyzing the user's facial expressions and body movements through the camera.
Input: text data, voice data, image data.
Output: Estimated results of the emotional state.

### Step 7:

The server returns the answer to the user.

Specific behavior: The server returns the generated answers to the user. The answer is displayed in a text chat window or played back with audio. For example, “This product is made of high quality materials and is durable.
Input: Answer text.
Output: Display of answer to user or audio playback.

### Step 8:

The server records and summarizes the dialogue data.

Specific behavior: The server records the user interaction data and summarizes it for later analysis and improvement. For example, it records the user's questions and emotional state, which can be used for the next interaction.
Input: Dialogue data, emotional state estimation results.
Output: summarized dialog data.

### (Example of Application 1)

Next, example of application 1 of example of implement 1 will be described. In the following description, the data processing device 12 is referred to as the “server” and the robot 414 is referred to as the “terminal.

Conventional user response systems within the virtual space have had difficulty providing ap propriate responses to user questions and taking into account the emotional state of the user. In addition, there was a lack of a means to effectively share interactions within the virtual space to the physical store, and there was a need to improve the user experience

The specific processing by specific processing unit 290 of data processing device 12 in example of application 1 is realized by the following means. In this invention, the server has the following means: a means to install an AI in the virtual space that can explain its services by learning CS data, etc.; a means to contact the person in charge at the physical store or make a reservation for a visit after the initial user response; a means to summarize the communication in the virtual space so that it can be shared with the store; a means including an emotion engine that estimates the user's emotional state; a means to analyze the user's voice or text input; a means to use natural language processing technology; and a means to analyze the user's voice or text input. The system includes an emotion engine to estimate the user's emotional state, natural language processing technology to analyze the user's voice and text input, and image analysis technology to analyze the user's facial expressions and actions. This makes it possible to provide appropriate answers to the user's questions and respond in consideration of the emotional state, effectively sharing the interaction within the virtual space to the physical store.

CS data” is data related to customer service and includes information such as the content of customer inquiries and response history.

A “virtual space” is a three-dimensional virtual environment constructed using computer technology, which users can experience interactively.

AI″ stands for artificial intelligence, a system that mimics human intelligence using techniques such as machine learning and natural language processing.

A “physical store” is a real store that actually exists and that customers can visit in person.

The “emotion engine” is a technology for estimating a user's emotional state, and is a system that recognizes emotions using voice and image analysis.

Natural language processing technology” refers to technology that enables computers to understand and generate human language, including text analysis and speech recognition.

Image analysis technology” refers to technology that analyzes image data and extracts information, including object recognition and face recognition.

A “summary” is a short summary of lengthy text or dialogue data, from which important information is extracted and expressed in a concise manner.

Communication” is the act of conveying information and is done by means of telephone, e-m ail, or other means.

The “visit reservation” is the act of reserving in advance a date and time for a customer to vis it a physical store so that the store can prepare to accommodate the customer.

The system for implementing this invention consists of the following

First, the server places an AI in the virtual space that can learn CS data and other data to explain its services. Users can access the virtual space using a smartphone or head-mounted display to interact with the AI, which automatically generates answers to their questions and provides those answers to the user.

The server then contacts the person in charge of the physical store after the initial user response or makes a reservation for a visit to the store. This allows the user to receive services at the physical store based on the information obtained in the virtual space.

In addition, the server will summarize the interactions within the virtual space so that they can be shared for the store. This allows physical store personnel to see what questions users have asked and what answers they have received in the virtual space.

The system includes an emotion engine that estimates the user's emotional state. The emotion engine uses natural language processing technology to analyze the user's voice and text inpu t. It also uses image analysis technology to analyze the user's facial expressions and actions. This enables the system to estimate the user's emotional state and respond appropriately.

As a specific example, if a user asks, “Tell me about your latest smartphone,” the AI will res pond, “It is the latest smartphone. It has a high-performance camera and a long-lasting batter y.” The AI responds, “It has a high-performance camera and a long battery life. And if the us er asks, “Where can I buy this product?” the AI will answer, “This product is available at our online store. The AI replies, “This product can be purchased at the online store.

The following hardware and software are used to realize this system
Hardware: Smartphones, head-mounted displays
Software: OpenAI API (generative AI models), Transformers library (natural language processing technology), OpenCV (image analysis technology)
Examples of prompt statements include the following
Tell me about your latest smartphone.”
Where can I buy this product?”

Tell me about the features of your head-mounted display.”

This allows users to receive services at a physical storefront through an interactive experience in the virtual space.

The flow of the identification process in Example of Application 1 is described in FIG. 18.

### Step 1:

The user accesses the virtual space using a smartphone or head-mounted display. The user in puts questions to the AI assistant within the virtual space. Input can be done by text or voice. The input data is sent to the server.

### Step 2:

The server analyzes the received user questions using natural language processing technolog y. Specifically, it uses the OpenAI API to understand the intent of the question and generate an appropriate response. The input is the user's question and the output is the generated answ er.

### Step 3:

The server provides the generated answers to the user. The user checks the answers in the virtual space. The output is the answers provided to the user.

### Step 4:

The server analyzes the user's voice and text input with the emotion engine to estimate the us er's emotional state. The emotion engine uses the Transformers library to recognize emotions. The input is the user's voice or text data, and the output is the estimated emotional state.

### Step 5:

The server analyzes the user's facial expressions and actions using image analysis technology. Specifically, it uses OpenCV to recognize the user's facial expressions and actions to complement the emotional state. The input is the user's image data, and the output is the analyzed facial expression and behavior information.

### Step 6:

The server summarizes the interaction in the virtual space and shares it with the physical store personnel. The summary includes the user's questions and the AI's answers. The input is the interaction data in the virtual space and the output is the summarized information.

### Step 7:

After the initial user response, the server will contact the person in charge of the physical store or implement a reservation for a visit to the store. Email or telephone is used as the means of contact. The input is the user's contact information and the desired appointment date and time, and the output is a confirmation of the contact or appointment.

### Step 8:

Users visit a physical store and receive services based on information obtained in the virtual space. The person in charge of the physical store responds based on the summary information shared from the server. The input is the summary information and the output is the service provided to the user.

### Example 2

Next, example 2 of exemplary embodiment of implement will be described. In the following description, data processing device 12 is referred to as the “server” and robot 414 is referred to as the “terminal.

Conventional systems provide a uniform response without taking into account the user's emotional state, and this has led to a problem of reduced user satisfaction. There was also the problem of the time and effort required to contact the person in charge at the real store after the initial response and the complicated procedures for making a visit appointment. Furthermore, the system lacked the ability to specify the date and time of the user's visit and the services to be provided, making it difficult to provide convenience to the user.

The specific processing by the specific processing unit 290 of the data processing device 12 in Example 2 is realized by the following means. In this invention, the server receives the use r's input data, analyzes the received input data to estimate the user's emotional state, generates a response using a generative AI model based on the estimated emotional state, provides the generated response to the user, and after the initial user response The system includes means to contact a person in charge of the real store or to make an appointment for the user to visit the store, and means by which the user can specify the date and time of his/her visit and the services to be provided. This enables appropriate responses according to the user's emotional state, and simplifies the contact and reservation procedures after the initial response, for the convenience of the user.

The “means of receiving user input data” is a function for sending and receiving text and voice data input by the user through the terminal to the server.

The “means for analyzing received input data to estimate the user's emotional state” is a function for analyzing received user input data and estimating the user's emotional state (joy, excitement, discomfort, confusion, etc.) from that data.

The “means for generating responses using a generative AI model” is a function for generating appropriate responses to users using a generative AI model based on the estimated emotion al state.

The “means of providing generated answers to users” is a function for transmitting and providing answers generated by the generative AI model to users.

The “means of contacting a real store representative or scheduling a visit after the initial user response” is a function for contacting a real store representative or scheduling a visit by the user after the initial response is complete.

The “means by which users can specify the date and time of their visit and the services they wish to receive” is a function for users to specify the date and time of their visit and the services they wish to receive.

An “emotion engine” is software or an algorithm that analyzes user input data and estimates the emotional state from that data.

A “generative AI model” is an artificial intelligence model for generating natural language responses based on user input data and emotional states.

An “e-mail, telephone, or dedicated reservation system” is a means of communication or reservation management system used to communicate between a user and a real store representative.

### Exemplary Embodiment of the Invention

This invention is a system that provides appropriate responses based on the user's emotional state and simplifies the contact and appointment procedures after the initial response. Specific exemplary embodiments of this system are described below.

### Means for Receiving User Input Data

A user accesses the system using a terminal (e.g., PC or smartphone) and enters questions or information. The data entered by the user is sent from the terminal to the server. The server is equipped with a high-performance processor (e.g., Intel Xeon processor) to process the received data.

### Means for Analyzing the Received Input Data to Estimate the Emotional State of the User

The server passes the received user input data to an emotion engine (e.g., IBM Watson Tone Analyzer) for emotion analysis. The emotion engine estimates the emotional state (e.g., joy, excitement, discomfort, confusion, etc.) from the user's text. The results of this analysis are fed back to the generative AI model.

### Means of Generating Responses Using a Generative AI Model Based on the Estimated Emotional State

The server generates a response to the user using a generative AI model (e.g., OpenAI's GPT-4) based on the emotional state obtained from the emotion engine. For example, if the user is expressing pleasure, the AI will say, “That's great! We're glad you're interested.” and generates a positive response such as “I'm glad you're interested.

### Means of Providing the Generated Answers to the User

The server sends and provides the answers generated by the generative AI model to the user.

Users can receive these answers through their terminals.

Means of contacting a real store representative or scheduling a visit to the store after the initial user response.

If the user is satisfied with the initial response, the server will contact a real store representative or implement a reservation for a visit to the store. This contact may be made via email (e. g., Gmail API), telephone (e.g., Twilio API), or through a dedicated reservation system (e.g., Calendly).

A means of specifying the date and time of the user's visit and the services to be provided.

The user may specify the date and time of the visit and the services to be provided when making an appointment to visit the restaurant. The server inputs these information into the reservation system and sends a reservation confirmation e-mail to the user. It also notifies the person in charge of the real store of the reservation information.

### Concrete Example

### Example 1: a User Expresses Delight

User says, “I really like your new product!” and inputs “I love it!”. The emotion engine detects “joy” and the generative AI model says, “That's great! We're glad you're interested. If you need more information, please contact a representative or schedule a visit. The model replies, “That's great!

### Example 2: A User Expresses Confusion

A user types “I am not sure how to use this product”. The emotion engine detects “puzzled” and the generated AI model says, “Sorry for the inconvenience. If you need further explanation, please contact a representative or make an appointment to visit our store. The model replies, “If you need further explanation, please contact a representative or make an appointment to visit our store.

### Example of Prompt Text

“Generate a positive response if the user expresses delight about the new product.”

“If a user is confused about how to use a product, generate a response that reassures them.”

In this way, the system responds appropriately to the user's emotional state and, if necessary, either contacts a real store representative or makes a reservation for a visit to the store.

The flow of the identification process in Example 2 is described in FIG. 19.

### Step 1: Receive the User's Input Data

A user accesses the system using a terminal (e.g., PC or smartphone) and enters questions or information. The data entered by the user is sent from the terminal to the server. Specifically, the user opens a browser, accesses the system's web page, enters a question in the text box, and clicks the “Send” button. The input data is the user's question or information (e.g., “Tell me more about your new product”), and the output is the user's input data sent to the server.

### Step 2: Analyze the Received Input Data to Estimate the User's Emotional State.

The server passes the received user input data to the emotion engine (e.g., IBM Watson Tone Analyzer) for emotion analysis. The input data is the user's text data, and the emotion engine analyzes this data to estimate the emotional state (e.g., joy, excitement, discomfort, confusion). Specifically, the server sends the user's input data to the emotion engine, which analyzes the text, estimates the emotional state, and returns the results to the server. The output is the estimated emotional state.

### Step 3: Generate Answers Using a Generative AI Model Based on the Estimated Emotional State

The server generates answers to users using a generative AI model (e.g., OpenAI's GPT-4) based on the emotional states obtained from the emotion engine. The input data is the emotion analysis results, and the generative AI model uses this data to generate an appropriate response. Specifically, the server passes the emotion analysis results to the generative AI model, and the generative AI model generates responses according to the emotional state. The output is the generated answers.

### Step 4: Provide the Generated Answers to the User.

The server sends and provides the answers generated by the generative AI model to the user. The input data is the generated answers, and the server sends these answers to the user. Specifically, the server sends the generated answers to the user's terminal, and the user receives the answers through the terminal. The output is the answers provided to the user.

### Step 5: After Initial User Response, Contact a Real Store Representative or Schedule a Visit to the Store

If the user is satisfied with the initial response, the server contacts a real store representative or makes a reservation for a visit. The input data is the user's satisfaction level and desired contact or reservation information, which the server uses as the basis for the contact or reservation. Specifically, the user clicks on the “Reserve Visit” button, the server accesses the reservation system, and the user's desired date, time, and service details are entered. The output is a reservation confirmation e-mail or contact notification.

Step 6: Users can Specify the Date and Time of their Visit and Services.

The user may specify the date and time of the visit and the services to be provided when making an appointment to visit the store. The input data is the user's desired visit date and time and service details, which are input by the server into the reservation system. Specifically, the server inputs the user's desired date, time, and service details into the reservation system, sends a reservation confirmation e-mail to the user, and also notifies the person in charge at the real store of the reservation information. The output is a reservation confirmation e-mail and a notification to the person in charge.

### (Example of Application 2)

Next, example of application 2 of example of implement 2 will be described. In the following description, the data processing device 12 is referred to as the “server” and the robot 414 is referred to as the “terminal.

In conventional metaverse store systems, it was difficult to respond appropriately to users' emotional states, resulting in a poor user experience. In addition, it was difficult to improve us er satisfaction because there was a lack of a means to promptly contact a real store representative when a user expressed discomfort or confusion.

The specific processing by the specific processing unit 290 of the data processing device 12 in example of application 2 is realized by the following means.

In this invention, the server includes: a means to install an AI in the metaverse store that can learn CS data, etc. and explain its services; a means to contact the person in charge at the real store or make a reservation for a visit to the store after the initial user response; a means to summarize the communication in the metaverse so that it can be shared for the store; and a means to generate appropriate responses based on the user's emotional state estimated by the emotion engine. AI generates appropriate responses based on the user's emotional state as estimated by the emotion engine, and means to contact the person in charge if the user expresses discomfort or confusion. This enables appropriate responses based on the user's emotional stat e, thereby improving the user experience and quickly resolving problems.

CS data” is data related to customer service and includes information such as the content of customer inquiries and response history.

The term “AI” stands for artificial intelligence, a technology in which computers mimic hum an intelligence in learning and reasoning.

The term “metaverse” refers to a virtual space, a 3D virtual world constructed on the Internet.

An “emotion engine” is an algorithm or system for estimating a user's emotional state, a technology that uses natural language processing and machine learning to analyze emotions.

A “real store” is a store that exists in a physical location and that customers can actually visit

The term “visit reservation” refers to a reservation made by a customer to visit a store on a specific date and time.

A “summary” is a concise summary of detailed information, with key points extracted and ex pressed in a short form.

The term “user experience” refers to the experience or satisfaction a user feels when using a product or service.

Prompt problem-solving” refers to the rapid response and resolution of problems as they aris e.

The system for implementing this invention is configured as follows. First, the server will ins tall an AI in the metaverse store that can learn CS data and other data to explain its services. When a user makes an inquiry in the metaverse, the emotion engine estimates the user's emotional state, and the AI generates an appropriate response based on that emotion.

If a user indicates discomfort or confusion, the server will contact a real store representative. The means of contact may be e-mail, telephone, or a dedicated reservation system. If the user wishes to make an appointment to visit the store, he or she can specify the date and time of the visit and the services to be provided.

Interactions in the metaverse are summarized and shared for the store. This summary includes the user's question and the AI's response. This allows real store personnel to quickly understand the user's situation and respond appropriately.
Hardware and software used
Hardware: Smartphones, servers
Software: Python, smtplib (sending email), random (simulation of emotion engine)
Data processing and computation

1. emotion engine: receives user input and estimates emotional states. Specifically, the emotion is analyzed from the user's text using a natural language processing model.

2. AI response generation: Generate appropriate responses based on estimated emotions. For example, if a user is confused, the system will ask, “Sorry for the inconvenience. How can we help you?” when the user is confused.

Contacting the person in charge: If a user expresses discomfort or confusion, the server will contact the person in charge. E-mail is used as the means of contact. The e-mail will include the date and time of the user's desired visit and the nature of the service.

### Concrete Example

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and contact is made with the person in charge.

### Example of Prompt Text

When a user types “I don't know how to use this product,” the emotion engine estimates “con fusion” and the AI says, “Sorry for the inconvenience. How can we assist you?” and the AI re plies, “How can we help you? The user then enters the desired date and time of the visit and the service, and the person in charge is contacted.

In this way, appropriate responses can be made according to the user's emotional state, improving the user experience and quickly resolving problems.

The flow of the identification process in example of application 2 is described in FIG. 20.

### Step 1:

A user makes an inquiry in the metaverse. The user uses a smartphone or computer to access the virtual storefront in the metaverse and enters a question in text format. The entered text is sent to the server.

### Step 2:

The server receives the user's input text and passes it to the emotion engine. The emotion engine uses a natural language processing model to estimate the user's emotional state. Specifically, it analyzes the text data and classifies emotions such as joy, excitement, discomfort, and confusion. The output of the emotion engine is the estimated emotional state.

### Step 3:

The server receives the output of the emotion engine and passes it to the generative AI model. The generative AI model generates appropriate responses based on the estimated emotional state. For example, if the user is confused, the model might say, “Sorry for the inconvenience. How can we help you?” The generated response is returned to the server. The generated answers are returned to the server.

### Step 4:

The server provides the generated answers to the user. The user can check the answers from the AI on the screen of his/her smartphone or computer. This allows users to obtain appropria the answers to their questions.

### Step 5:

If the user indicates discomfort or confusion, the server will contact the real store representative. The user enters the desired date and time of the visit and the services to be provided, and this information is sent to the server. The server uses e-mail to contact the person in charge. The e-mail includes the user's desired date and time of visit and the services to be provided.

### Step 6:

The server summarizes the interactions in the metaverse and shares them for the store. The summary includes the user's question and the AI's response. This allows real store personnel to quickly understand the user's situation and respond appropriately.

In this way, appropriate responses can be made according to the user's emotional state, improving the user experience and resolving problems quickly.

### (Example 3)

Next, example 3 of exemplary embodiment of implement will be described. In the following description, the data processing device 12 is referred to as the “server” and the robot 414 is referred to as the “terminal.

Conventional interaction data between users and AI in the metaverse is often not used as useful information for real store personnel. In addition, it is difficult to provide services that take into account the emotional state of users. This makes it difficult for real store personnel to accurately understand users' needs and emotions and provide appropriate services

The specific processing unit 290 of the data processing device 12 in Example 3 is realized by the following means.

In this invention, the server includes means for collecting dialogue data in the metaverse, means for storing the collected dialogue data in a cloud-based database, means for analyzing the stored dialogue data and generating summary information, means for analyzing the emotion al state of the user using an emotion engine, means for storing the generated summary information and the emotional state are stored in a cloud-based database, and a person in charge of the real store accesses the cloud-based database to view the summary information. This enables real store personnel to understand the content of user interaction and emotional states in the metaverse and to provide more appropriate and personalized service.

The “metaverse” is a three-dimensional virtual space built using virtual reality technology, where users can interact with other users and AI through their avatars.

Dialogue data” is data that includes questions, answers, time stamps, and other information exchanged between users and AI in the metaverse.

A “cloud-based database” is a database service accessible via the Internet and is a platform for storing, managing, and analyzing data.

Summary information” is a concise summary of important information extracted from the dialogue data, including the user's question, the AI's response, and important dialogue points.

An “emotion engine” is software or an algorithm that analyzes user interaction data to identify the user's emotional state (e.g., excitement, frustration, joy, etc.).

A “generative AI model” is an artificial intelligence model that uses natural language processing techniques to analyze textual data and generate summaries and responses.

Real store personnel” are those staff members who provide customer service and provide ser vices in physical stores.

Access” is the act of connecting to a cloud-based database to view, retrieve, or manipulate stored data.

This invention is a system that collects dialogue data in the metaverse, analyzes it, generates summary information, and provides it to real store personnel. An exemplary embodiment of this system is described below.

The server obtains dialogue data from the metaverse platform (e.g., a three-dimensional virtu al space using virtual reality technology) through an API. When a user asks a question to the AI in the metaverse, the question and the AI's answer are sent to the server in real time. For example, if a user asks, “What are the features of your new smartphone?” the question and the AI's answer are collected as dialogue data.

The server stores the collected dialogue data in a cloud-based database (e.g., a database service accessible through the Internet). The database will record the details of each dialogue. For example, the following records are added

```
{
  “timestamp”: “2023-10-01T12:34:56Z”,.
  “user_question”: “What are the features of your new smartphone?” ,.
  “ai_response”: “The new smartphones feature high-resolution cameras and long-life batterie
s.”
}
```

The server then analyzes the stored dialogue data and generates summary information. A generative AI model (e.g., an artificial intelligence model using natural language processing techniques) is used to generate a summary of the dialogue data. This summary includes the user's question, the AI's response, and the key dialogue points. The generated summary will look like the following

Summary: User asked about features of new smartphone; AI answered about high-resolution camera and long-life battery.

In addition, the server uses an emotion engine (e.g., software or algorithms for analyzing the user's emotional state) to analyze the user's emotional state. The analysis results include the emotions (e.g., excitement, frustration, joy, etc.) that the user exhibited during the interaction. The analysis results are as follows.

### Emotional State: Excited

The server will store the generated summary information and emotional states in a cloud-based database. The records to be stored will be as follows

```
{
  “timestamp”: “2023-10-01T12:34:56Z”,.
  “summary”: “Users asked about new smartphone features, and the AI answered about the hi
gh-resolution camera mela and long-life battery.” ,
  “emotion”: “excitement”
}
```

Using the terminal, a real store representative accesses a cloud-based database to view summary information. The representative can determine the user's interest in a new smartphone, provide a detailed description, and suggest relevant accessories.

Examples of Prompt Sentences to be Input into the Generative AI Model are as Follows
Summarize the data of the user's interaction with the AI in the metaverse. Include the following information
User Question
AI Answer
Emotional state of the user

With this system, real store personnel will be able to understand the content of the user's intereaction and emotional state in the metaverse and provide more appropriate and personalized services. The flow of the identification process in Example 3 is explained using FIG. 21.

### Step 1:

The server obtains dialogue data from the metaverse platform through an API. When a user asks a question to the AI in the metaverse, the question and the AI's answer are sent to the server in real time. The input is the user's question and the AI's answer, and the output is the dialogue data. In concrete operation, the server sends an API request and receives the dialogue data.

### Step 2:

The server stores the collected dialogue data in a cloud-based database. The input is the dialogue data obtained in step 1 and the output is the records stored in the database. As a specific action, the server executes an INSERT query to the database and stores the dialogue data.

### Step 3:

The server analyzes the stored dialogue data and generates summary information. The input is the dialogue data stored in the database and the output is the generated summary informatio n. Specifically, the server inputs dialogue data to a generative AI model and generates a sum mary. The generative AI model uses natural language processing techniques to generate a summary of the dialog data.

### Step 4:

The server uses an emotion engine to analyze the user's emotional state. The input is the dialog data and the output is the analyzed emotional state. Specifically, the server inputs dialogue data to the emotion engine and analyzes the emotional state. The emotion engine identifies the user's emotion (e.g., excitement, frustration, joy, etc.).

### Step 5:

The server stores the generated summary information and emotional states in a cloud-based database. The input is the summary information and emotional state, and the output is the records stored in the database. Specifically, the server executes an INSERT query against the database and stores the summary information and emotional state.

### Step 6:

Using the terminal, the person in charge of the real store accesses the cloud-based database and views the summary information. The input is the summary information and emotional state stored in the database, and the output is the information the person in charge views. Specifically, the person in charge uses the terminal to send a query to the database to retrieve summary information and emotional states.

### (Example of Application 3)

Next, example 3 of application of example of implement 3 will be described. In the following description, data processing device 12 is referred to as the “server” and robot 414 is referred to as the “terminal.

There is a need for a system that allows real store personnel to understand the interaction bet ween users and AI in the metaverse, which can be used to improve service and predict the popularity of products. However, current systems make it difficult to summarize interactions in the metaverse in real time and share them, including emotional states. They also lack the means to provide information in a form that can be easily accessed by real store personnel. This makes it difficult to quickly identify user needs and respond appropriately

Specific processing by specific processing unit 290 of data processing device 12 in example of application 3 is realized by the following means. In this invention, the server has the following means: a means to install an AI in the metaverse that can explain its services by learning CS data, etc., in the metaverse store; a means to contact the person in charge at the real store or make a reservation for a visit to the store after the initial user response; a means to summarize the communication in the metaverse so that it can be shared with the store; a means to store the summarized information to be stored in a cloud-based database and made accessible to real store personnel, recording the user's emotional state as part of the summary and sharing it with the store, and providing an application installed on a smart phone or tablet that allows real store personnel to review the summary information. Includes means to provide an ap plication. This makes it possible to summarize in real time the content of the dialog with the user in the metaverse and share it, including the emotional state, so that the real store personnel can quickly understand the user's needs and respond appropriately.

CS data” is data related to customer service and includes information such as customer inquiry details, response history, and satisfaction ratings.

AI″ stands for artificial intelligence, a system that mimics human intelligence using techniques such as machine learning and natural language processing.

A “metaverse” is a virtual reality space, a digital environment in which users can interact and engage in activities with other users and AI through avatars.

A “real store” is a store that exists in a physical location, a place where customers can actually visit to purchase products and receive services.

A “cloud-based database” is a database accessible via the Internet, where data is stored and managed on a cloud server.

The “summary information” is a concise summary of the user's interaction with the AI in the metaverse, including the user's questions, the AI's answers, and the emotional state of the use r.

The term “emotional state” refers to the feelings that a user exhibits during an interaction, such as excitement, frustration, joy, or sadness.

A “smart device” is a type of cell phone, a multifunctional device with Internet access and access to applications.

A “tablet” is a portable computer device with a touch screen and the ability to use applications in the same way as a smart device.

An “application” is a software program that provides a specific function or service and is installed on a smartphone or tablet.

The System for Implementing this Invention Consists of the Following

First, the server will install an AI in the metaverse store that can learn CS data and other data to explain the company's services. When a user interacts with the AI in Metaverse, the content of the interaction is recorded in real time. The recorded dialogue will be stored in a cloud-based database as summary information. This summary information includes the user's question, the AI's response, and the user's emotional state.

Real store personnel can then access this summary information using a dedicated application installed on their smartphones or tablets. The application has the ability to retrieve the summary information from a cloud-based database and display it to the person in charge. This allows the person in charge to understand the content of the interaction with the user in the meta verse and to respond appropriately.

As a specific example, if a user asks in the metaverse, “Do you have this item in stock?” the AI will respond, “Yes, we have this product in stock. Along with the content of this dialogue, the emotional state of excitement of the user is also recorded. This information is summarized and stored in a cloud-based database. Real store personnel can access this information using a smartphone or tablet and provide detailed information about the products the user is interested in.

An example of a prompt statement would be in the following form
Summarize the user's interaction with the AI in the metaverse and output in the following format
user ID
question
Answer.
emotional condition
Example: The
User ID: user_001
Q: Do you have this item in stock?
Answer: Yes, we have them in stock.
Emotional State: Excited

In this way, the content of the dialogue in the metaverse can be summarized in real time and shared, including the emotional state. This allows real store personnel to quickly understand the needs of users and respond appropriately.

The flow of the identification process in example of application 3 is described in FIG. 22.

### Step 1:

The server will install an AI in the metaverse store that can learn CS data and other data to ex plain the company's services. When a user initiates a dialogue with the AI in the metaverse, the server records the content of the dialogue in real time. The input is the user's question and the AI's answer, and the output is the recorded dialogue data.

### Step 2:

The server stores the recorded dialogue data as summary information in a cloud-based databa se. The summary information includes the user's question, the AI's answer, and the user's emotional state. The input is the recorded dialog data and the output is the summary information stored in the cloud-based database.

### Step 3:

Real store personnel retrieve summary information from the cloud-based database using a dedicated application installed on their smartphones or tablets. The input is a request to access the cloud-based database and the output is the summary information retrieved.

### Step 4:

The terminal displays the retrieved summary information to the person in charge. The information displayed includes the user's question, the AI's answer, and the emotional state. The input is the acquired summary information and the output is the summary information displayed on the terminal screen.

### Step 5:

Based on the summary information displayed, the person in charge will assess the user's needs and respond appropriately. For example, if the user is excited, the person in charge responds by providing detailed information about the product. The input is the summary information displayed, and the output is the response behavior of the person in charge.

The specific processing unit 290 sends the results of the specific processing to the robot 414. In robot 414, control unit 46A causes speaker 240 and control target 443 to output the results of specific processing. Microphone 238 acquires audio indicating user input to the result of the specific processing. The control unit 46A transmits the voice data indicating the user input acquired by the microphone 238 to the data processing device 12. In the data processing de vice 12, the specific processing unit 290 acquires the voice data.

The data generation model 58 is a so-called Generative AI (Artificial Intelligence). An example of a data generation model 58 is a generative AI such as ChatGPT (Internet Search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.c
om/?hl=ja>).

In the above exemplary embodiment, an example of implement in which the specific processing is performed by the data processing device 12 is given, but the technology of the present disclosure is not limited to this, and the specific processing may be performed by the robot 414.

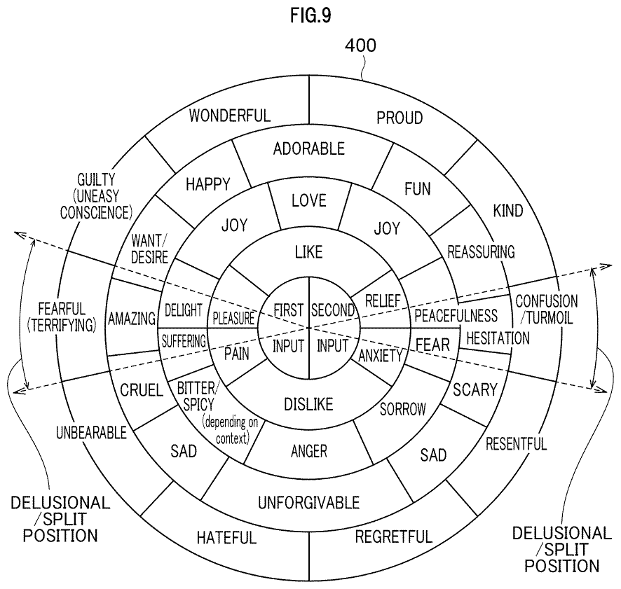

The emotion identification model 59, as the emotion engine, may determine the user's emotion according to a specific mapping. Specifically, the emotion identification model 59 may determine the user's emotion according to a specific mapping, the emotion map (see FIG. 9). The emotion identification model 59 may similarly determine the robot's emotion, and the specific processing unit 290 may perform the identification process using the robot's emotion.

FIG. 9 shows an emotion map 400 in which multiple emotions are mapped. In emotion map 400, the emotions are arranged in concentric circles radiating from the center. The closer to the center of the concentric circles, the more primitive state emotions are arranged. The more outward of the concentric circles are placed the emotions that represent states of mind and actions that arise from the state of mind. Emotion is a concept that includes emotional and mental states. On the left side of the concentric circles are the emotions that are generally generated from the reactions that occur in the brain. On the right side of the concentric circles are the emotions that are generally induced by situational judgments. On the upper and lower sides of the concentric circles are the emotions that are generally generated from the reactions that occur in the brain and are guided by situational judgments. In addition, “pleasant” emotions are placed on the upper side of the concentric circles, and “unpleasant” emotions are placed on the lower side. Thus, in emotion map 400, multiple emotions are mapped based on the structure in which emotions are generated, and emotions that tend to occur simultaneously are mapped close together.

These emotions are distributed in the 3 o'clock direction of the emotion map 400 and usually move back and forth between relief and anxiety. In the right half of the emotion map 400, situational awareness predominates over internal sensations, resulting in a calm impression.

Since the inside of the emotion map 400 represents the mind and the outside of the emotion map 400 represents behavior, the further outside of the emotion map 400, the more visible the emotion becomes (expressed in behavior).

Here, human emotions are based on various balances such as posture and blood glucose level, and when these balances move away from the ideal, they are unpleasant, and when they move closer to the ideal, they are pleasant. In robots, cars, motorcycles, etc., emotions can also be created based on various balances such as posture and battery level, with the state of discomfort when these balances move away from the ideal and pleasure when they move closer tother ideal. An emotion map may be generated based on, for example, Dr. Mitsuyoshi's emotion map (Research on Speech Emotion Recognition and Brain Physiological Signal Analysis S system for Emotions, The University of Tokushima, PhD thesis: https://ci.nii.ac.jp/naid/50000 0375379). In the left half of the emotion map, emotions belonging to a region called “reaction,” in which the senses predominate, are lined up. In the right half of the emotion map, emotions belonging to the “situation” domain, in which situational awareness predominates, are lined up.

The emotion map defines two emotions that facilitate learning: one is the emotion around the middle of negative “repentance” or “remorse” on the situational side. That is, when the robot experiences negative emotions such as “I don't want to feel this way again” or “I don't want to be scolded again. The other emotion is around the positive “greed” on the reaction side. In other words, it is when the robot has a positive feeling of “wanting more” or “wanting to know more.

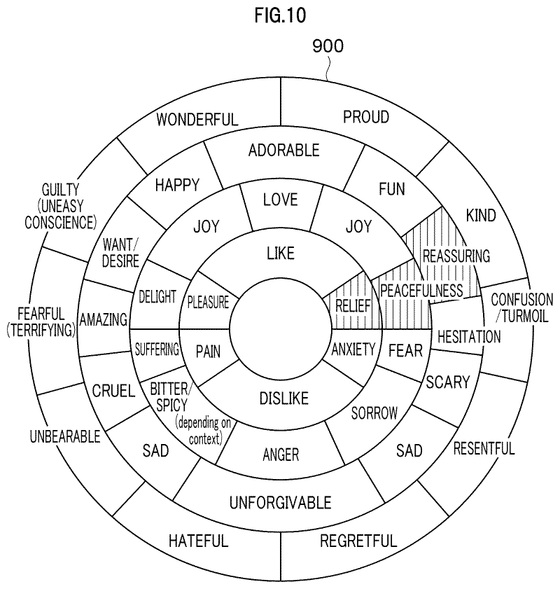

The emotion identification model 59 determines the user's emotion by inputting the user input into a neural network that has been trained in advance and obtaining an emotion value indicating each emotion shown in the emotion map 400. This neural network is pre-trained based on a plurality of training data, which are combinations of user input and emotion values indicating each emotion shown in the emotion map 400. This neural network is also learned so that emotions that are placed close to each other have close values, as shown in the emotion map 900 in FIG. 10. FIG. 10 shows an example in which multiple emotions, such as “safe,” “peaceful,” and “reassuring,” have close emotion values.

In the above exemplary embodiment, an example of implement in which specific processing is performed by one computer 22 is given, but the technology of the present disclosure is not limited to this, and distributed processing for specific processing may be performed by multiple computers including computer 22.

In the above exemplary embodiment, an example of implement in which specific processing program 56 is stored in storage 32 has been described, but the technology of the present disclosure is not limited to this. For example, the specific processing program 56 may be stored in a portable, computer-readable, non-transitory storage medium such as a USB (Universal Se rial Bus) memory. The specific processing program 56 stored on the non-transitory storage medium is installed on the computer 22 of the data processing device 12. Processor 28 performs specific processing according to specific processing program 56.

The specific processing program 56 may be stored on a server or other storage device connected to the data processing device 12 via network 54, and the specific processing program 56 may be downloaded and installed on the computer 22 at the request of the data processing de vice 12.

It is not necessary to have all of the specific processing program 56 stored in a server or other storage device connected to the data processing device 12 via network 54, or to have all of the specific processing program 56 stored in storage 32, but a portion of the specific processing program 56 may be stored.

The hardware resource that executes the specific process can be a processor of any of the following types. Processors include, for example, CPUs, which are general-purpose processors that function as hardware resources that execute specific processing programs by executing software, i.e., programs. A processor can also be, for example, a field-programmable gate array (FPGA), programmable logic device (PLD), or application-specific integrated circuit (ASI C). For example, a dedicated electrical circuit, which is a processor with a circuit configuration designed specifically to perform a particular process, such as a FPGA (Field Programmable Gate Array), PLD (Programmable Logic Device), or ASIC (Application Specific Integrated Circuit). Any of these processors has a memory built in or connected to it, and any of them performs a specific process by using the memory.

The hardware resource that executes the specific processing may consist of one of these various processors or a combination of two or more processors of the same or different types (e.g., a combination of multiple FPGAs or a CPU and an FPGA). The hardware resource that per forms the specific processing may be a single processor.

An example of implementing a single processor is, first, a form in which one processor is composed of a combination of one or more CPUs and software, and this processor functions as a hardware resource that executes a specific process. Second, there is a form that uses a processor that realizes the functions of the entire system, including multiple hardware resources that execute specific processing, in a single IC chip, as typified by a system-on-a-chip (SoC). Thus, the specific processing is realized using one or more of the various processors mentioned above as hardware resources.

Furthermore, the hardware structure of these various processors can be more specifically an electric circuit that combines circuit elements such as semiconductor devices. In addition, the above specific process is only an example. Therefore, it goes without saying that unnecessary steps may be deleted, new steps may be added, or the order of processing may be replaced tother extent that it does not deviate from the main purpose.

The descriptions and illustrations shown above are detailed descriptions of portions pertaining to the technology of the present disclosure and are only examples of the technology of the present disclosure. For example, the above description of the configuration, functions, actions, and effects is a description of one example of the configuration, functions, actions, and effects of the portion pertaining to the technology of the disclosure. Therefore, it goes without saying that unnecessary portions may be deleted, new elements may be added, or new elements may be substituted for the above description and illustration to the extent that it does not de part from the main purpose of the technology of the present disclosure. In addition, in order to avoid confusion and to facilitate understanding of the parts pertaining to the technology of the present disclosure, explanations regarding technical common sense, etc. that do not require particular explanation to enable implementation of the technology of the present disclosure have been omitted from the descriptions and illustrations shown above.

All references, patent applications, and technical standards described herein are incorporated by reference herein to the same extent that individual references, patent applications, and technical standards are specifically and individually noted as being incorporated by reference.

With respect to the above exemplary embodiments, the following is further disclosed

### (Claim 1)

The system includes a means of installing an AI in the metaverse that can explain the company's services by learning CS data, etc., a means of contacting the person in charge at the real store or making a reservation for a visit to the store after the initial user response, and a means of summarizing the communication in the metaverse and sharing it with the store.

### (Claim 2)

The system of claim 1, further comprising means by which the AI automatically generates an answer to the user's question and provides that answer to the user.

### (Claim 3)

The system of claim 1, wherein the summary of the interaction in the metaverse further includes a means of sharing information with the store, including the user's question and the AI's answer.

### (Claim 4)

The system of claim 1, wherein the AI further includes means including an emotion engine that recognizes the user's emotions.

### (Claim 5)

The system of claim 4, wherein the emotion engine further includes means for estimating the user's emotional state from the user's questions and other interaction data and reflecting the results in the AI's answer generation.

### (Claim 6)

The system of claim 4, wherein the emotion engine further includes means for including the estimated emotional state of the user in a summary of the interaction in the metaverse and sharing this with the store.

### Example 1.”

### (Claim 1)

A means to set up an AI in a virtual space that can learn CS data and other data to explain the company's services,
A means of contacting a physical store representative or conducting an appointment to visit the store after the initial user response,
A means to summarize the interactions in the virtual space so that they can be shared for stores,
A means of receiving questions from users and analyzing the questions using natural language processing technology,
A means of inputting prompt sentences into the generative AI model and generating appropriate responses,
A means of providing the generated answers to the user,
Means for recording and summarizing dialogue data,

The system includes.

### (Claim 2)

The system of claim 1, further comprising means by which the AI automatically generates an answer to the user's question and provides the answer to the user.

### (Claim 3)

The system of claim 1, wherein the summary of the interaction in the virtual space further includes a means of sharing information with the store, including the user's question and the AI's answer.

### Example of Application 1.”

### (Claim 1)

The means to install an AI in Metaverse stores that can learn from CS data, etc., and explain the company's services,

A means to contact a real store representative OR implement a reservation for a visit to the store after the initial user response,

A means to summarize and share the metaverse exchange for the stores, A means of generating and providing answers to users' questions in real time,

A system that includes means to record and summarize dialogue data and provide it to the store manager.

### (Claim 2)

The system of claim 1, further comprising means by which the AI automatically generates an answer to the user's question and provides the answer to the user.

### (Claim 3)

The system of claim 1, wherein the summary of the interaction in the metaverse further includes a means of sharing information with the store, including the user's question and the AI's answer.

### Example 2.”

### (Claim 1)

A means to set up an AI in a virtual space that can learn CS data and other data to explain the company's services,
A means to contact a physical store representative OR implement an appointment to visit the store after the initial user response,
A means of summarizing interactions in virtual space and sharing them with stores, A means of providing an interface for users to enter the date and time of their visit and the nature of the service,
A means of storing the input data in a database,
A means of sending notifications according to a specified contact method based on the stored data,
A means of providing feedback to the user on the results of the notification transmission,

The system includes.

### (Claim 2)

The system of claim 1, further comprising means by which the AI automatically generates an answer to the user's question and provides the answer to the user.

### (Claim 3)

The system of claim 1, wherein the summary of the interaction in the virtual space further includes a means of sharing information with the store, including the user's question and the AI's answer.

Example of application 2.”

### (Claim 1)

The means to install an AI in Metaverse stores that can learn from CS data, etc., and explain the company's services,
A means to contact a real store representative OR implement a reservation for a visit to the store after the initial user response,
A means to summarize and share the metaverse exchange for the stores,
A means for AI to automatically select an appropriate contact person based on the user's inquiry,
A means of contacting the person in charge via e-mail, telephone, or a dedicated reservation system,
Means including a reservation system that allows users to specify the date and time of their visit and the services to be provided,

The system includes.

### (Claim 2)

The system of claim 1, further comprising means by which the AI automatically generates an answer to the user's question and provides the answer to the user.

### (Claim 3)

The system of claim 1, wherein the summary of the interaction in the metaverse further includes a means of sharing information with the store, including the user's question and the AI's answer.

### Example 3.”

### (Claim 1)

A means of collecting interaction data in the metaverse,
A means of storing the collected dialogue data in a cloud-based database,
means of summarizing the dialogue data using a generative AI model,
means of storing the summary data in a cloud-based database; and
A means for real store personnel to view summary data,

The system includes.

### (Claim 2)

The system of claim 1, wherein said generative AI model further includes means to summarize the user's question and the AI's response.

### (Claim 3)

The system of claim 1, wherein the summary data further includes means for sharing information with the store, including the user's question and the AI's answer.

Example of application 3.”

### (Claim 1)

The means to install an AI in Metaverse stores that can learn from CS data, etc., and explain the company's services,
A means to contact a real store representative OR implement a reservation for a visit to the store after the initial user response,
A means to summarize and share the metaverse exchange for the stores,
A means of storing summary information in a cloud-based database that can be accessed by real store personnel using smart phones; and
A means of including the user's question and the AI's answer and other important interactive data in the summary information,
The system includes.

### (Claim 2)

The system of claim 1, further comprising means by which the AI automatically generates an answer to the user's question and provides the answer to the user.

### (Claim 3)

The system of claim 1, wherein the summary of the interaction in the metaverse further includes a means of sharing information with the store, including the user's question and the AI's answer.

Example 1 for the combined emotional engine.”

### (Claim 1)

A means of installing artificial intelligence in a virtual space that can learn CS data and other data to explain the company's services,
A means of contacting a physical store representative or conducting an appointment to visit the store after the initial user response,
A means to summarize the interactions in the virtual space so that they can be shared for stores,
A means of analyzing the user's questions using natural language processing technology and generating appropriate responses,
A means of using voice analysis, image analysis, and motion analysis techniques to estimate the emotional state of users,
Means for recording and summarizing dialogue data,

The system includes.

### (Claim 2)

The system of claim 1, further comprising means by which the artificial intelligence automatically generates an answer to the user's question and provides the answer to the user.

### (Claim 3)

The system of claim 1, wherein the summary of the interaction in the virtual space further includes a means of sharing information with the store, including the user's question and the artificial intelligence's answer.

Example of application 1 when combined with the Emotional Engine.”

### (Claim 1)

A means to set up an AI in a virtual space that can learn CS data and other data to explain the company's services,
A means to contact the physical store representative OR implement an appointment to come tother store after the initial user response,
A means of summarizing interactions in virtual space and sharing them with stores,
A means including an emotional engine to estimate the emotional state of the user,
A means of using natural language processing technology to analyze the user's voice and text input,
A means of using image analysis technology to analyze the user's facial expressions and movements,

The system includes.

### (Claim 2)

The system of claim 1, further comprising means by which the AI automatically generates an answer to the user's question and provides the answer to the user.

### (Claim 3)

The system of claim 1, wherein the summary of the interaction in the virtual space further includes a means of sharing information with the store, including the user's question and the AI's answer.

Example 2 for the combined emotional engine.”

### (Claim 1)

means for receiving input data from the user; and
A means for analyzing the received input data to estimate the emotional state of the user, means of generating responses using a generative AI model based on the estimated emotional state,
A means of providing the generated answers to the user,
A means of contacting a real store representative or conducting an appointment to visit the store after the initial user response,
A means of specifying the date and time of the user's visit and the services to be provided,

The system includes.

### (Claim 2)

The system of claim 1, wherein the estimation of the emotional state further includes means using an emotional engine that analyzes the user's input data.

### (Claim 3)

The system of claim 1, further comprising means by which contacting a real store representative or making an appointment to visit the store is done via e-mail, telephone, or through a dedicated reservation system.

Example of application 2 when combined with an “emotional engine.”

### (Claim 1)

The means to install an AI in Metaverse stores that can learn from CS data, etc., and explain the company's services,
A means to contact a real store representative OR implement a reservation for a visit to the store after the initial user response,
A means to summarize and share the metaverse exchange for the stores,
A means for the AI to generate appropriate responses based on the user's emotional state as estimated by the emotion engine,
A means for users to contact a representative if they express discomfort or confusion, and The system includes.

### (Claim 2)

The system of claim 1, further comprising means by which the AI automatically generates an answer to the user's question and provides the answer to the user.

### (Claim 3)

The system of claim 1, wherein the summary of the interaction in the metaverse further includes a means of sharing information with the store, including the user's question and the AI's a nswer.

Example 3 for the combined emotional engine.”

### (Claim 1)

A means of collecting dialogue data in the metaverse,

A means of storing the collected dialogue data in a cloud-based database,

A means for analyzing the stored dialogue data and generating summary information,

A means of analyzing the user's emotional state using an emotional engine, means of storing the generated summary information and emotional states in a cloud-based database; and

A system that includes a means for real store personnel to access a cloud-based database and view summary information.

### (Claim 2)

The system of claim 1, further comprising means for using a generative AI model to generate said summary information.

### (Claim 3)

The system of claim 1, further comprising means by which the emotion engine analyzes the user's emotional state and adds the results to the summary information.

An example of application3 when combined with an “emotional engine.”

### (Claim 1)

The means to install an AI in Metaverse stores that can learn from CS data, etc., and explain the company's services,
A means to contact a real store representative OR implement a reservation for a visit to the store after the initial user response,
A means to summarize and share the metaverse exchange for the stores,
A means of storing summary information in a cloud-based database that can be accessed by real store personnel,
A means of recording the user's emotional state as part of the summary and sharing it with the store,
Means of providing an application that is installed on smartphones and tablets that allows real store personnel to review summary information

The system includes.

### (Claim 2)

The system of claim 1, further comprising means by which the AI automatically generates an answer to the user's question and provides the answer to the user.

### (Claim 3)

The system of claim 1, wherein the summary of the interaction in the metaverse further includes a means of sharing information with the store, including the user's question and the AI's answer.

1. A system comprising:
a processor configured to:
deploy an artificial intelligence chatbot (AI) in a three-dimensional (3D) virtual space, wherein a user in the 3D virtual space interacts through an avatar, the AI being capable of learning customer service (CS) data and explaining company services;
contact a physical store representative or schedule a store visit after an initial user interaction;
summarize and share interactions in the virtual space with a physical store;
receive questions from the user and analyze the questions using natural language processing technology;
capture an image or motion of at least one of a facial expression and a body movement of the user by a camera equipped with an image sensor and convert the captured image or motion into image data;
input prompt sentences regarding the analyzed questions into a generative AI model and generate appropriate responses;
provide the generated appropriate responses to the user through the AI;
record and summarize interaction data between the user and the AI;
automatically generate answers to user's questions and provide the answers to the user;
create a summary of interactions in the virtual space and share the summary, including the user's questions and the AI's responses, with the physical store, and
update the AI,
wherein analyzing the questions using natural language processing technology includes:
generating tokenized input data by performing tokenization of user's questions; and
computing an emotional state of the user based on the tokenized input data and the image data of the captured image or motion by applying a pre-trained emotion identification model,
wherein generating appropriate responses includes adapting the generated responses to the emotional state of the user,
wherein creating the summary of interactions in the virtual space includes recording the emotional state of the user, and
wherein the AI is updated based on the computed emotional state.

2. (canceled)

3. (canceled)
